(19) United States
(12) Patent Application Publication
(10) Pub. No.: US 2021/0171788 A1
(43) Pub. Date: Jun. 10, 2021

(54) COATING METHOD AND PRODUCT THEREOF

(71) Applicants: SCG CHEMICALS CO., LTD., Bangkok (TH); SCG PACKAGING PUBLIC COMPANY LIMITED, Bangkok (TH)

(72) Inventors: Dermot O'Hare, Oxford (GB); Jingfang Yu, Oxford (GB); Dana-Georgiana Crivoi, Oxford (GB); Kanittika Ruengkajorn, Oxford (GB)

(21) Appl. No.: 16/763,292

(22) PCT Filed: Nov. 13, 2018
(86) PCT No.: PCT/GB2018/053281

§ 371 Date: May 12, 2020

(30) Foreign Application Priority Data
Nov. 13, 2017 (GB) 1718719.6

(51) Int. Cl. C09D 7/62; C09D 129/04; C08K 9/04; C08K 3/32; C08K 3/26; C08K 3/22; B05D 7/04; C08J 7/048; C08J 7/04

(52) U.S. Cl. CPC C09D 7/62; C08J 2429/04; C08K 9/04; C08K 3/32; C08K 3/26; C08K 3/22; B05D 7/04; C08J 7/048; C08J 7/0427; C08K 2201/008; C08K 2201/016; C08K 2003/324; C08K 2003/267; C08K 2003/2224; C08K 2003/2227; B05D 2201/02; B05D 2252/00; C08J 2367/02; C09D 129/04

(57) ABSTRACT

A process for the preparation of a coated substrate is described, in which a substrate is coated with a coating mixture containing a polymer and an amino acid-modified layered double hydroxide. The process of the invention is markedly simpler than conventional techniques for affording coated substrates having reduced permeability to degradative gases. The coated substrates obtainable by the process are particularly useful in packaging applications, notably in the food industry.

### INTRODUCTION

The present invention relates to a process for the preparation of a coated substrate, as well as to coated substrates obtainable by the process and their uses in packaging applications. The present invention also relates to a process for the preparation of a coating mixture suitable for use in coating applications, as well as to coating mixtures obtainable by such a process. More specifically, the present invention relates to a process for the preparation of a coated substrate comprising an LDH-containing coating.

### BACKGROUND OF THE INVENTION

Polymer films have been widely applied as packaging materials (e.g. in the food industry) due to their lightweight, low cost and good processability (T. Pan, S. Xu, Y. Dou, X. Liu, Z. Li, J. Han, H. Yan and M. Wei, J. Mater. Chem. A, 2015, 3, 12350-12356). However, the effectiveness of polymer packaging materials in preventing product degradation depends on their impermeability to degradative gases such as oxygen (Y. Dou, S. Xu, X. Liu, J. Han, H. Yan, M. Wei, D. G. Evans and X. Duan, Adv. Funct. Mater., 2014, 24, 514-521) and water vapour.

In an endeavour to reduce the gas permeability of polymeric films used in packaging applications, inorganic materials have been incorporated directly into the polymeric films themselves (e.g. as fillers), or have been applied to the surface of such polymeric films (e.g. as a coating). Clays (such as montmorillonite) have been considered promising candidate materials for reducing the gas permeability of polymeric films. However, these materials suffer from the fact that they are naturally-occurring, and as such may be heavily contaminated with potentially harmful substances (e.g. heavy metals), thereby hampering their use in food packaging.

Aside from clays, layered-double hydroxides (LDHs) have been recognised as potentially useful materials for reducing the gas permeability of polymeric films. However, to date, research in the area of LDH coatings on polymeric films has focussed on the preparation of a complex “brick-mortar” structure obtained via layer-by-layer (LbL) assembly of LDH nanoplatelets and polymer on the film, in which a highly-ordered stack of alternating layers of LDH (brick) and polymer (mortar) is prepared by a series of alternating spin or dip coating steps using i) an LDH dispersion, and ii) a polymer solution. These assemblies have been rendered even more complex by infilling voids with CO₂ (to give a “brick-mortar-sand” structure) in an endeavour to further reduce the oxygen transmission rate (OTR) of the polymeric film. However, the elaborate and complex nature of such LbL techniques restricts their implementation on an industrial scale.

In spite of the advances made by the prior art, there remains a need for improved means for reducing the gas permeability of polymeric films. In particular, there remains a need for an overall simpler coating technique allowing for the preparation of coated polymeric films having acceptable OTR and/or water-vapour transmission rate (WVTR) properties.

The present invention was devised with the foregoing in mind.

### SUMMARY OF THE INVENTION

According to a first aspect of the present invention there is provided a process for the preparation of a coated first substrate, the process comprising the steps of:
a) providing a coating mixture comprising:
   i. an amino acid-modified layered double hydroxide,
   ii. a polymer, and
   iii. a solvent for the polymer;
b) applying a layer of the coating mixture to a first substrate to provide a coated first substrate; and
c) drying the coated first substrate.

According to a second aspect of the present invention there is provided a coated substrate obtainable, obtained or directly obtained by the process of the first aspect of the invention.

According to a third aspect of the present invention there is provided a coated substrate comprising:
a) a first substrate; and
b) a coating layer provided on a least one surface of the first substrate,
wherein the coating layer comprises 20-90 wt % of an amino acid-modified layered double hydroxide dispersed throughout a polymeric matrix.

According to a fourth aspect of the present invention there is provided a process for the preparation of a coating mixture suitable for use in a coating application, the coating mixture comprising an amino acid-modified layered double hydroxide, a polymer and a solvent for the polymer, the process comprising the step of:
a) mixing at least the following:
   i. an amino acid-modified layered double hydroxide,
   ii. a polymer, and
   iii. a solvent for the polymer.
      Suitably, the coating mixture is suitable for use in food packaging.

According to a fifth aspect of the present invention there is provided a coating mixture obtainable, obtained or directly obtained by the process of the fourth aspect of the invention.

According to a sixth aspect of the present invention there is provided a coating mixture comprising an amino acid-modified layered double hydroxide, a polymer and a solvent for the polymer. Suitably, the coating mixture is suitable for use in food packaging.

According to a seventh aspect of the present invention there is provided a use of a coating mixture according to the fifth or sixth aspect in the formation of a coating on a substrate.

According to an eighth aspect of the present invention there is provided a use of a coated substrate according to the second or third aspect of the invention in packaging.

According to a ninth aspect of the present invention there is provided packaging comprising a coated substrate according to the second or third aspect of the invention.

### DETAILED DESCRIPTION OF THE INVENTION

### Preparation of Coated Substrates

According to a first aspect of the present invention there is provided a process for the preparation of a coated first substrate, the process comprising the steps of:
a) providing a coating mixture comprising:
   i. an amino acid-modified layered double hydroxide,
   ii. a polymer, and
   iii. a solvent for the polymer;
b) applying a layer of the coating mixture to a first substrate to provide a coated first substrate; and
c) drying the coated first substrate.

The process of the invention provides a number of advantages over conventional techniques for reducing the gas permeability characteristics of polymeric films. When compared with techniques employing the use of an inorganic filler in the film itself, the present invention is advantageous in that it allows various different substrates to be coated with the same coating mixture. Hence, it not necessary for each substrate (e.g. PET, PU, PE) to be purpose-made with the inclusion of an inorganic filler.

The use of LDH in the process of the invention also presents numerous advantages over prior art techniques employing clays. In contrast to clays (e.g. montmorillonite), LDHs are entirely synthetic materials, the composition, structure and morphology of which is wholly governed by the manner in which they are prepared. As a consequence, the replacement of clays with LDHs in coated substrates for packaging applications considerably reduces—if not eliminates—the risk posed by potentially harmful contaminants (such as heavy metals), which present clear advantages for the food industry.

The process of the invention also presents a number of advantages over conventional LbL assembly techniques. As discussed hereinbefore, LbL techniques have been used to prepare complex “brick-mortar” structures, containing a highly-ordered stack of alternating layers of LDH (brick) and polymer (mortar) which is grown directly on a substrate by a series of alternating spin or dip coating steps using i) an LDH dispersion, and ii) a polymer solution, or is assembled separate from the substrate prior to being transferred onto it. In contrast to this approach, the present invention provides a considerably simpler technique for achieving coated polymeric substrates having acceptable OTR and/or WVTR properties. In particular, in the present process, both the LDH and the polymer are simultaneously applied to the substrate in a single step, whereas LbL processes require successive alternating separate steps for applying the LDH and polymer. This necessarily facilitates up-scaling of the present process, the coating mixture of which can be applied to the substrate from a single vessel in a production line in a single application step. Moreover, the present process provides a greater degree of flexibility in the manner in which the coating mixture may be applied to the substrate on an industrial scale. As a non-limiting example, the present process may be implemented using a roller-and-bath apparatus, in which the coating mixture is licked onto a roller being in contact with a bath, and is then transferred onto a substrate also being in contact with the roller, thereby allowing vast quantities of substrate to be continuously coated in a short period of time. Such cost-effective techniques are entirely incompatible with LbL techniques, the complex structures of which can only be achieved by sequential alternating dip or spray coating techniques.

Yet a further advantage of the present process is that the amino acid-modified LDH contained within the coating mixture has improved morphological properties when compared with LDHs employed in prior art techniques. The amino acid-modified LDHs may be obtainable by a process in which a layered double oxide (LDO) is contacted with an amino acid in a solvent (e.g. water) in air. Upon contacting the amino acid and solvent, the LDO is converted (e.g. reconstructed) into an LDH. Without wishing to be bound by theory, it is believed that the presence of the amino acid during the reformation of the LDH from the LDO gives rise to an LDH having advantageous morphological properties. In particular, when compared with the LDH contained in coating mixtures that are formed by mixing LDH directly with the other components of the mixture, the amino acid-modified LDH may have an improved aspect ratio. The aspect ratio of the LDH platelets is seen as an important factor in the formation of coatings having a sufficiently tortuous pathway to reduce the transmission of gases and vapours (e.g. O₂ and H₂O).

In an embodiment, the combined quantity of the amino acid-modified LDH and polymer in the coating mixture is 2.0-12.0% by weight relative to the total weight of the coating mixture. Suitably, the combined quantity of the amino acid-modified LDH and polymer in the coating mixture is 2.5-10.0% by weight relative to the total weight of the coating mixture. Suitably, the combined quantity of the amino acid-modified LDH and polymer in the coating mixture is 2.5-7.5% by weight relative to the total weight of the coating mixture. Suitably, the combined quantity of the amino acid-modified LDH and polymer in the coating mixture is 3-7% by weight relative to the total weight of the coating mixture. More suitably, the combined quantity of the amino acid-modified LDH and polymer in the coating mixture is 3.5-6.5% by weight relative to the total weight of the coating mixture. Yet more suitably, the combined quantity of the amino acid-modified LDH and polymer in the coating mixture is 4-6% by weight relative to the total weight of the coating mixture.

In an embodiment, the combined quantity of the amino acid-modified LDH and polymer in the coating mixture is 2.0-20.0% by weight relative to the total weight of the coating mixture. Suitably, the combined quantity of the amino acid-modified LDH and polymer in the coating mixture is 3.0-17.0% by weight relative to the total weight of the coating mixture. Suitably, the combined quantity of the amino acid-modified LDH and polymer in the coating mixture is 4.0-15.0% by weight relative to the total weight of the coating mixture. Suitably, the combined quantity of the amino acid-modified LDH and polymer in the coating mixture is 5.0-14.0% by weight relative to the total weight of the coating mixture. More suitably, the combined quantity of the amino acid-modified LDH and polymer in the coating mixture is 6.0-14.0% by weight relative to the total weight of the coating mixture. Yet more suitably, the combined quantity of the amino acid-modified LDH and polymer in the coating mixture is 8.0-12.0% by weight relative to the total weight of the coating mixture.

In an embodiment, the weight ratio of amino acid-modified LDH to polymer in the coating mixture ranges from 1:9 to 9:1. Suitably, the weight ratio of amino acid-modified LDH to polymer in the coating mixture ranges from 1:6 to 4:1. Suitably, the weight ratio of amino acid-modified LDH to polymer in the coating mixture ranges from 1:4 to 4:1. More suitably, the weight ratio of amino acid-modified LDH to polymer in the coating mixture ranges from 1:2 to 3:1.

In an embodiment, of the total solids (i.e. polymer and amino acid-modified LDH) present in the coating mixture, 10-90 wt % is the amino acid-modified LDH. Suitably, of the total solids present in the coating mixture, 20-87.5 wt % is the amino acid-modified LDH. More suitably, of the total solids present in the coating mixture, 30-85 wt % is the amino acid-modified LDH. Even more suitably, of the total solids present in the coating mixture, 40-82.5 wt % is the amino acid-modified LDH. Yet more suitably, of the total solids present in the coating mixture, 45-80 wt % is the amino acid-modified LDH. Yet even more suitably, of the total solids present in the coating mixture, 50-75 wt % is the amino acid-modified LDH. Yet even more suitably, of the total solids present in the coating mixture, 52.5-72.5 wt % is the amino acid-modified LDH. Most suitably, of the total solids present in the coating mixture, 55-65 wt % is the amino acid-modified LDH.

In an embodiment, the polymer is a water-soluble polymer. Suitably, the water-soluble polymer is one or more polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA). More suitably, the water-soluble polymer is poly(vinyl alcohol) (PVOH). Alternatively, the polymer is a water-based polymer. The term water-based polymer will be familiar to one of ordinary skill in the art, and is used to denote a polymer that may not be water-soluble, but which has been functionalised to render it readily dispersible in water.

In a particularly suitable embodiment, the polymer is crosslinked PVOH.

In an embodiment, the polymer is poly(vinyl alcohol) (PVOH) having a molecular weight (M_{w}) of 20,000 to 220,000 Da. Suitably, the polymer is poly(vinyl alcohol) (PVOH) having a molecular weight (M_{w}) of 20,000 to 150,000 Da. Suitably, the polymer is poly(vinyl alcohol) (PVOH) having a molecular weight (M_{w}) of 20,000 to 70,000 Da. Suitably, the polymer is poly(vinyl alcohol) (PVOH) having a molecular weight (M_{w}) of 20,000 to 60,000 Da. More suitably, the polymer is poly(vinyl alcohol) (PVOH) having a molecular weight (M_{w}) of 27,000 to 40,000 Da.

In an embodiment, the polymer is poly(vinyl alcohol) (PVOH) having a molecular weight (M_{w}) of 40,000 to 220,000 Da. Suitably, the polymer is poly(vinyl alcohol) (PVOH) having a molecular weight (M_{w}) of 170,000 to 210,000 Da.

In an embodiment, the polymer is poly(vinyl alcohol) (PVOH) having a degree of hydrolysis of 70 to 100 mol %. Suitably, the polymer is poly(vinyl alcohol) (PVOH) having a degree of hydrolysis of 80 to 99 mol %. Suitably, the polymer is poly(vinyl alcohol) (PVOH) having a degree of hydrolysis of 80 to 95 mol %. Suitably, the polymer is poly(vinyl alcohol) (PVOH) having a degree of hydrolysis of 83 to 92 mol %. More suitably, the polymer is poly(vinyl alcohol) (PVOH) having a degree of hydrolysis of 85 to 90 mol %.

In an embodiment, the polymer is poly(vinyl alcohol) (PVOH) having a molecular weight (M_{w}) of 20,000 to 70,000 Da and a degree of hydrolysis of 83 to 92 mol %. Suitably, the polymer is poly(vinyl alcohol) (PVOH) having a molecular weight (M_{w}) of 27,000 to 40,000 Da and a degree of hydrolysis of 85 to 90 mol %.

In an embodiment, the polymer is poly(vinyl alcohol) (PVOH) having a molecular weight (M_{w}) of 40,000 to 220,000 Da and a degree of hydrolysis of 80 to 99 mol %.

In an embodiment, the solvent for the polymer is water. Additional solvents may or may not be present. Suitably, >95 vol. % of the solvent is water.

In an embodiment, the solvent comprises <10 vol. % organic solvent. Suitably, the solvent comprises <5 vol. % organic solvent.

In an embodiment, the coating mixture has a viscosity at 25° C. of 1 to 1000 cP.

The first substrate is suitably sheet-like. Suitably, the first substrate has a thickness of 1-30 μm. More suitably, the first substrate has a thickness of 5-20 μm.

In an embodiment, the first substrate is selected from polyethylene terephthalate (PET), polyethylene (PE), biaxially oriented polypropylene film (BOPP), polypropylene (PP), polyvinyl dichloride (PVDC), polyamide, nylon, and polylactic acid (PLA). Suitably, the first substrate is PET.

In a particularly suitable embodiment, the first substrate is PET having a thickness of 5-20 μm.

In an embodiment, the amino acid-modified LDH contained within the coating mixture is a Zn/Al, Mg/Al, Ca/Al or Zn, Mg/Al LDH. Suitably, the amino acid-modified LDH contained within the coating mixture is a carbonate-containing LDH.

In an embodiment, the amino acid-modified LDH contained within the coating mixture is a Mg/Al LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a carbonate-containing LDH.

In an embodiment, the amino acid-modified LDH contained within the coating mixture is a nitrate-containing LDH.

In an embodiment, the amino acid-modified LDH contained within the coating mixture is a magnesium aluminium carbonate LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a magnesium aluminium nitrate LDH. Suitably, the molar ratio of Mg:Al is (1.9-2.5):1. More suitably, the molar ratio of Mg:Al is (2.0-2.25):1.

In an embodiment, the aspect ratio of the amino acid-modified layered double hydroxide is 10-500, wherein aspect ratio is the average diameter of the layered double hydroxide platelet divided by the average thickness of the layered double hydroxide platelet. Suitably, the aspect ratio of the amino acid-modified layered double hydroxide is greater than 85. More suitably, the aspect ratio of the amino acid-modified layered double hydroxide is 90-400. More suitably, the aspect ratio of the amino acid-modified layered double hydroxide is 100-300. Even more suitably, the aspect ratio of the amino acid-modified layered double hydroxide is >120 (e.g. 121-300). Yet even more suitably, the aspect ratio of the amino acid-modified layered double hydroxide is >150. Yet even more suitably, the aspect ratio of the amino acid-modified layered double hydroxide is >175. Yet even more suitably, the aspect ratio of the amino acid-modified layered double hydroxide is >200. Most suitably, the aspect ratio of the amino acid-modified layered double hydroxide is >225.

In an embodiment, the amino acid-modified layered double hydroxide is a layered double hydroxide comprising an amino acid. The process by which the amino acid-modified layered double hydroxide is made may therefore introduce a quantity of amino acid into the structure of the LDH. The presence of amino acid within the amino acid-modified LDH may be determined by experimental techniques such as FTIR spectroscopy. Suitably, the amino acid-modified layered double hydroxide is a layered double hydroxide comprising 0.1-50 wt % of an amino acid. More suitably, the amino acid-modified layered double hydroxide is a layered double hydroxide comprising 1-25 wt % of an amino acid. More suitably, the amino acid-modified layered double hydroxide is a layered double hydroxide comprising 1.5-15 wt % of an amino acid. More suitably, the amino acid-modified layered double hydroxide is a layered double hydroxide comprising 2-9 wt % of an amino acid. Alternatively, the amino acid-modified layered double hydroxide is a layered double hydroxide comprising 4-12 wt % of an amino acid. The amino acid-modified layered double hydroxide may also be a layered double hydroxide comprising a trace quantity of an amino acid.

In an embodiment, the amino acid is non-aromatic.

In an embodiment, the amino acid is selected from the group consisting of aspartic acid, glutamic acid, asparagine, serine, glycine, β-alanine, β-aminobutyric acid, γ-aminobutyric acid and β-leucine. The amino acid-modified layered double hydroxide may also be selected from glutamic acid, aspartic acid, asparagine and serine. Suitably, the amino acid is selected from the group consisting of glycine, β-alanine, β-aminobutyric acid and β-leucine. More suitably, the amino acid is selected from the group consisting of glycine, β-alanine and β-aminobutyric acid. Most suitably, the amino acid is β-aminobutyric acid or glycine.

In a particularly suitable embodiment, the amino acid is glycine.

In an embodiment, the coating mixture provided in step a) is prepared by a process comprising the step of mixing at least the following:
i. a layered double oxide
ii. an amino acid
iii. the polymer,
iv. the solvent for the polymer, and optionally either or both of:
   a. a source of an inorganic oxyanion (e.g. a salt), and
   b. a polymer crosslinking agent (e.g. a crosslinking agent suitable for crosslinking PVOH, such as trisodium trimetaphosphate).
      Suitable inorganic oxyanions include carbonates, bicarbonates, hydrogenphosphates, dihydrogenphosphates, nitrites, borates, nitrates, phosphates and sulphates.

Coating mixtures prepared in accordance with the present invention allows for a greater degree of control over the composition of the coating mixture. Coating mixtures used in the prior art have been prepared by blending together polymerisable acrylic monomers, other polymers and inorganic materials (e.g. clays) in the presence of a solvent and then conducting radical polymerisation of the resulting blend under elevated temperature to yield the polymeric coating mixture. As a consequence, coating mixtures prepared by such in-situ polymerisation techniques are likely to contain a variety of polymeric products, each having different properties (e.g. molecular weight). This necessarily makes it different to prepare multiple batches of coating mixture to the exact same specification. In contrast to this approach, the coating mixtures of the present process can be prepared by mixing together predetermined quantities of i) an LDO, ii) an amino acid, iii) a polymer iii) a solvent for the polymer. The resulting polymeric solution therefore has pre-determined properties (e.g. viscosity). The present process also eliminates the risk of generating potentially unwanted (or harmful) side products by uncontrolled radical polymerisation of a complex blend of ingredients.

In a particularly suitable embodiment, step a) comprises the steps of:
a-i) providing a layered double oxide;
a-ii) providing a mixture of an amino acid and a solvent for the amino acid (e.g. water);
a-iii) providing a mixture of the polymer and the solvent for the polymer;
a-iv) contacting the layered double oxide with the mixture of step a-ii) to yield an amino acid-modified layered double hydroxide; and
a-v) contacting the amino acid-modified layered double hydroxide with the mixture of step a-iii) to yield the coating mixture.

As used herein, the term “layered double oxide” (LDO) will be understood to denote a semi-amorphous mixed metal oxide obtainable by thermally treating (e.g. in air) a precursor layered double hydroxide at a temperature of 260-550° C. Due to the “memory effect”, LDOs obtainable by thermally treating a precursor layered double hydroxide at such a temperature will reform the layered double hydroxide structure upon addition of water and an anion. The precursor LDH will be understood as being that which is, once thermally treated at the specific temperature, yields a LDO. Suitably, the layered double oxide is obtainable by thermally treating a precursor layered double hydroxide at a temperature of 290-525° C. More suitably, the layered double oxide is obtainable by thermally treating a precursor layered double hydroxide at a temperature of 310-500° C. More suitably, the layered double oxide is obtainable by thermally treating a precursor layered double hydroxide at a temperature of 325-475° C. Most suitably, the layered double oxide is obtainable by thermally treating a precursor layered double hydroxide at a temperature of 400-475° C.

Yet a further advantage of the present process is that the use of an LDO-derived LDH considerably reduces the possibility of the coated substrate being contaminated with harmful organic products. For example, urea, which is commonly used in LDH manufacturing processes to improve the aspect ratio of LDH platelets, is known to be toxic, thus presenting considerations for manufacturers of food packaging. However, the present inventors have now surprisingly found that high aspect ratio LDH platelets can be prepared by reconstructing (e.g. rehydrating and anion intercalation) an LDH from the corresponding LDO, even when the precursor LDH was of a low aspect ratio prepared by a non-urea containing synthesis (e.g. simple coprecipitation). Even if the precursor LDH is prepared by a urea-containing synthesis, thermally treating the LDH (e.g. at 260-550° C.) to yield the corresponding LDO will mean that any residual urea present within the LDH is removed, meaning that the LDH that is subsequently reformed from the LDO (e.g. by reconstruction) is free from urea.

In an embodiment, the layered double hydroxide present within the coating mixture is substantially free from organic compounds used in the preparation of layered double hydroxides.

In an embodiment, the layered double hydroxide present within the coating mixture is substantially free from toxic organic compounds (e.g. urea).

In an embodiment, the layered double hydroxide present within the coating mixture is free from urea. Hence, the coated substrate is free from urea.

In an embodiment, the layered double oxide is obtainable by thermally treating a precursor layered double hydroxide for a period of 1-48 hours. Suitably, the layered double oxide is obtainable by thermally treating a precursor layered double hydroxide for a period of 4-24 hours. More suitably, the layered double oxide is obtainable by thermally treating a precursor layered double hydroxide for a period of 6-18 hours. The ramp rate used as part of the thermal treatment step may be 2.5-7.5° C./min.

In an embodiment, the layered double oxide is obtainable by thermally treating a precursor layered double hydroxide in air.

In an embodiment, during step a-iv), the amino acid is in an excess with respect to the layered double oxide. Suitably, the weight ratio of amino acid (e.g. glycine) to layered double hydroxide in step a-iv) is 1.1:1 to 2:1.

In an embodiment, step a-iv) is conducted at a temperature of 50-150° C. Suitably, step a-iv) is conducted at a temperature of 70-120° C. Step a-iv) may be conducted under hydrothermal conditions.

In an embodiment, step a-iv) is conducted for >1 minute. Suitably, step a-iv) is conducted for >2 minutes. More suitably, step a-iv) is conducted for >10 minutes. More suitably, step a-iv) is conducted for >1 hour. Even more suitably, step a-iv) is conducted for >2 hours. Yet more suitably, step a-iv) is conducted for >5 hours. Most suitably, step a-iv) is conducted for >10 hours.

In an embodiment, the solvent for the amino acid is water.

In an embodiment, the mixture of step a-ii) and/or step a-iii) further comprises either or both of
a) a source of an inorganic oxyanion (e.g. a salt), and
b) a polymer crosslinking agent (e.g. a crosslinking agent suitable for crosslinking PVOH, such as trisodium trimetaphosphate).

In an embodiment, prior to step a-v), a base (e.g. NaOH) is added to the mixture resulting from step a-iv) to precipitate the amino acid-modified LDH. Before adding into the mixture of step a-iii), the isolated amino acid-modified LDH is washed with water.

The precursor LDH used to form the LDO and/or the amino acid-modified LDH may have a structure according to formula (I) shown below:

[M^{z+}₁₋ₓM′^{y+}ₓ(OH)₂]^{a+}(Xⁿ⁻)ₘ.bH₂O.c(solv) (I)
wherein
   M is a charged metal cation;
   M′ is a charged metal cation different from M;
   z is 1 or 2;
   y is 3 or 4;
   0<x<0.9;
   0<b≤10;
   0≤c≤10
   X is an anion;
   n is the charge on anion X;
   a is equal to z(1−x)+xy−2;
   m≥a/n; and
   solv denotes an organic solvent capable of hydrogen-bonding to water.

In an embodiment, when z is 2, M is Mg, Zn, Fe, Ca, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Fe, Ti, or a mixture thereof, or when y is 4, M′ is Ti. Suitably, y is 3. More suitably, y is 3 and M′ is Al.

In an embodiment, M′ is Al.

In an embodiment, 0<c≤10.

In an embodiment, X is at least one anion selected from the group consisting of a halide (e.g., chloride) and an inorganic oxyanion (e.g. X′ₘOₙ(OH)ₚ—, in which m=1-5; n=2-10; p=0-4, q=1-5; X′ ═B, C, N, S, P; such as carbonate, bicarbonate, hydrogenphosphate, dihydrogenphosphate, nitrite, borate, nitrate, phosphate, sulphate, hydroxide, silicate). Suitably, X is at least one anion selected from the group consisting of carbonate, bicarbonate, nitrate and nitrite. Most suitably, X is carbonate.

In an embodiment, x has a value according to the expression 0.18<x<0.9. Suitably, x has a value according to the expression 0.18<x<0.5. More suitably, x has a value according to the expression 0.18<x<0.4.

In an embodiment, the precursor LDH and/or the amino acid-modified LDH is a flower-like layered double hydroxide or a platelet-like layered double hydroxide. The term flower-like LDH will be understood by one of skill in the art to denote one which has been prepared according to a co-precipitation technique. The term platelet-like LDH will be understood by one of skill in the art to denote one which has been prepared according to a urea-hydrothermal technique.

In an embodiment, the precursor LDH and/or the amino acid-modified LDH is a Zn/Al, Mg/Al, Ca/Al or Zn, Mg/Al LDH. Suitably, the precursor LDH and/or the amino acid-modified LDH is a Mg/Al LDH.

In an embodiment, the amino acid-modified LDH is a carbonate-containing LDH.

Step b) of the present process may be performed by various different techniques.

In one embodiment, the coating mixture may be applied to the substrate in step b) by spraying, dip coating or spin coating.

Alternatively, the coating mixture may be applied to the substrate in step b) using a bath-and-roller assembly. Such assemblies will be understood to comprise a rotating roller being in partial contact with a bath containing a coating mixture. As the roller rotates, the coating mixture coats the surface of the roller, and is transferred onto a substrate passing over the surface of the roller. Additional rollers may be present to meter the quantity of coating mixture applied to the substrate, or to remove excess coating mixture. Such assemblies may additionally comprise a Mayer rod, or other means, to ensure uniform distribution of the coating mixture across the surface of the substrate.

In an embodiment, the coating mixture is applied to the substrate in step b) at a thickness of 0.5 μm-100 μm. Suitably, the coating mixture is applied to the substrate in step b) at a thickness of 1 μm-60 μm. More suitably, the coating mixture is applied to the substrate in step b) at a thickness of 2 μm-45 μm.

The coated substrate prepared by the process of the invention may have a laminated structure. In such cases, after step b) and prior to step c), the coated first substrate is contacted with a second substrate, such that the layer of coating mixture is provided between the first and second substrates. In such an embodiment, the wet coating mixture serves as an adhesive to adhere the second substrate to the first substrate.

Alternatively, a laminated structure may be achieved by using a separate, dedicated adhesive layer. Hence, the process may further comprise the steps of:
d) applying a layer of adhesive to the dried coated first substrate resulting from step c), such that the layer of adhesive is provided on top of the layer applied during step b); and
e) contacting the layer of adhesive applied in step d) with a second substrate.

The second substrate is suitably sheet-like. The second substrate may be selected from polyethylene terephthalate (PET), polyethylene (PE), polypropylene (PP), polyamide, nylon, polylactic acid (PLA) and polyvinyl dichloride (PVDC). The second substrate and the first substrate may be the same or different.

The adhesive may be selected from cellulose acetate, poly(vinyl alcohol) (PVOH), polyvinyl acetate, polyvinyl dichloride (PVDC), polyurethane, an acrylic-based adhesive, an epoxy resin and mixtures thereof. Alternatively, the adhesive may be a copolymer based on one or the aforementioned polymers and one or more additional comonomers, such as ethylene (e.g. polyethylene vinyl alcohol). Suitably, the adhesive is food-grade. Suitably, the adhesive may also comprise a curing agent.

In an embodiment, the adhesive may be a polyurethane and/or acrylic-based adhesive.

The coated substrate may comprise more than one coating layer. the process comprises a step d′) of coating the dried layer of coating mixture resulting from step c) with a further layer of coating mixture, and then drying the further layer of coating mixture. Step d′) may be repeated multiple times to afford a substrate containing a plurality of individually coated layers. It will be appreciated that each coating layer may be the same or different.

In an embodiment, the coated substrate has an oxygen transmission rate (OTR) of <7.0 cc/m²/day/atm. OTR can be measured using the procedure outlined in Example 6, Materials and methods. Suitably, the coated substrate has an OTR of <5.5 cc/m²/day/atm. More suitably, the coated substrate has an OTR of <3.0 cc/m²/day/atm. More suitably, the coated substrate has an OTR of <1.5 cc/m²/day/atm. Even more suitably, the coated substrate has an OTR of <1.0 cc/m²/day/atm. Yet even more suitably, the coated substrate has an OTR of <0.50 cc/m²/day/atm. Yet even more suitably, the coated substrate has an OTR of <0.10 cc/m²/day/atm. Yet even more suitably, the coated substrate has an OTR of <0.050 cc/m²/day/atm. Yet even more suitably, the coated substrate has an OTR of <0.010 cc/m²/day/atm. Most suitably, the coated substrate has an OTR of <0.0075 cc/m²/day/atm.

In an embodiment, the coated substrate has a water vapour transmission rate (WVTR) of <7.0 g/m²/day. WVTR can be measured using the procedure outlined in Example 6, Materials and methods. The values included herein were recorded at 50% RH and 23° C. Suitably, the coated substrate has a WVTR of <4.0 g/m²/day. More suitably, the coated substrate has a WVTR of <2.5 g/m²/day. More suitably, the coated substrate has a WVTR of <1.5 g/m²/day. Even more suitably, the coated substrate has a WVTR of <1.25 g/m²/day. Yet even more suitably, the coated substrate has a WVTR of <1.0 g/m²/day. Yet even more suitably, the coated substrate has a WVTR of <0.50 g/m²/day. Yet even more suitably, the coated substrate has a WVTR of <0.10 g/m²/day. Most suitably, the coated substrate has a WVTR of <0.075 g/m²/day.

In an embodiment, the coated substrate has an OTR of <7.0 cc/m²/day/atm and a WVTR of <7.0 g/m²/day. Suitably, the coated substrate has an OTR of <5.5 cc/m²/day/atm and a WVTR of <2.5 g/m²/day. More suitably, the coated substrate has an OTR of <3.0 cc/m²/day/atm and a WVTR of <1.5 g/m²/day. Even more suitably, the coated substrate has an OTR of <1.5 cc/m²/day/atm and a WVTR of <1.25 g/m²/day. Even more suitably, the coated substrate has an OTR of <1.0 cc/m²/day/atm and a WVTR of <1.0 g/m²/day. Yet even more suitably, the coated substrate has an OTR of <0.5 cc/m²/day/atm and a WVTR of <0.50 g/m²/day. Yet even more suitably, the coated substrate has an OTR of <0.10 cc/m²/day/atm and a WVTR of <0.10 g/m²/day. Most suitably, the coated substrate has an OTR of <0.005 cc/m²/day/atm and a WVTR of <0.075 g/m²/day.

### Coated Substrates

According to a second aspect of the present invention, there is provided a coated substrate obtainable by a process according to the first aspect.

According to a third aspect of the present invention, there is provided a coated substrate comprising:
a) a first substrate; and
b) a coating layer provided on at least one surface of the first substrate,
wherein the coating layer comprises 20-90 wt % of an amino acid-modified layered double hydroxide dispersed throughout a polymeric matrix.

The coated substrates of the invention have improved OTR properties with respect to prior art films.

It will be understood that the coated substrates of the invention are distinguished from LbL-prepared films by virtue of the fact that they do not contain a plurality of alternating layers of polymer and LDH. Rather, the coated substrates of the invention contain a single layer of LDH dispersed throughout a polymeric matrix. The LDH may be randomly dispersed throughout the polymeric matrix.

In an embodiment, the amino acid-modified LDH is substantially free from toxic organic compounds (e.g. urea). Hence, the coated substrate is substantially free from toxic organic compounds (e.g. urea).

In an embodiment, the amino acid-modified LDH is free from urea. Hence, the coated substrate is free from urea.

In an embodiment, the amino acid-modified LDH is randomly dispersed throughout the polymeric matrix.

In an embodiment, the weight ratio of amino acid-modified layered double hydroxide to polymer in the coating layer ranges from 1:9 to 9:1. Suitably, the weight ratio of amino acid-modified layered double hydroxide to polymer in the coating layer ranges from 1:6 to 4:1. Suitably, the weight ratio of amino acid-modified layered double hydroxide to polymer in the coating layer ranges from 1:4 to 4:1. More suitably, the weight ratio of amino acid-modified layered double hydroxide to polymer in the coating layer ranges from 1:2 to 3:1.

In an embodiment, the polymeric matrix comprises a water-soluble polymer. Suitably, the water-soluble polymer is one or more polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA). More suitably, the water-soluble polymer is poly(vinyl alcohol) (PVOH). Alternatively, the polymeric matrix comprises a water-based polymer. The term water-based polymer will be familiar to one of ordinary skill in the art, and is used to denote a polymer that may not be water-soluble, but which has been functionalised to render it readily dispersible in water.

In a particularly suitable embodiment, the polymer is crosslinked PVOH.

In an embodiment, the polymeric matrix comprises poly(vinyl alcohol) (PVOH) having a molecular weight (M_{w}) of 20,000 to 220,000 Da. Suitably, the polymeric matrix comprises poly(vinyl alcohol) (PVOH) having a molecular weight (M_{w}) of 20,000 to 150,000 Da. Suitably, the polymeric matrix comprises poly(vinyl alcohol) (PVOH) having a molecular weight (M_{w}) of 20,000 to 70,000 Da. Suitably, the polymeric matrix comprises poly(vinyl alcohol) (PVOH) having a molecular weight (M_{w}) of 20,000 to 60,000 Da. More suitably, the polymeric matrix comprises poly(vinyl alcohol) (PVOH) having a molecular weight (M_{w}) of 27,000 to 40,000 Da.

In an embodiment, the polymeric matrix comprises poly(vinyl alcohol) (PVOH) having a molecular weight (M_{w}) of 40,000 to 220,000 Da. Suitably, the polymeric matrix comprises poly(vinyl alcohol) (PVOH) having a molecular weight (M_{w}) of 170,000 to 210,000 Da.

In an embodiment, the polymeric matrix comprises poly(vinyl alcohol) (PVOH) having a degree of hydrolysis of 70 to 100 mol %. Suitably, the polymeric matrix comprises poly(vinyl alcohol) (PVOH) having a degree of hydrolysis of 80 to 99 mol %. Suitably, the polymeric matrix comprises poly(vinyl alcohol) (PVOH) having a degree of hydrolysis of 80 to 95 mol %. Suitably, the polymeric matrix comprises poly(vinyl alcohol) (PVOH) having a degree of hydrolysis of 83 to 92 mol %. More suitably, the polymeric matrix comprises poly(vinyl alcohol) (PVOH) having a degree of hydrolysis of 85 to 90 mol %.

In an embodiment, the polymeric matrix comprises poly(vinyl alcohol) (PVOH) having a molecular weight (M_{w}) of 20,000 to 70,000 Da and a degree of hydrolysis of 83 to 92 mol %. Suitably, the polymeric matrix comprises poly(vinyl alcohol) (PVOH) having a molecular weight (M_{w}) of 27,000 to 40,000 Da and a degree of hydrolysis of 85 to 90 mol %.

In an embodiment, the polymeric matrix comprises poly(vinyl alcohol) (PVOH) having a molecular weight (M_{w}) of 40,000 to 220,000 Da and a degree of hydrolysis of 80 to 99 mol %.

In an embodiment, the coating layer comprises 25-80 wt % of the amino acid-modified layered double hydroxide. Suitably, the coating layer comprises 30-75 wt % of the amino acid-modified layered double hydroxide. More suitably, the coating layer comprises 35-75 wt % of the amino acid-modified layered double hydroxide.

In an embodiment, the coating layer comprises 20-87.5 wt % of the amino acid-modified layered double hydroxide. Suitably, the coating layer comprises 30-85 wt % of the amino acid-modified layered double hydroxide. More suitably, the coating layer comprises 40-82.5 wt % of the amino acid-modified layered double hydroxide. More suitably, the coating layer comprises 45-80 wt % of the amino acid-modified layered double hydroxide. Even more suitably, the coating layer comprises 50-75 wt % of the amino acid-modified layered double hydroxide. Even more suitably, the coating layer comprises 52.5-72.5 wt % of the amino acid-modified layered double hydroxide. Most suitably, the coating layer comprises 55-65 wt % of the amino acid-modified layered double hydroxide.

The first substrate is suitably sheet-like. Suitably, the first substrate has a thickness of 1-30 μm. More suitably, the first substrate has a thickness of 5-20 μm.

In an embodiment, the first substrate is selected from polyethylene terephthalate (PET), polyethylene (PE), blaxially oriented polypropylene film (BOPP), polypropylene (PP), polyvinyl dichloride (PVDC), polyamide, nylon, and polylactic acid (PLA). Suitably, the first substrate is PET.

In a particularly suitable embodiment, the first substrate is PET having a thickness of 5-20 μm.

In an embodiment, the amino acid-modified LDH is a Zn/Al, Mg/Al, Ca/Al or Zn, Mg/A LDH. Suitably, the amino acid-modified LDH is a carbonate-containing LDH.

In an embodiment, the amino acid-modified LDH is a Mg/Al LDH. Suitably, the molar ratio of Mg:Al is (1.9-2.5):1. More suitably, the molar ratio of Mg:Al is (2.0-2.25):1.

In an embodiment, the amino acid-modified LDH is a carbonate-containing LDH.

In an embodiment, the amino acid-modified LDH is a nitrate-containing LDH.

In an embodiment, the amino acid-modified LDH contained within the coating layer is a magnesium aluminium carbonate LDH. Suitably, the molar ratio of Mg:Al is (1.9-2.5):1. More suitably, the molar ratio of Mg:Al is (2.0-2.25):1.

In an embodiment, the amino acid-modified LDH contained within the coating layer is a magnesium aluminium nitrate LDH. Suitably, the molar ratio of Mg:Al is (1.9-2.5):1. More suitably, the molar ratio of Mg:Al is (2.0-2.25):1.

In an embodiment, the aspect ratio of the amino acid-modified LDH is 10-500, wherein aspect ratio is the average diameter of the layered double hydroxide platelet divided by the average thickness of the layered double hydroxide platelet. Suitably, the aspect ratio of the amino acid-modified LDH is greater than 85. More suitably, the aspect ratio of the amino acid-modified LDH is 90-400. More suitably, the aspect ratio of the amino acid-modified LDH is 100-300. Even more suitably, the aspect ratio of the amino acid-modified layered double hydroxide is >120 (e.g. 121-300). Yet even more suitably, the aspect ratio of the amino acid-modified layered double hydroxide is >150. Yet even more suitably, the aspect ratio of the amino acid-modified layered double hydroxide is >175. Yet even more suitably, the aspect ratio of the amino acid-modified layered double hydroxide is >200. Most suitably, the aspect ratio of the amino acid-modified layered double hydroxide is >225.

In an embodiment, the amino acid-modified layered double hydroxide is a layered double hydroxide comprising an amino acid. The process by which the amino acid-modified layered double hydroxide is made may therefore introduce a quantity of amino acid into the structure of the LDH. The presence of amino acid within the amino acid-modified LDH may be determined by experimental techniques such as FTIR spectroscopy. Suitably, the amino acid-modified layered double hydroxide is a layered double hydroxide comprising 0.1-50 wt % of an amino acid. More suitably, the amino acid-modified layered double hydroxide is a layered double hydroxide comprising 1-25 wt % of an amino acid. More suitably, the amino acid-modified layered double hydroxide is a layered double hydroxide comprising 1.5-15 wt % of an amino acid. More suitably, the amino acid-modified layered double hydroxide is a layered double hydroxide comprising 2-9 wt % of an amino acid. Alternatively, the amino acid-modified layered double hydroxide is a layered double hydroxide comprising 4-12 wt % of an amino acid. The amino acid-modified layered double hydroxide may also be a layered double hydroxide comprising a trace quantity of an amino acid.

In an embodiment, the amino acid is non-aromatic.

In an embodiment, the amino acid is selected from the group consisting of aspartic acid, glutamic acid, asparagine, serine, glycine, β-alanine, β-aminobutyric acid, γ-aminobutyric acid and β-leucine. The amino acid-modified layered double hydroxide may also be selected from glutamic acid, aspartic acid, asparagine and serine. Suitably, the amino acid is selected from the group consisting of glycine, β-alanine, β-aminobutyric acid and β-leucine. More suitably, the amino acid is selected from the group consisting of glycine, β-alanine and β-aminobutyric acid. Most suitably, the amino acid is β-aminobutyric acid or glycine.

In a particularly suitable embodiment, the amino acid is glycine.

In an embodiment, the amino acid-modified LDH has a structure according to formula (I) shown below:

[M^{z+}₁₋ₓM′^{y+}ₓ(OH)₂]^{a+}(Xⁿ⁻)ₘ.bH₂O.c(solv) (I)
wherein
   M is a charged metal cation;
   M′ is a charged metal cation different from M;
   z is 1 or 2;
   y is 3 or 4;
   0<x<0.9;
   0<b≤10;
   0≤c≤10;
   X is an anion;
   n is the charge on anion X;
   a is equal to z(1−x)+xy−2;
   m≥a/n; and
   solv denotes an organic solvent capable of hydrogen-bonding to water.

In an embodiment, when z is 2, M is Mg, Zn, Fe, Ca, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Fe, Ti, or a mixture thereof, or when y is 4, M′ is Ti. Suitably, y is 3. More suitably, y is 3 and M′ is Al.

In an embodiment, M′ is Al.

In an embodiment, 0<c≤10.

In an embodiment, X is at least one anion selected from the group consisting of a halide (e.g., chloride) and an inorganic oxyanion (e.g. X′ₘOₙ(OH)ₚ^{-q}, in which m=1-5; n=2-10; p=0-4, q=1-5; X′ ═B, C, N, S, P; such as carbonate, bicarbonate, hydrogenphosphate, dihydrogenphosphate, nitrite, borate, nitrate, phosphate, sulphate, hydroxide, silicate). Suitably, X is at least one anion selected from the group consisting of carbonate, bicarbonate, nitrate and nitrite. Most suitably, X is carbonate.

In an embodiment, x has a value according to the expression 0.18<x<0.9. Suitably, x has a value according to the expression 0.18<x<0.5. More suitably, x has a value according to the expression 0.18<x<0.4.

In an embodiment, the amino acid-modified LDH is a flower-like layered double hydroxide or a platelet-like layered double hydroxide. The term flower-like LDH will be understood by one of skill in the art to denote one which has been prepared according to a co-precipitation technique. The term platelet-like LDH will be understood by one of skill in the art to denote one which has been prepared according to a urea-hydrothermal technique.

In another embodiment, the coating layer has a thickness of 0.1-10 μm (e.g. 1-10 μm).

In an embodiment, the coating layer has a thickness of 20 nm-5.0 μm. Suitably, the coating layer has a thickness of 50 nm-2.5 μm. Suitably, the coating layer has a thickness of 100 nm-1.8 μm.

In an embodiment, the coated substrate comprises multiple coating layers. Suitably, the coated substrate comprises 1-10 individually coated layers. Suitably, the coated substrate comprises 1-4 individually coated layers.

In another embodiment, the coating layer comprises:
a) 25-80 wt % of amino acid-modified LDH;
b) 20-75 wt % of polymeric matrix; and
c) 0-2 wt % of solvent (e.g. water).

In another embodiment, the coating layer comprises:
a) 35-75 wt % of amino acid-modified LDH;
b) 25-65 wt % of poly(vinyl alcohol); and
c) 0-2 wt % of water.

The coated substrate may have a laminated structure. Hence, in one embodiment, the substrate is a first substrate, and the coated substrate comprises a second substrate disposed on top of the coating layer, such that the coating layer is located between the first and second substrates. In such embodiments, the coating layer serves as an adhesive to adhere the second substrate to the first substrate.

Alternatively, the coated substrate comprises a layer of adhesive provided between the coating layer and the second substrate. In such embodiments, a dedicated adhesive layer adheres the second substrate to the coated first substrate. The adhesive may be a polyurethane and/or acrylic-based adhesive.

In an embodiment, the coated substrate has an oxygen transmission rate (OTR) of <7.0 cc/m²/day/atm. OTR can be measured using the procedure outlined in Example 6, Materials and methods. Suitably, the coated substrate has an OTR of <5.5 cc/m²/day/atm. More suitably, the coated substrate has an OTR of <3.0 cc/m²/day/atm. More suitably, the coated substrate has an OTR of <1.5 cc/m²/day/atm. Even more suitably, the coated substrate has an OTR of <1.0 cc/m²/day/atm. Yet even more suitably, the coated substrate has an OTR of <0.50 cc/m²/day/atm. Yet even more suitably, the coated substrate has an OTR of <0.10 cc/m²/day/atm. Yet even more suitably, the coated substrate has an OTR of <0.050 cc/m²/day/atm. Yet even more suitably, the coated substrate has an OTR of <0.010 cc/m²/day/atm. Most suitably, the coated substrate has an OTR of <0.0075 cc/m²/day/atm.

In an embodiment, the coated substrate has a water vapour transmission rate (WVTR) of <7.0 g/m²/day. WVTR can be measured using the procedure outlined in Example 6, Materials and methods. Suitably, the coated substrate has a WVTR of <4.0 g/m²/day. More suitably, the coated substrate has a WVTR of <2.5 g/m²/day. More suitably, the coated substrate has a WVTR of <1.5 g/m²/day. Even more suitably, the coated substrate has a WVTR of <1.25 g/m²/day. Yet even more suitably, the coated substrate has a WVTR of <1.0 g/m²/day. Yet even more suitably, the coated substrate has a WVTR of <0.50 g/m²/day. Yet even more suitably, the coated substrate has a WVTR of <0.10 g/m²/day. Most suitably, the coated substrate has a WVTR of <0.075 g/m²/day.

In an embodiment, the coated substrate has an OTR of <7.0 cc/m²/day/atm and a WVTR of <7.0 g/m²/day. Suitably, the coated substrate has an OTR of <5.5 cc/m²/day/atm and a WVTR of <2.5 g/m²/day. More suitably, the coated substrate has an OTR of <3.0 cc/m²/day/atm and a WVTR of <1.5 g/m²/day. Even more suitably, the coated substrate has an OTR of <1.5 cc/m²/day/atm and a WVTR of <1.25 g/m²/day. Even more suitably, the coated substrate has an OTR of <1.0 cc/m²/day/atm and a WVTR of <1.0 g/m²/day. Yet even more suitably, the coated substrate has an OTR of <0.5 cc/m²/day/atm and a WVTR of <0.50 g/m²/day. Yet even more suitably, the coated substrate has an OTR of <0.10 cc/m²/day/atm and a WVTR of <0.10 g/m²/day. Most suitably, the coated substrate has an OTR of <0.005 cc/m²/day/atm and a WVTR of <0.075 g/m²/day.

### Preparation of Coating Mixtures

According to a fourth aspect of the present invention, there is provided a process for the preparation of a coating mixture suitable for use in a coating application, the coating mixture comprising an amino acid-modified layered double hydroxide, a polymer and a solvent for the polymer, the process comprising the step of:
a) mixing at least the following:
   i. an amino acid-modified layered double hydroxide,
   ii. a polymer, and
   iii. a solvent for the polymer.

The coating mixtures prepared in accordance with the fourth aspect of the invention are useable in accordance with the first aspect of the invention. The numerous advantages discussed hereinbefore in connection with the first aspect of the invention are thereby equally applicable to the fourth aspect of the invention.

Of particular note is that the amino acid-modified LDH contained within the coating mixture has improved morphological properties when compared with LDHs employed in prior art techniques. The amino acid-modified LDHs may be obtainable by a process in which a layered double oxide (LDO) is contacted with an amino acid in a solvent (e.g. water) in air. Upon contacting the amino acid and solvent, the LDO is converted (e.g. reconstructed) into an LDH. Without wishing to be bound by theory, it is believed that the presence of the amino acid during the reformation of the LDH from the LDO gives rise to an LDH having advantageous morphological properties. In particular, when compared with the LDH contained in coating mixtures that are formed by mixing LDH directly with the other components of the mixture, the amino acid-modified LDH may have an improved aspect ratio. The aspect ratio of the LDH platelets is seen as an important factor in the formation of coatings having a sufficiently tortuous pathway to reduce the transmission of gases and vapours (e.g. 02 and H₂O).

In an embodiment, the combined quantity of the amino acid-modified LDH and polymer in the coating mixture is 2.5-10.0% by weight relative to the total weight of the coating mixture. Suitably, the combined quantity of the amino acid-modified LDH and polymer in the coating mixture is 2.5-7.5% by weight relative to the total weight of the coating mixture. Suitably, the combined quantity of the amino acid-modified LDH and polymer in the coating mixture is 3-7% by weight relative to the total weight of the coating mixture. More suitably, the combined quantity of the amino acid-modified LDH and polymer in the coating mixture is 3.5-6.5% by weight relative to the total weight of the coating mixture. Yet more suitably, the combined quantity of the amino acid-modified LDH and polymer in the coating mixture is 4-6% by weight relative to the total weight of the coating mixture.

In an embodiment, the combined quantity of the amino acid-modified LDH and polymer in the coating mixture is 2.0-20.0% by weight relative to the total weight of the coating mixture. Suitably, the combined quantity of the amino acid-modified LDH and polymer in the coating mixture is 3.0-17.0% by weight relative to the total weight of the coating mixture. Suitably, the combined quantity of the amino acid-modified LDH and polymer in the coating mixture is 4.0-15.0% by weight relative to the total weight of the coating mixture. Suitably, the combined quantity of the amino acid-modified LDH and polymer in the coating mixture is 5.0-14.0% by weight relative to the total weight of the coating mixture. More suitably, the combined quantity of the amino acid-modified LDH and polymer in the coating mixture is 6.0-14.0% by weight relative to the total weight of the coating mixture. Yet more suitably, the combined quantity of the amino acid-modified LDH and polymer in the coating mixture is 8.0-12.0% by weight relative to the total weight of the coating mixture.

In an embodiment, the weight ratio of amino acid-modified LDH to polymer in the coating mixture ranges from 1:9 to 9:1. Suitably, the weight ratio of amino acid-modified LDH to polymer in the coating mixture ranges from 1:6 to 4:1. Suitably, the weight ratio of amino acid-modified LDH to polymer in the coating mixture ranges from 1:4 to 4:1. More suitably, the weight ratio of amino acid-modified LDH to polymer in the coating mixture ranges from 1:2 to 3:1.

In an embodiment, of the total solids (i.e. polymer and amino acid-modified LDH) present in the coating mixture, 10-90 wt % is the amino acid-modified LDH. Suitably, of the total solids present in the coating mixture, 20-87.5 wt % is the amino acid-modified LDH. More suitably, of the total solids present in the coating mixture, 30-85 wt % is the amino acid-modified LDH. Even more suitably, of the total solids present in the coating mixture, 40-82.5 wt % is the amino acid-modified LDH. Yet more suitably, of the total solids present in the coating mixture, 45-80 wt % is the amino acid-modified LDH. Yet even more suitably, of the total solids present in the coating mixture, 50-75 wt % is the amino acid-modified LDH. Yet even more suitably, of the total solids present in the coating mixture, 52.5-72.5 wt % is the amino acid-modified LDH. Most suitably, of the total solids present in the coating mixture, 55-65 wt % is the amino acid-modified LDH.

In an embodiment, the polymer is a water-soluble polymer. Suitably, the water-soluble polymer is one or more polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA). More suitably, the water-soluble polymer is poly(vinyl alcohol) (PVOH). Alternatively, the polymer is a water-based polymer. The term water-based polymer will be familiar to one of ordinary skill in the art, and is used to denote a polymer that may not be water-soluble, but which has been functionalised to render it readily dispersible in water.

In a particularly suitable embodiment, the polymer is crosslinked PVOH.

In an embodiment, the polymer is poly(vinyl alcohol) (PVOH) having a molecular weight (M_{w}) of 20,000 to 220,000 Da. Suitably, the polymer is poly(vinyl alcohol) (PVOH) having a molecular weight (M_{w}) of 20,000 to 150,000 Da. Suitably, the polymer is poly(vinyl alcohol) (PVOH) having a molecular weight (M_{w}) of 20,000 to 70,000 Da. Suitably, the polymer is poly(vinyl alcohol) (PVOH) having a molecular weight (M_{w}) of 20,000 to 60,000 Da. More suitably, the polymer is poly(vinyl alcohol) (PVOH) having a molecular weight (M_{w}) of 27,000 to 40,000 Da.

In an embodiment, the polymer is poly(vinyl alcohol) (PVOH) having a molecular weight (M_{w}) of 40,000 to 220,000 Da. Suitably, the polymer is poly(vinyl alcohol) (PVOH) having a molecular weight (M_{w}) of 170,000 to 210,000 Da.

In an embodiment, the polymer is poly(vinyl alcohol) (PVOH) having a degree of hydrolysis of 70 to 100 mol %. Suitably, the polymer is poly(vinyl alcohol) (PVOH) having a degree of hydrolysis of 80 to 99 mol %. Suitably, the polymer is poly(vinyl alcohol) (PVOH) having a degree of hydrolysis of 80 to 95 mol %. Suitably, the polymer is poly(vinyl alcohol) (PVOH) having a degree of hydrolysis of 83 to 92 mol %. More suitably, the polymer is poly(vinyl alcohol) (PVOH) having a degree of hydrolysis of 85 to 90 mol %.

In an embodiment, the polymer is poly(vinyl alcohol) (PVOH) having a molecular weight (M_{w}) of 20,000 to 70,000 Da and a degree of hydrolysis of 83 to 92 mol %. Suitably, the polymer is poly(vinyl alcohol) (PVOH) having a molecular weight (M_{w}) of 27,000 to 40,000 Da and a degree of hydrolysis of 85 to 90 mol %.

In an embodiment, the polymer is poly(vinyl alcohol) (PVOH) having a molecular weight (M_{w}) of 40,000 to 220,000 Da and a degree of hydrolysis of 80 to 99 mol %.

In an embodiment, the solvent for the polymer is water. Additional solvents may or may not be present. Suitably, >95 vol. % of the solvent is water.

In an embodiment, the solvent comprises <10 vol. % organic solvent. Suitably, the solvent comprises <5 vol. % organic solvent.

In an embodiment, the coating mixture has a viscosity at 25° C. of 1 to 1000 cP.

In an embodiment, the amino acid-modified LDH contained within the coating mixture is a Zn/Al, Mg/Al, Ca/Al or Zn, Mg/Al LDH. Suitably, the amino acid-modified LDH contained within the coating mixture is a carbonate-containing LDH.

In an embodiment, the amino acid-modified LDH contained within the coating mixture is a Mg/Al LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a carbonate-containing LDH.

In an embodiment, the amino acid-modified LDH contained within the coating mixture is a nitrate-containing LDH.

In an embodiment, the amino acid-modified LDH contained within the coating mixture is a magnesium aluminium carbonate LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a magnesium aluminium nitrate LDH. Suitably, the molar ratio of Mg:Al is (1.9-2.5):1. More suitably, the molar ratio of Mg:Al is (2.0-2.25):1.

In an embodiment, the aspect ratio of the amino acid-modified layered double hydroxide is 10-500, wherein aspect ratio is the average diameter of the layered double hydroxide platelet divided by the average thickness of the layered double hydroxide platelet. Suitably, the aspect ratio of the amino acid-modified layered double hydroxide is greater than 85. More suitably, the aspect ratio of the amino acid-modified layered double hydroxide is 90-400. More suitably, the aspect ratio of the amino acid-modified layered double hydroxide is 100-300. Even more suitably, the aspect ratio of the amino acid-modified layered double hydroxide is >120 (e.g. 121-300). Yet even more suitably, the aspect ratio of the amino acid-modified layered double hydroxide is >150. Yet even more suitably, the aspect ratio of the amino acid-modified layered double hydroxide is >175. Yet even more suitably, the aspect ratio of the amino acid-modified layered double hydroxide is >200. Most suitably, the aspect ratio of the amino acid-modified layered double hydroxide is >225.

In an embodiment, the amino acid-modified layered double hydroxide is a layered double hydroxide comprising an amino acid. The process by which the amino acid-modified layered double hydroxide is made may therefore introduce a quantity of amino acid into the structure of the LDH. The presence of amino acid within the amino acid-modified LDH may be determined by experimental techniques such as FTIR spectroscopy. Suitably, the amino acid-modified layered double hydroxide is a layered double hydroxide comprising 0.1-50 wt % of an amino acid. More suitably, the amino acid-modified layered double hydroxide is a layered double hydroxide comprising 1-25 wt % of an amino acid. More suitably, the amino acid-modified layered double hydroxide is a layered double hydroxide comprising 1.5-15 wt % of an amino acid. More suitably, the amino acid-modified layered double hydroxide is a layered double hydroxide comprising 2-9 wt % of an amino acid. Alternatively, the amino acid-modified layered double hydroxide is a layered double hydroxide comprising 4-12 wt % of an amino acid. The amino acid-modified layered double hydroxide may also be a layered double hydroxide comprising a trace quantity of an amino acid.

In an embodiment, the amino acid is non-aromatic.

In an embodiment, the amino acid is selected from the group consisting of aspartic acid, glutamic acid, asparagine, serine, glycine, β-alanine, β-aminobutyric acid, γ-aminobutyric acid and β-leucine. The amino acid-modified layered double hydroxide may also be selected from glutamic acid, aspartic acid, asparagine and serine. Suitably, the amino acid is selected from the group consisting of glycine, β-alanine, β-aminobutyric acid and β-leucine. More suitably, the amino acid is selected from the group consisting of glycine, β-alanine and β-aminobutyric acid. Most suitably, the amino acid is β-aminobutyric acid or glycine.

In a particularly suitable embodiment, the amino acid is glycine.

In an embodiment, step a) comprises mixing at least the following:
i. a layered double oxide
ii. an amino acid
iii. the polymer,
iv. the solvent for the polymer, and optionally either or both of:
   a. a source of an inorganic oxyanion (e.g. a salt), and
   b. a polymer crosslinking agent (e.g. a crosslinking agent suitable for crosslinking PVOH, such as trisodium trimetaphosphate).
      Suitable inorganic oxyanions include carbonates, bicarbonates, hydrogenphosphates, dihydrogenphosphates, nitrites, borates, nitrates, phosphates and sulphates.

Coating mixtures prepared in accordance with the present invention allows for a greater degree of control over the composition of the coating mixture. Coating mixtures used in the prior art have been prepared by blending together polymerisable acrylic monomers, other polymers and inorganic materials (e.g. clays) in the presence of a solvent and then conducting radical polymerisation of the resulting blend under elevated temperature to yield the polymeric coating mixture. As a consequence, coating mixtures prepared by such in-situ polymerisation techniques are likely to contain a variety of polymeric products, each having different properties (e.g. molecular weight). This necessarily makes it different to prepare multiple batches of coating mixture to the exact same specification. In contrast to this approach, the coating mixtures of the present process can be prepared by mixing together predetermined quantities of i) an LDO, ii) an amino acid, iii) a polymer iii) a solvent for the polymer. The resulting polymeric solution therefore has pre-determined properties (e.g. viscosity). The present process also eliminates the risk of generating potentially unwanted (or harmful) side products by uncontrolled radical polymerisation of a complex blend of ingredients.

In a particularly suitable embodiment, step a) comprises the steps of:
a-i) providing a layered double oxide;
a-ii) providing a mixture of an amino acid and a solvent for the amino acid (e.g. water);
a-iii) providing a mixture of the polymer and the solvent for the polymer;
a-iv) contacting the layered double oxide with the mixture of step a-ii) to yield an amino acid-modified layered double hydroxide; and
a-v) contacting the amino acid-modified layered double hydroxide with the mixture of step a-iii) to yield the coating mixture.

As used herein, the term “layered double oxide” will be understood to denote a semi-amorphous mixed metal oxide obtainable by thermally treating (e.g. in air) a precursor layered double hydroxide at a temperature of 260-550° C. Due to the “memory effect”, LDOs obtainable by thermally treating a precursor layered double hydroxide at such a temperature will reform the layered double hydroxide structure upon addition of water and an anion. The precursor LDH will be understood as being that which is, once thermally treated at the specific temperature, yields a LDO. Suitably, the layered double oxide is obtainable by thermally treating a precursor layered double hydroxide at a temperature of 290-525° C. More suitably, the layered double oxide is obtainable by thermally treating a precursor layered double hydroxide at a temperature of 310-500° C. More suitably, the layered double oxide is obtainable by thermally treating a precursor layered double hydroxide at a temperature of 325-475° C. Most suitably, the layered double oxide is obtainable by thermally treating a precursor layered double hydroxide at a temperature of 400-475° C.

Yet a further advantage of the present process is that the use of an LDO-derived LDH considerably reduces the possibility of the coated substrate being contaminated with harmful organic products. For example, urea, which is commonly used in LDH manufacturing processes to improve the aspect ratio of LDH platelets, is known to be toxic, thus presenting considerations for manufacturers of food packaging. However, the present inventors have now surprisingly found that high aspect ratio LDH platelets can be prepared by reconstructing (e.g. rehydrating and anion intercalation) an LDH from the corresponding LDO, even when the precursor LDH was of a low aspect ratio prepared by a non-urea containing synthesis (e.g. simple coprecipitation). Even if the precursor LDH is prepared by a urea-containing synthesis, thermally treating the LDH (e.g. at 260-550° C.) to yield the corresponding LDO will mean that any residual urea present within the LDH is removed, meaning that the LDH that is subsequently reformed from the LDO (e.g. by reconstruction) is free from urea.

In an embodiment, the amino acid-modified layered double hydroxide present within the coating mixture is substantially free from toxic organic compounds (e.g. urea).

In an embodiment, the amino acid-modified layered double hydroxide present within the coating mixture is free from urea.

In an embodiment, the layered double oxide is obtainable by thermally treating a precursor layered double hydroxide for a period of 1-48 hours. Suitably, the layered double oxide is obtainable by thermally treating a precursor layered double hydroxide for a period of 4-24 hours. More suitably, the layered double oxide is obtainable by thermally treating a precursor layered double hydroxide for a period of 6-18 hours. The ramp rate used as part of the thermal treatment step may be 2.5-7.5° C./min.

In an embodiment, the layered double oxide is obtainable by thermally treating a precursor layered double hydroxide in air.

In an embodiment, during step a-iv), the amino acid is in an excess with respect to the layered double oxide. Suitably, the weight ratio of amino acid (e.g. glycine) to layered double hydroxide in step a-iv) is 1.1:1 to 2:1.

In an embodiment, step a-iv) is conducted at a temperature of 50-150° C. Suitably, step a-iv) is conducted at a temperature of 70-120° C. Step a-iv) may be conducted under hydrothermal conditions.

In an embodiment, step a-iv) is conducted for >1 minute. Suitably, step a-iv) is conducted for >2 minutes. More suitably, step a-iv) is conducted for >10 minutes. More suitably, step a-iv) is conducted for >1 hour. Even more suitably, step a-iv) is conducted for >2 hours. Yet more suitably, step a-iv) is conducted for >5 hours. Most suitably, step a-iv) is conducted for >10 hours.

In an embodiment, the solvent for the amino acid is water.

In an embodiment, the mixture of step a-ii) and/or step a-iii) further comprises either or both of
a) a source of an inorganic oxyanion (e.g. a salt), and
b) a polymer crosslinking agent (e.g. a crosslinking agent suitable for crosslinking PVOH, such as trisodium trimetaphosphate).

In an embodiment, prior to step a-v), a base (e.g. NaOH) is added to the mixture resulting from step a-iv) to precipitate the amino acid-modified LDH. Before adding into the mixture of step a-iii), the isolated amino acid-modified LDH is washed with water.

The precursor LDH used to form the LDO and/or the amino acid-modified LDH may have a structure according to formula (I) shown below:

[M^{z+}₁₋ₓM′^{y+}x(OH)₂]^{a+}(Xⁿ⁻)ₘ.bH₂O+c(solv) (I)
wherein
   M is a charged metal cation;
   M′ is a charged metal cation different from M;
   z is 1 or 2;
   y is 3 or 4;
   0<x<0.9;
   0<b≤10;
   0≤c≤10
   X is an anion;
   n is the charge on anion X;
   a is equal to z(1−x)+xy−2;
   m≥a/n; and
   solv denotes an organic solvent capable of hydrogen-bonding to water.

In an embodiment, when z is 2, M is Mg, Zn, Fe, Ca, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Fe, Ti, or a mixture thereof, or when y is 4, M′ is Ti. Suitably, y is 3. More suitably, y is 3 and M′ is Al.

In an embodiment, M is Al.

In an embodiment, 0<c≤10.

In an embodiment, X is at least one anion selected from the group consisting of a halide (e.g., chloride) and an inorganic oxyanion (e.g. X′ₘOₙ(OH)ₚ^{-q}, in which m=1-5; n=2-10; p=0-4, q=1-5; X′ ═B, C, N, S, P; such as carbonate, bicarbonate, hydrogenphosphate, dihydrogenphosphate, nitrite, borate, nitrate, phosphate, sulphate, hydroxide, silicate). Suitably, X is at least one anion selected from the group consisting of carbonate, bicarbonate, nitrate and nitrite. Most suitably, X is carbonate.

In an embodiment, x has a value according to the expression 0.18<x<0.9. Suitably, x has a value according to the expression 0.18<x<0.5. More suitably, x has a value according to the expression 0.18<x<0.4.

In an embodiment, the precursor LDH and/or the amino acid-modified LDH is a flower-like layered double hydroxide or a platelet-like layered double hydroxide. The term flower-like LDH will be understood by one of skill in the art to denote one which has been prepared according to a co-precipitation technique. The term platelet-like LDH will be understood by one of skill in the art to denote one which has been prepared according to a urea-hydrothermal technique.

In an embodiment, the precursor LDH and/or the amino acid-modified LDH is a Zn/Al, Mg/Al, Ca/Al or Zn, Mg/Al LDH. Suitably, the precursor LDH and/or the amino acid-modified LDH is a Mg/Al LDH.

### Coating Mixtures

According to a fifth aspect of the present invention, there is provided a coating mixture obtainable by a process according to the fourth aspect of the invention.

According to a sixth aspect of the present invention, there is provided a coating mixture comprising an amino acid-modified layered double hydroxide, a polymer and a solvent for the polymer.

The coating mixtures of the fifth and sixth aspects of the invention are useable in accordance with the first aspect of the invention. The numerous advantages discussed hereinbefore in connection with the first aspect of the invention are thereby equally applicable to the fifth and sixth aspects of the invention.

In an embodiment, the combined quantity of the amino acid-modified LDH and polymer in the coating mixture is 2.0-12.0% by weight relative to the total weight of the coating mixture.

Suitably, the combined quantity of the amino acid-modified LDH and polymer in the coating mixture is 2.5-10.0% by weight relative to the total weight of the coating mixture. Suitably, the combined quantity of the amino acid-modified LDH and polymer in the coating mixture is 2.5-7.5% by weight relative to the total weight of the coating mixture. Suitably, the combined quantity of the amino acid-modified LDH and polymer in the coating mixture is 3-7% by weight relative to the total weight of the coating mixture. More suitably, the combined quantity of the amino acid-modified LDH and polymer in the coating mixture is 3.5-6.5% by weight relative to the total weight of the coating mixture. Yet more suitably, the combined quantity of the amino acid-modified LDH and polymer in the coating mixture is 4-6% by weight relative to the total weight of the coating mixture.

In an embodiment, the combined quantity of the amino acid-modified LDH and polymer in the coating mixture is 2.0-20.0% by weight relative to the total weight of the coating mixture.

Suitably, the combined quantity of the amino acid-modified LDH and polymer in the coating mixture is 3.0-17.0% by weight relative to the total weight of the coating mixture. Suitably, the combined quantity of the amino acid-modified LDH and polymer in the coating mixture is 4.0-15.0% by weight relative to the total weight of the coating mixture. Suitably, the combined quantity of the amino acid-modified LDH and polymer in the coating mixture is 5.0-14.0% by weight relative to the total weight of the coating mixture. More suitably, the combined quantity of the amino acid-modified LDH and polymer in the coating mixture is 6.0-14.0% by weight relative to the total weight of the coating mixture. Yet more suitably, the combined quantity of the amino acid-modified LDH and polymer in the coating mixture is 8.0-12.0% by weight relative to the total weight of the coating mixture.

In an embodiment, the weight ratio of amino acid-modified LDH to polymer in the coating mixture ranges from 1:9 to 9:1. Suitably, the weight ratio of amino acid-modified LDH to polymer in the coating mixture ranges from 1:6 to 4:1. Suitably, the weight ratio of amino acid-modified LDH to polymer in the coating mixture ranges from 1:4 to 4:1. More suitably, the weight ratio of amino acid-modified LDH to polymer in the coating mixture ranges from 1:2 to 3:1.

In an embodiment, of the total solids (i.e. polymer and amino acid-modified LDH) present in the coating mixture, 10-90 wt % is the amino acid-modified LDH. Suitably, of the total solids present in the coating mixture, 20-87.5 wt % is the amino acid-modified LDH. More suitably, of the total solids present in the coating mixture, 30-85 wt % is the amino acid-modified LDH. Even more suitably, of the total solids present in the coating mixture, 40-82.5 wt % is the amino acid-modified LDH. Yet more suitably, of the total solids present in the coating mixture, 45-80 wt % is the amino acid-modified LDH. Yet even more suitably, of the total solids present in the coating mixture, 50-75 wt % is the amino acid-modified LDH. Yet even more suitably, of the total solids present in the coating mixture, 52.5-72.5 wt % is the amino acid-modified LDH. Most suitably, of the total solids present in the coating mixture, 55-65 wt % is the amino acid-modified LDH.

In an embodiment, the polymer is a water-soluble polymer. Suitably, the water-soluble polymer is one or more polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA). More suitably, the water-soluble polymer is poly(vinyl alcohol) (PVOH). Alternatively, the polymer is a water-based polymer. The term water-based polymer will be familiar to one of ordinary skill in the art, and is used to denote a polymer that may not be water-soluble, but which has been functionalised to render it readily dispersible in water.

In a particularly suitable embodiment, the polymer is crosslinked PVOH.

In an embodiment, the polymer is poly(vinyl alcohol) (PVOH) having a molecular weight (M_{w}) of 20,000 to 220,000 Da. Suitably, the polymer is poly(vinyl alcohol) (PVOH) having a molecular weight (M_{w}) of 20,000 to 150,000 Da. Suitably, the polymer is poly(vinyl alcohol) (PVOH) having a molecular weight (M_{w}) of 20,000 to 70,000 Da. Suitably, the polymer is poly(vinyl alcohol) (PVOH) having a molecular weight (M_{w}) of 20,000 to 60,000 Da. More suitably, the polymer is poly(vinyl alcohol) (PVOH) having a molecular weight (M_{w}) of 27,000 to 40,000 Da.

In an embodiment, the polymer is poly(vinyl alcohol) (PVOH) having a molecular weight (M_{w}) of 40,000 to 220,000 Da. Suitably, the polymer is poly(vinyl alcohol) (PVOH) having a molecular weight (M_{w}) of 170,000 to 210,000 Da.

In an embodiment, the polymer is poly(vinyl alcohol) (PVOH) having a degree of hydrolysis of 70 to 100 mol %. Suitably, the polymer is poly(vinyl alcohol) (PVOH) having a degree of hydrolysis of 80 to 99 mol %. Suitably, the polymer is poly(vinyl alcohol) (PVOH) having a degree of hydrolysis of 80 to 95 mol %. Suitably, the polymer is poly(vinyl alcohol) (PVOH) having a degree of hydrolysis of 83 to 92 mol %. More suitably, the polymer is poly(vinyl alcohol) (PVOH) having a degree of hydrolysis of 85 to 90 mol %.

In an embodiment, the polymer is poly(vinyl alcohol) (PVOH) having a molecular weight (M_{w}) of 20,000 to 70,000 Da and a degree of hydrolysis of 83 to 92 mol %. Suitably, the polymer is poly(vinyl alcohol) (PVOH) having a molecular weight (M_{w}) of 27,000 to 40,000 Da and a degree of hydrolysis of 85 to 90 mol %.

In an embodiment, the polymer is poly(vinyl alcohol) (PVOH) having a molecular weight (M_{w}) of 40,000 to 220,000 Da and a degree of hydrolysis of 80 to 99 mol %.

In an embodiment, the solvent for the polymer is water. Additional solvents may or may not be present. Suitably, >95 vol. % of the solvent is water.

In an embodiment, the coating mixture has a viscosity at 25° C. of 1 to 1000 cP.

In an embodiment, the amino acid-modified LDH contained within the coating mixture is a Zn/Al, Mg/Al, Ca/Al or Zn, Mg/Al LDH. Suitably, the amino acid-modified LDH contained within the coating mixture is a carbonate-containing LDH.

In an embodiment, the amino acid-modified LDH contained within the coating mixture is a Mg/Al LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a carbonate-containing LDH.

In an embodiment, the amino acid-modified LDH contained within the coating mixture is a nitrate-containing LDH.

In an embodiment, the amino acid-modified LDH contained within the coating mixture is a magnesium aluminium carbonate LDH. Suitably, the molar ratio of Mg:Al is (1.9-2.5):1. More suitably, the molar ratio of Mg:Al is (2.0-2.25):1.

In an embodiment, the amino acid-modified LDH contained within the coating mixture is a magnesium aluminium nitrate LDH. Suitably, the molar ratio of Mg:Al is (1.9-2.5):1. More suitably, the molar ratio of Mg:Al is (2.0-2.25):1.

In an embodiment, the aspect ratio of the amino acid-modified layered double hydroxide is 10-500, wherein aspect ratio is the average diameter of the layered double hydroxide platelet divided by the average thickness of the layered double hydroxide platelet. Suitably, the aspect ratio of the amino acid-modified layered double hydroxide is greater than 85. More suitably, the aspect ratio of the amino acid-modified layered double hydroxide is 90-400. More suitably, the aspect ratio of the amino acid-modified layered double hydroxide is 100-300. Even more suitably, the aspect ratio of the amino acid-modified layered double hydroxide is >120 (e.g. 121-300). Yet even more suitably, the aspect ratio of the amino acid-modified layered double hydroxide is >150. Yet even more suitably, the aspect ratio of the amino acid-modified layered double hydroxide is >175. Yet even more suitably, the aspect ratio of the amino acid-modified layered double hydroxide is >200. Most suitably, the aspect ratio of the amino acid-modified layered double hydroxide is >225.

In an embodiment, the amino acid-modified layered double hydroxide is a layered double hydroxide comprising an amino acid. The process by which the amino acid-modified layered double hydroxide is made may therefore introduce a quantity of amino acid into the structure of the LDH. The presence of amino acid within the amino acid-modified LDH may be determined by experimental techniques such as FTIR spectroscopy. Suitably, the amino acid-modified layered double hydroxide is a layered double hydroxide comprising 0.1-50 wt % of an amino acid. More suitably, the amino acid-modified layered double hydroxide is a layered double hydroxide comprising 1-25 wt % of an amino acid. More suitably, the amino acid-modified layered double hydroxide is a layered double hydroxide comprising 1.5-15 wt % of an amino acid. More suitably, the amino acid-modified layered double hydroxide is a layered double hydroxide comprising 2-9 wt % of an amino acid. Alternatively, the amino acid-modified layered double hydroxide is a layered double hydroxide comprising 4-12 wt % of an amino acid. The amino acid-modified layered double hydroxide may also be a layered double hydroxide comprising a trace quantity of an amino acid.

In an embodiment, the amino acid is non-aromatic.

In an embodiment, the amino acid is selected from the group consisting of aspartic acid, glutamic acid, asparagine, serine, glycine, β-alanine, β-aminobutyric acid, γ-aminobutyric acid and β-leucine. The amino acid-modified layered double hydroxide may also be selected from glutamic acid, aspartic acid, asparagine and serine. Suitably, the amino acid is selected from the group consisting of glycine, β-alanine, β-aminobutyric acid and β-leucine. More suitably, the amino acid is selected from the group consisting of glycine, β-alanine and β-aminobutyric acid.

Most suitably, the amino acid is β-aminobutyric acid or glycine.

In a particularly suitable embodiment, the amino acid is glycine.

In an embodiment, the amino acid-modified layered double hydroxide present within the coating mixture is substantially free from toxic organic compounds (e.g. urea).

In an embodiment, the amino acid-modified layered double hydroxide present within the coating mixture is free from urea.

The amino acid-modified LDH may have a structure according to formula (I) shown below:

[M^{z+}₁₋ₓM′^{y+}ₓ(OH)₂]^{a+}(Xⁿ⁻)ₘ.bH₂O.c(solv) (I)
wherein
   M is a charged metal cation;
   M′ is a charged metal cation different from M;
   z is 1 or 2;
   y is 3 or 4;
   0<x<0.9;
   0<b≤10;
   0≤c≤10
   X is an anion;
   n is the charge on anion X;
   a is equal to z(1−x)+xy−2;
   m≥a/n; and
   solv denotes an organic solvent capable of hydrogen-bonding to water.

In an embodiment, when z is 2, M is Mg, Zn, Fe, Ca, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Fe, Ti, or a mixture thereof, or when y is 4, M′ is Ti. Suitably, y is 3. More suitably, y is 3 and M′ is Al.

In an embodiment, M′ is Al.

In an embodiment, 0<c≤10.

In an embodiment, X is at least one anion selected from the group consisting of a halide (e.g., chloride) and an inorganic oxyanion (e.g. X′ₘOₙ(OH)ₚ^{-q}, in which m=1-5; n=2-10; p=0-4, q=1-5; X′ ═B, C, N, S, P; such as carbonate, bicarbonate, hydrogenphosphate, dihydrogenphosphate, nitrite, borate, nitrate, phosphate, sulphate, hydroxide, silicate). Suitably, X is at least one anion selected from the group consisting of carbonate, bicarbonate, nitrate and nitrite. Most suitably, X is carbonate.

In an embodiment, x has a value according to the expression 0.18<x<0.9. Suitably, x has a value according to the expression 0.18<x<0.5. More suitably, x has a value according to the expression 0.18<x<0.4.

In an embodiment, the amino acid-modified LDH is a flower-like layered double hydroxide or a platelet-like layered double hydroxide. The term flower-like LDH will be understood by one of skill in the art to denote one which has been prepared according to a co-precipitation technique. The term platelet-like LDH will be understood by one of skill in the art to denote one which has been prepared according to a urea-hydrothermal technique.

In an embodiment, the the amino acid-modified LDH is a Zn/Al, Mg/Al, Ca/Al or Zn, Mg/A LDH. Suitably, the precursor LDH and/or the amino acid-modified LDH is a Mg/Al LDH.

### Applications

According to a seventh aspect of the present invention there is provided a use of a coating mixture according to the fifth or sixth aspect in the formation of a coating on a substrate.

The substrate may have any of the definitions discussed hereinbefore in respect of any other aspect of the invention.

According to an eighth aspect of the present invention there is provided a use of a coated substrate according to the second or third aspect in packaging.

According to a ninth aspect of the present invention there is provided packaging comprising a coated substrate according to the second or third aspect.

The advantageous OTR and/or WVTR properties of the coated substrates of the invention render them useful in the field of packaging, particularly in the food industry. Accordingly, the coated substrates of the invention may be used in packaging or in a container that is intended to package or contain a foodstuff.

Suitably, the coated substrates have acceptable optical properties (e.g. transparency, clarity and/or haze).

The following numbered statements 1 to 154 are not claims, but instead serve to define particular aspects and embodiments of the invention:
1. A process for the preparation of a coated first substrate, the process comprising the steps of:
   a) providing a coating mixture comprising:
      i. an amino acid-modified layered double hydroxide,
      ii. a polymer, and
      iii. a solvent for the polymer;
   b) applying a layer of the coating mixture to a first substrate to provide a coated first substrate; and
   c) drying the coated first substrate.
2. The process of statement 1, wherein the total solids content of the coating mixture is 2.0-20.0% by weight relative to the total weight of the coating mixture.
3. The process of statement 1, wherein the total solids content of the coating mixture is 5.0-14.0% by weight relative to the total weight of the coating mixture.
4. The process of statement 1, wherein the total solids content of the coating mixture is 8.0-12.0% by weight relative to the total weight of the coating mixture.
5. The process of statement 1, wherein the total solids content of the coating mixture is 2.5-7.5% by weight relative to the total weight of the coating mixture.
6. The process of statement 1, wherein the total solids content of the coating mixture is 3-7% by weight relative to the total weight of the coating mixture.
7. The process of statement 1, wherein the total solids content of the coating mixture is 4-6% by weight relative to the total weight of the coating mixture.
8. The process of any preceding statement, wherein the weight ratio of amino acid-modified layered double hydroxide to polymer in the coating mixture ranges from 1:4 to 4:1.
9. The process of any preceding statement, wherein the weight ratio of amino acid-modified layered double hydroxide to polymer in the coating mixture ranges from 1:2 to 3:1.
10. The process of any one of statement 1 to 7, wherein of the total solids present in the coating mixture, 10-90 wt % is the amino acid-modified LDH.
11. The process of any one of statement 1 to 7, wherein of the total solids present in the coating mixture, 30-85 wt % is the amino acid-modified LDH.
12. The process of any one of statement 1 to 7, wherein of the total solids present in the coating mixture, 50-75 wt % is the amino acid-modified LDH.
13. The process of any one of statement 1 to 7, wherein of the total solids present in the coating mixture, 55-65 wt % is the amino acid-modified LDH.
14. The process of any preceding statement, wherein the total solids content of the coating mixture is 5.0-14.0% by weight relative to the total weight of the coating mixture and of the total solids present in the coating mixture, 50-75 wt % is the amino acid-modified LDH.
15. The process of any preceding statement, wherein the polymer is a water-soluble polymer.
16. The process of any preceding statement, wherein the polymer is one or more water-soluble polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA), or one or more water-based polymers selected from the group consisting of water-based polyurethane and water-based polyacrylate.
17. The process of any preceding statement, wherein the polymer is poly(vinyl alcohol) (PVOH).
18. The process of any preceding statement, wherein the polymer is crosslinked PVOH.
19. The process of any preceding statement, wherein the coating mixture is aqueous and the solvent for the polymer is water.
20. The process of any preceding statement, wherein the polymer is PVOH or crosslinked PVOH and the solvent is >95 wt % water.
21. The process of any preceding statement, wherein the coating mixture has a viscosity at 25° C. of 1 to 1000 cP.
22. The process of any preceding statement, wherein the first substrate is selected from the group consisting of polyethylene terephthalate (PET), polyethylene (PE), biaxially oriented polypropylene film (BOPP), polypropylene (PP), and polyvinyl dichloride (PVDC).
23. The process of any preceding statement, wherein the first substrate is sheet-like, having a thickness of 1-30 μm.
24. The process of any preceding statement, wherein the first substrate is sheet-like, having a thickness of 5-20 μm.
25. The process of any preceding statement, wherein the first substrate is polyethylene terephthalate (PET).
26. The process of any preceding statement, wherein the aspect ratio of the amino acid-modified layered double hydroxide is 10-500, wherein aspect ratio is the average diameter of the layered double hydroxide platelet divided by the average thickness of the layered double hydroxide platelet.
27. The process of any preceding statement, wherein the aspect ratio of the amino acid-modified layered double hydroxide is greater than 85.
28. The process of any preceding statement, wherein the aspect ratio of the amino acid-modified layered double hydroxide is >120.
29. The process of any preceding statement, wherein the aspect ratio of the amino acid-modified layered double hydroxide is >150.
30. The process of any preceding statement, wherein the aspect ratio of the amino acid-modified layered double hydroxide is >175.
31. The process of any preceding statement, wherein the aspect ratio of the amino acid-modified layered double hydroxide is >200.
32. The process of any preceding statement, wherein the amino acid-modified layered double hydroxide is a layered double hydroxide comprising an amino acid.
33. The process of any preceding statement, wherein the amino acid-modified layered double hydroxide is a layered double hydroxide comprising 1-25 wt % of an amino acid.
34. The process of any preceding statement, wherein the amino acid-modified layered double hydroxide is a layered double hydroxide comprising 4-12 wt % of an amino acid.
35. The process of any preceding statement, wherein step a) comprises the steps of:
   a-i) providing a layered double oxide;
   a-ii) providing a mixture of an amino acid and a solvent for the amino acid (e.g. water);
   a-iii) providing a mixture of the polymer and the solvent for the polymer;
   a-iv) contacting the layered double oxide with the mixture of step a-ii) to yield an amino acid-modified layered double hydroxide; and
   a-v) contacting the amino acid-modified layered double hydroxide with the mixture of step a-iii) to yield the coating mixture.
36. The process of statement 35, wherein during step a-iv), the amino acid is in an excess with respect to the layered double oxide.
37. The process of statement 35, wherein the weight ratio of amino acid (e.g. glycine) to layered double hydroxide in step a-iv) is 1.1:1 to 2:1.
38. The process of any one of statements 35, 36 or 37, wherein step a-iv) is conducted at a temperature of 50-150° C., and/or step a-iv) is conducted for >1 minute, preferably >10 minutes, more preferably >1 hour.
39. The process of any one of statements 35 to 38, wherein step a-iv) is conducted at a temperature of 70-120° C., optionally under hydrothermal conditions, and/or step a-iv) is conducted for >5 hours, preferably >10 hours.
40. The process of any one of statements 35 to 39, wherein the solvent for the amino acid is water.
41. The process of any one of statements 35 to 40, wherein the mixture of step a-ii) and/or step a-iii) further comprises either or both of
   a) a source of an inorganic oxyanion (e.g. a salt), and
   b) a polymer crosslinking agent (e.g. a crosslinking agent suitable for crosslinking PVOH, such as trisodium trimetaphosphate).
42. The process of any one of statements 35 to 41, wherein the layered double oxide is obtainable by thermally treating a precursor layered double hydroxide at a temperature of 260-550° C.
43. The process of any one of statements 35 to 42, wherein the layered double oxide is obtainable by thermally treating a precursor layered double hydroxide at a temperature of 325-475° C.
44. The process of any one of statements 35 to 43, wherein the layered double oxide is obtainable by thermally treating a precursor layered double hydroxide at a temperature of 400-475° C.
45. The process of statements 35 to 44, wherein the layered double oxide is obtainable by thermally treating a precursor layered double hydroxide for a period of 1-48 hours.
46. The process of any one of statements 35 to 45, wherein the layered double oxide is obtainable by thermally treating a precursor layered double hydroxide for a period of 6-18 hours.
47. The process of any one of statements 35 to 46, wherein the layered double oxide is obtainable by thermally treating a precursor layered double hydroxide in air.
48. The process of any one of statements 35 to 47, wherein prior to step a-v), a base (e.g. NaOH) is added to the mixture resulting from step a-iv) to precipitate the amino acid-modified LDH.
49. The process of any one of statements 42 to 48, wherein the precursor layered double hydroxide has a structure according to formula (I) shown below:

[M^{z+}₁₋ₓM′^{y+}ₓ(OH)₂]^{a+}(Xⁿ⁻)ₘ.bH₂O.c(solv) (I)
wherein
   M is a charged metal cation;
   M′ is a charged metal cation different from M;
   z is 1 or 2;
   y is 3 or 4;
   0<x<0.9;
   0<b≤10;
   0≤c≤10
   X is an anion;
   n is the charge on anion X;
   a is equal to z(1−x)+xy−2;
   m≥a/n; and
   solv denotes an organic solvent capable of hydrogen-bonding to water.
50. The process of statement 49, wherein when z is 2, M is Mg, Zn, Fe, Ca, or a mixture of two or more of these, or when z is 1, M is Li.
51. The process of statement 49 or 50, wherein when y is 3, M′ is Al, Fe, Ti, or a mixture thereof, or when y is 4, M′ is Ti.
52. The process of any one of statement 49, 50 and 51, wherein M′ is Al.
53. The process of any one of statements 49 to 52, wherein X is at least one anion selected from the group consisting of a halide (e.g., chloride) and an inorganic oxyanion (e.g. X′ₘO(OH)ₚ^{-q}, in which m=1-5; n=2-10; p=0-4, q=1-5; X′═B, C, N, S, P; such as carbonate, bicarbonate, hydrogenphosphate, dihydrogenphosphate, nitrite, borate, nitrate, phosphate, sulphate, hydroxide, silicate).
54. The process of any one of statements 49 to 53, wherein X is at least one anion selected from the group consisting of carbonate, bicarbonate, nitrate and nitrite.
55. The process of any one of statements 49 to 54, wherein X is carbonate.
56. The process of any one of statements 42 to 55, wherein the precursor layered double hydroxide is a flower-like layered double hydroxide or a platelet-like layered double hydroxide.
57. The process of any preceding statement, wherein the amino acid-modified layered double hydroxide has a structure according to formula (I) as defined in any one of statements 49 to 55.
58. The process of any preceding statement, wherein either or both of the precursor layered double hydroxide and the amino acid-modified layered double hydroxide contained within the coating mixture is a Zn/Al, Mg/Al, ZnMg/Al or Ca/Al layered double hydroxide.
59. The process of any preceding statement, wherein either or both of the precursor layered double hydroxide and the amino acid-modified layered double hydroxide contained within the coating mixture is a Mg/Al LDH.
60. The process of any preceding statement, wherein either or both of the precursor layered double hydroxide and the amino acid-modified layered double hydroxide contained within the coating mixture is a Mg/Al LDH in which the molar ratio of Mg:Al is (1.9-2.5):1.
61. The process of any preceding statement, wherein either or both of the precursor layered double hydroxide and the amino acid-modified layered double hydroxide contained within the coating mixture is a carbonate-containing layered double hydroxide.
62. The process of any preceding statement, wherein either or both of the precursor layered double hydroxide and the amino acid-modified layered double hydroxide contained within the coating mixture is a magnesium aluminium carbonate LDH.
63. The process of any preceding statement, wherein either or both of the precursor layered double hydroxide and the amino acid-modified layered double hydroxide contained within the coating mixture is a magnesium aluminium carbonate LDH in which the molar ratio of Mg:Al is (1.9-2.5):1.
64. The process of any preceding statement, wherein the amino acid is non-aromatic.
65. The process of any preceding statement, wherein the amino acid is selected from the group consisting of aspartic acid, glutamic acid, asparagine, serine, glycine, s-alanine, β-aminobutyric acid and β-leucine.
66. The process of any preceding statement, wherein the amino acid is selected from the group consisting of glycine, β-alanine and β-aminobutyric acid.
67. The process of any preceding statement, wherein the amino acid is β-aminobutyric acid or glycine.
68. The process of any preceding statement, wherein the amino acid is glycine.
69. The process of any preceding statement, wherein the coating mixture is applied to the substrate in step b) at a thickness of 0.5 μm-100 μm.
70. The process of any preceding statement, wherein the coating mixture is applied to the substrate in step b) at a thickness of 1 μm-60 μm.
71. The process of any preceding statement, wherein the process further comprises the steps of
   applying a further layer of coating mixture to the dried coating layer resulting from step c), and
   drying the further layer of coating mixture.
72. The process of any preceding statement, wherein after step b) and prior to step c), the coated first substrate is contacted with a second substrate, such that the layer of coating mixture is provided between the first and second substrates.
73. The process of any preceding statement, further comprising the steps of:
   d) of applying a layer of adhesive to the dried coated first substrate resulting from step c), such that the layer of adhesive is provided on top of the layer applied during step b); and
   e) contacting the layer of adhesive applied in step d) with a second substrate.
74. The process of statement 72 or 73, wherein the second substrate is selected from polyethylene terephthalate (PET), polyethylene (PE), polypropylene (PP), and polyvinyl dichloride (PVDC).
75. The process of statement 73 or 74, wherein the adhesive is selected from poly(vinyl alcohol) (PVOH) and poly(lactic acid) (PLA).
76. The process of any one of statements 35 to 75, wherein step a-i) comprises thermally treating a precursor layered double hydroxide at a temperature of 325-475° C.;
   during step a-iv), the amino acid (e.g. glycine) is in an excess with respect to the layered double oxide; and
   step a-iv) is conducted at a temperature of 50-150° C.
77. The process of any one of statements 35 to 76, wherein step a-i) comprises thermally treating a precursor layered double hydroxide at a temperature of 325-475° C.;
   the weight ratio of amino acid (e.g. glycine) to layered double hydroxide in step a-iv) is 1.1:1 to 2:1;
   step a-iv) is conducted at a temperature of 70-120° C., optionally under hydrothermal conditions; and
   prior to step a-v), a base (e.g. NaOH) is added to the mixture resulting from step a-iv) to precipitate the amino acid-modified LDH.
78. The process of any one of statements 42 to 77, wherein
   either or both of the precursor layered double hydroxide and the amino acid-modified layered double hydroxide contained within the coating mixture is a magnesium aluminium carbonate LDH in which the molar ratio of Mg:Al is (1.9-2.5):1;
   the amino acid-modified layered double hydroxide is a layered double hydroxide comprising 1-25 wt % of an amino acid; and
   the aspect ratio of the amino acid-modified layered double hydroxide is >120.
79. The process of any one of statements 42 to 78, wherein
   either or both of the precursor layered double hydroxide and the amino acid-modified layered double hydroxide contained within the coating mixture is a magnesium aluminium carbonate LDH in which the molar ratio of Mg:Al is (1.9-2.5):1;
   the amino acid-modified layered double hydroxide is a layered double hydroxide comprising 1-25 wt % of glycine; and
   the aspect ratio of the amino acid-modified layered double hydroxide is >175.
80. A coated substrate obtainable by the process of any preceding statement.
81. A coated substrate comprising:
   a) a first substrate; and
   b) a coating layer provided on at least one surface of the first substrate, wherein the coating layer comprises 20-90 wt % of an amino acid-modified layered double hydroxide dispersed throughout a polymeric matrix.
82. The coated substrate of statement 81, wherein the amino acid-modified layered double hydroxide is randomly dispersed throughout the polymeric matrix.
83. The coated substrate of statement 81 or 82, wherein the coated substrate is free from urea.
84. The coated substrate of any one of statements 81, 82 and 83, wherein the coating layer comprises 30-85 wt % of amino acid-modified layered double hydroxide.
85. The coated substrate of any one of statements 81, 82 and 83, wherein the coating layer comprises 35-75 wt % of amino acid-modified layered double hydroxide.
86. The coated substrate of any one of statements 81, 82 and 83, wherein the coating layer comprises 50-75 wt % of amino acid-modified layered double hydroxide.
87. The coated substrate of any one of statements 81 to 86, wherein the amino acid-modified layered double hydroxide is as defined in any preceding statement.
88. The coated substrate of any one of statements 81 to 87, wherein the amino acid is as defined in any preceding statement.
89. The coated substrate of any one of statements 81 to 88, wherein the polymeric matrix comprises a polymer as defined in any preceding statement.
90. The coated substrate of any one of statements 81 to 89, wherein the first substrate is as defined in any preceding statement.
91. The coated substrate of any one of statements 81 to 90, wherein the coating layer comprises:
   a) 20-90 wt % of amino acid-modified layered double hydroxide;
   b) 10-80 wt % of polymeric matrix; and
   c) 0-2 wt % of solvent (e.g. water).
92. The coated substrate of any one of statements 81 to 91, wherein the coating layer has a thickness of 20 nm-5.0 μm
93. The coated substrate of any one of statements 81 to 92, wherein the coating layer has a thickness of 100 nm-1.8 μm
94. The coated substrate of any one of statements 81 to 91, wherein the coating layer has a thickness of 0.1-10 μm (e.g. 1-10 μm).
95. The coated substrate of any one of statements 81 to 94, wherein the coating layer is a first coating layer, and the coated substrate further comprises a second coating layer disposed on top of the first coating layer, the second coating layer comprising 20-90 wt % of an amino acid-modified layered double hydroxide dispersed throughout a polymeric matrix.
96. The coated substrate of any one of statements 81 to 95, wherein the coated substrate comprises a second substrate disposed on top of the coating layer, such that the coating layer is located between the first and second substrates.
97. The coated substrate of statements 96, wherein the coated substrate comprises a layer of adhesive provided between the coating layer and the second substrate.
98. The coated substrate of statements 97, wherein the adhesive is as defined in statement 75.
99. The coated substrate of any one of statements 81 to 98, wherein
   the coating layer comprises 30-85 wt % of amino acid-modified layered double hydroxide;
   the aspect ratio of the amino acid-modified layered double hydroxide is >120;
   the polymer is PVOH; and
   the first substrate is PET.
100. The coated substrate of any one of statements 81 to 99, wherein
   the coating layer comprises 50-75 wt % of amino acid-modified layered double hydroxide;
   the aspect ratio of the amino acid-modified layered double hydroxide is >150; the polymer is PVOH;
   the coating layer has a thickness of 50 nm-2.5 μm; and
   the first substrate is PET.
101. The coated substrate of any one of statements 81 to 100, wherein
   the coating layer comprises 50-75 wt % of glycine-modified layered double hydroxide;
   the aspect ratio of the glycine-modified layered double hydroxide is >175;
   the polymer is PVOH or crosslinked PVOH;
   the coating layer has a thickness of 50 nm-2.5 μm; and
   the first substrate is PET having a thickness of 5-20 μm.
102. The coated substrate of any one of statements 81 to 101, wherein the coated substrate has an OTR of <7.0 cc/m²/day/atm.
103. The coated substrate of any one of statements 81 to 102, wherein the coated substrate has an OTR of <1.5 cc/m²/day/atm.
104. The coated substrate of any one of statements 81 to 103, wherein the coated substrate has an OTR of <0.1 cc/m²/day/atm.
105. The coated substrate of any one of statements 81 to 104, wherein the coated substrate has a WVTR of <7.0 g/m²/day.
106. The coated substrate of any one of statements 81 to 105, wherein the coated substrate has a WVTR of <2.5 g/m²/day.
107. The coated substrate of any one of statements 81 to 106, wherein the coated substrate has a WVTR of <1.25 g/m²/day.
108. Use of a coated substrate as defined in any one of statements 81 to 107 in packaging.
109. The use of statement 108, wherein the packaging is food packaging.
110. Packaging comprising a coated substrate as defined in any one of statements 81 to 107.
111. The packaging of statement 110, wherein the packaging is food packaging.
112. A process for the preparation of a coating mixture suitable for use in a coating application, the coating mixture comprising an amino acid-modified layered double hydroxide, a polymer and a solvent for the polymer, the process comprising the step of:
   a) mixing at least the following:
      i. an amino acid-modified layered double hydroxide,
      ii. a polymer, and
      iii. a solvent for the polymer.
113. The process of statement 112, wherein step a) comprises the steps of:
   a-i) providing a layered double oxide;
   a-ii) providing a mixture of an amino acid and a solvent for the amino acid (e.g. water);
   a-iii) providing a mixture of the polymer and the solvent for the polymer;
   a-iv) contacting the layered double oxide with the mixture of step a-ii) to yield an amino acid-modified layered double hydroxide; and
   a-v) contacting the amino acid-modified layered double hydroxide with the mixture of step a-iii) to yield the coating mixture.
114. The process of statement 113, wherein during step a-iv), the amino acid is in an excess with respect to the layered double oxide.
115. The process of statement 113, wherein the weight ratio of amino acid (e.g. glycine) to layered double hydroxide in step a-iv) is 1.1:1 to 2:1. 116. The process of any one of statements 113 to 115, wherein step a-iv) is conducted at a temperature of 50-150° C.
117. The process of any one of statements 113 to 116, wherein step a-iv) is conducted at a temperature of 70-120° C., optionally under hydrothermal conditions.
118. The process of any one of statements 113 to 117, wherein the solvent for the amino acid is water.
119. The process of any one of statements 113 to 118, wherein the mixture of step a-ii) and/or step a-iii) further comprises either or both of
   a) a source of an inorganic oxyanion (e.g. a salt), and
   b) a polymer crosslinking agent (e.g. a crosslinking agent suitable for crosslinking PVOH, such as trisodium trimetaphosphate).
120. The process of any one of statements 113 to 119, wherein the layered double oxide is obtainable by thermally treating a precursor layered double hydroxide at a temperature of 260-550° C.
121. The process of any one of statements 113 to 120, wherein the layered double oxide is obtainable by thermally treating a precursor layered double hydroxide at a temperature of 325-475° C.
122. The process of any one of statements 113 to 121, wherein the layered double oxide is obtainable by thermally treating a precursor layered double hydroxide at a temperature of 400-475° C.
123. The process of statement 120, 121 or 122, wherein the layered double oxide is obtainable by thermally treating a precursor layered double hydroxide for a period of 1-48 hours.
124. The process of statement 120, 121 or 122, wherein the layered double oxide is obtainable by thermally treating a precursor layered double hydroxide for a period of 6-18 hours.
125. The process of any one of statements 113 to 124, wherein the layered double oxide is obtainable by thermally treating a precursor layered double hydroxide in air.
126. The process of any one of statements 113 to 125, wherein prior to step a-v), a base (e.g. NaOH) is added to the mixture resulting from step a-iv) to precipitate the amino acid-modified LDH.
127. The process of any one of statements 112 to 126, wherein coating mixture is as defined in any one or more of statements 2 to 14.
128. The process of any one of statements 112 to 127, wherein the polymer is as defined in any one or more of statements 15 to 18.
129. The process of any one of statements 112 to 128, wherein the coating mixture is aqueous and the solvent is water.
130. The process of any one of statements 112 to 129, wherein the polymer is PVOH or crosslinked PVOH and the solvent is >95 wt % water.
131. The process of any one of statements 112 to 130, wherein the coating mixture has a viscosity at 25° C. of 1 to 1000 cP.
132. The process of any one of statements 112 to 131, wherein the aspect ratio of the amino acid-modified layered double hydroxide is 10-500, wherein aspect ratio is the average diameter of the layered double hydroxide platelet divided by the average thickness of the layered double hydroxide platelet.
133. The process of any one of statements 112 to 132, wherein the aspect ratio of the amino acid-modified layered double hydroxide is greater than 85.
134. The process of any one of statements 112 to 133, wherein the aspect ratio of the amino acid-modified layered double hydroxide is >120.
135. The process of any one of statements 112 to 134, wherein the aspect ratio of the amino acid-modified layered double hydroxide is >150.
136. The process of any one of statements 112 to 135, wherein the aspect ratio of the amino acid-modified layered double hydroxide is >175.
137. The process of any one of statements 112 to 136, wherein the aspect ratio of the amino acid-modified layered double hydroxide is >200.
138. The process of any one of statements 112 to 137, wherein either or both of the precursor layered double hydroxide and the amino acid-modified layered double hydroxide is as defined in any preceding statement.
139. A coating mixture obtainable by the process of any one of statements 112 to 138.
140. A coating mixture comprising an amino acid-modified layered double hydroxide, a polymer and a solvent for the polymer.
141. The coating mixture of statement 140, wherein the coating mixture is as defined in any one or more of statements 2 to 14.
142. The coating mixture of statement 140 or 141, wherein the polymer is as defined in any one or more of statements 15 to 18.
143. The coating mixture of any one of statements 140, 141 or 142, wherein the amino acid-modified layered double hydroxide is as defined in any preceding claim.
144. The coating mixture of statement 140 to 143, wherein the coating mixture is aqueous and the solvent is water.
145. The coating mixture of any one of statements 140 to 144, wherein the polymer is PVOH or crosslinked PVOH and the solvent is >95 wt % water.
146. The coating mixture of any one of statements 140 to 145, wherein the coating mixture has a viscosity at 25° C. of 1 to 1000 cP.
147. The coating mixture of any one of statements 140 to 146, wherein the aspect ratio of the amino acid-modified layered double hydroxide is 10-500, wherein aspect ratio is the average diameter of the layered double hydroxide platelet divided by the average thickness of the layered double hydroxide platelet.
148. The coating mixture of any one of statements 140 to 147, wherein the aspect ratio of the amino acid-modified layered double hydroxide is greater than 85.
149. The coating mixture of any one of statements 140 to 148, wherein the aspect ratio of the amino acid-modified layered double hydroxide is >120.
150. The coating mixture of any one of statements 140 to 149, wherein the aspect ratio of the amino acid-modified layered double hydroxide is >150.
151. The coating mixture of any one of statements 140 to 150, wherein the aspect ratio of the amino acid-modified layered double hydroxide is >175.
152. The coating mixture of any one of statements 140 to 151, wherein the aspect ratio of the amino acid-modified layered double hydroxide is >200.
153. Use of a coating mixture as defined in any one of statement 140 to 152 in the formation of a coating on a substrate.
154. The use of statement 153, wherein the substrate is intended for use in packaging (e.g. food packaging).

### EXAMPLES

One or more examples of the invention will now be described, for the purpose of illustration only, with reference to the accompanying figures, in which:

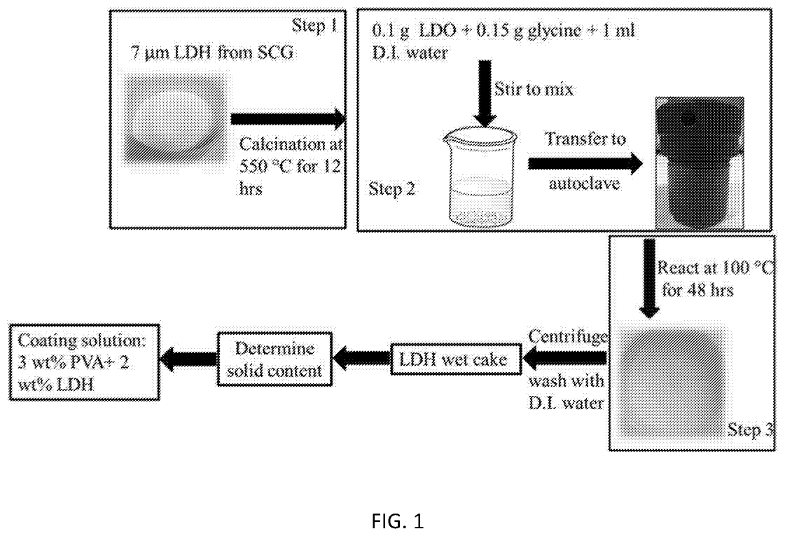

FIG. 1 shows a flow diagram illustrating the various steps involved in the formation of the coating mixtures of the invention according to Procedure 2.

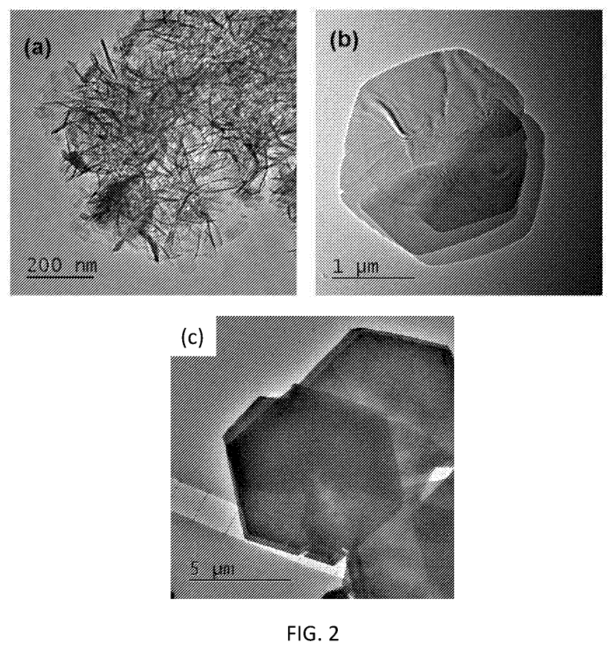

FIG. 2 shows TEM images of precursor LDHs used this study: (a) Mg₄Al—CO₃-AMO LDH from co-precipitation (Cop-AMO LDH); (b) Mg₄Al—CO₃-AMO LDH from urea-hydrothermal method (UHT-AMO LDH); and (c) a commercial 7 μm diameter Mg₄Al—CO₃ LDH obtained from SCG Chemicals.

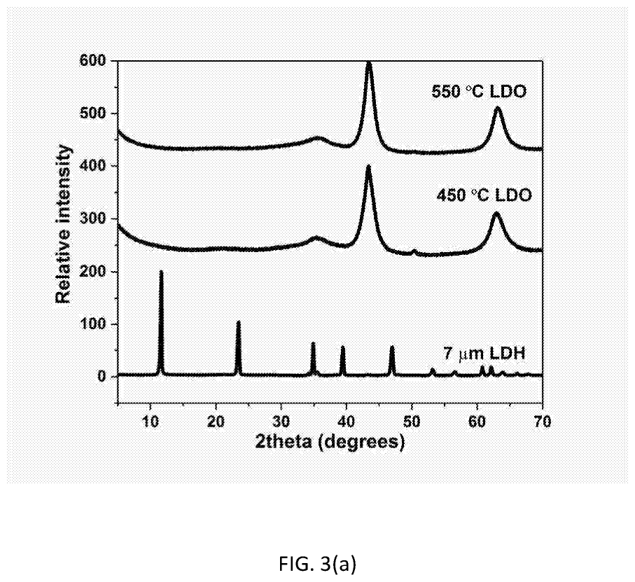

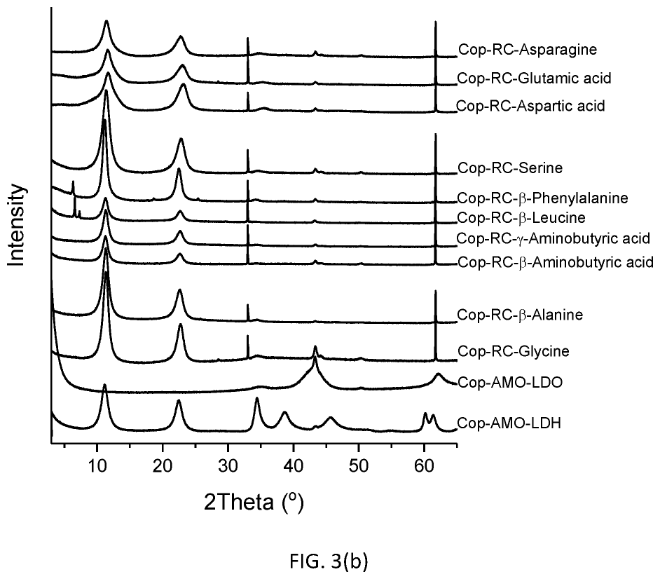

FIG. 3 shows (a) the XRD patterns of a commercial 7 μm diameter Mg₄Al—CO₃ LDH obtained from SCG Chemicals (FIG. 2(c)) thermally treated at 450 and 550° C. affording LDO; (b) the XRD pattern of a coprecipitated precursor LDH, as well as the XRD pattern of the corresponding LDO, and various amino acid-modified LDHs (i.e. LDHs reconstructed (“RC”) from various amino acids).

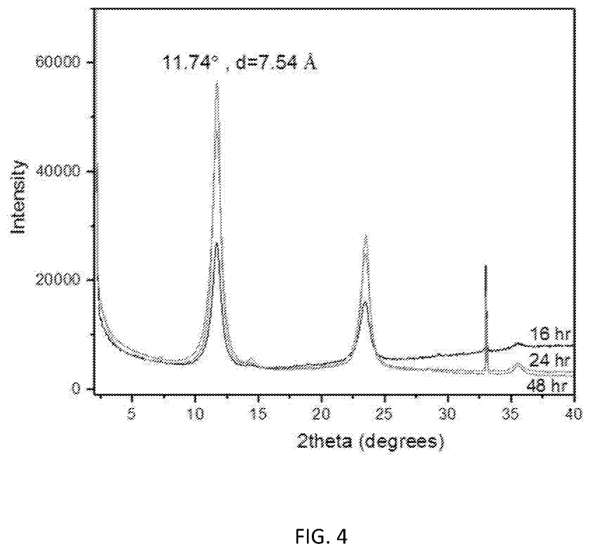

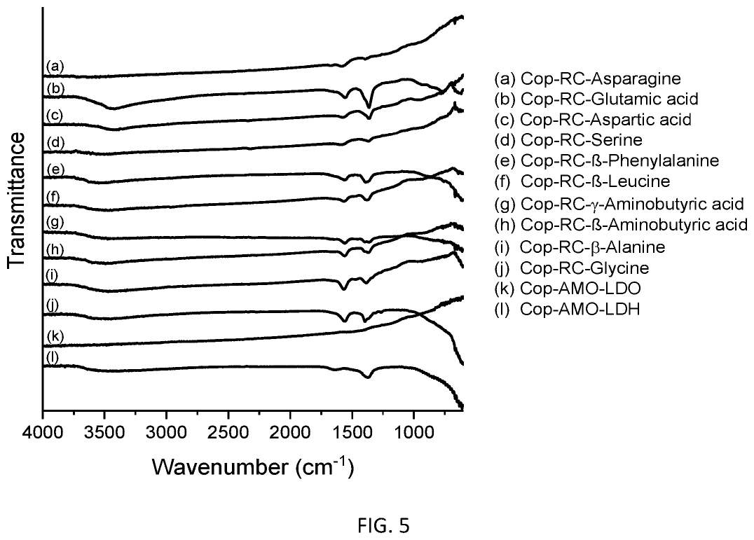

FIG. 4 shows XRD patterns of LDHs modified with glycine for various periods of time following Procedure 2.

FIG. 5 shows the FTIR spectrum of a coprecipitated LDH, as well as the FTIR spectra of the corresponding LDO, and various amino acid-modified LDHs (i.e. LDHs reconstructed (“RC”) from various amino acids) prepared in a round bottom flask following Procedure 1.

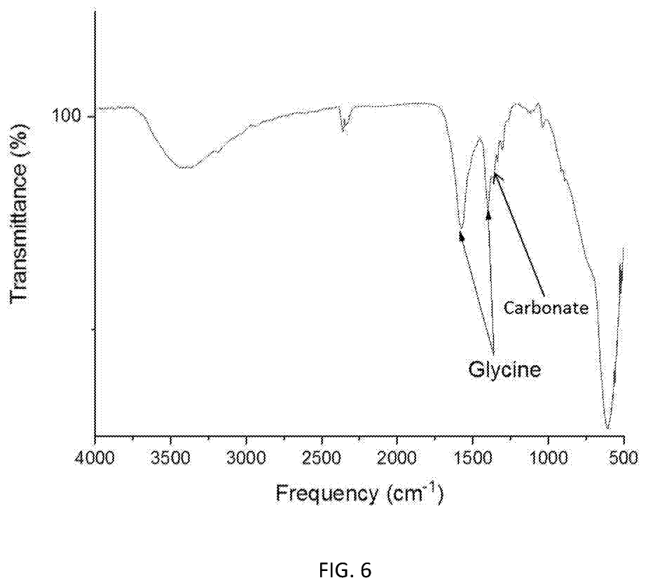

FIG. 6 shows an FTIR spectrum of a coprecipitated LDH reconstructed with glycine for 24 hours following Procedure 2.

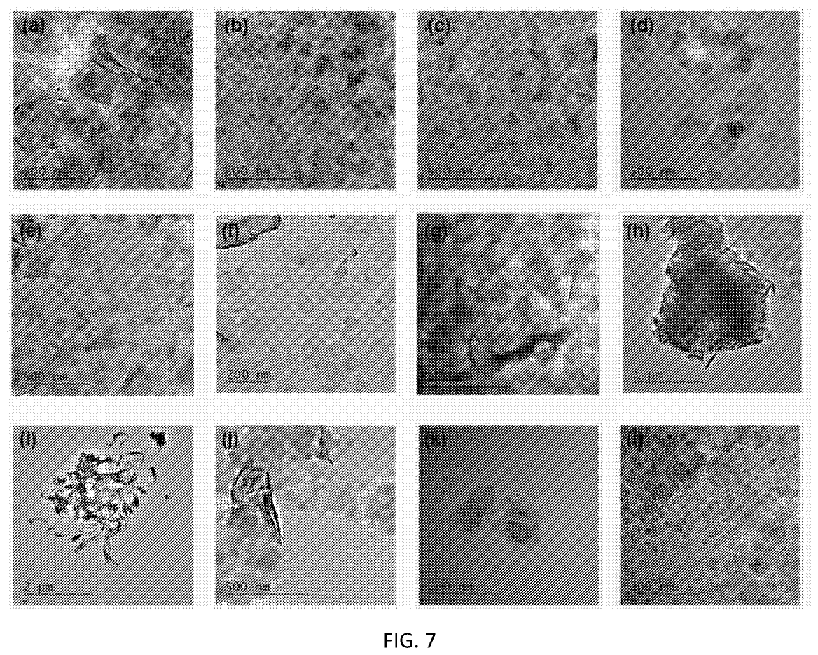

FIG. 7 shows TEM images of LDHs reconstructed with different amino acids in round bottom flask vs autoclave with hydrothermal treatment using coprecipitated Mg₄Al—CO₃-AMO precursor LDHs (Cop-AMO LDH)) following procedure 1; (a), (e) R-Alanine, (b), (f) @-aminobutyric acid, (c), (g) S-Leucine, (d), (h) β-Phenylalanine reconstructed LDHs in round bottom flask and in autoclave hydrothermal treatment, respectively and (i) Aspartic acid, (j) Glutamic acid, (k) Asparagine and (I) Serine reconstructed LDHs in round bottom flask.

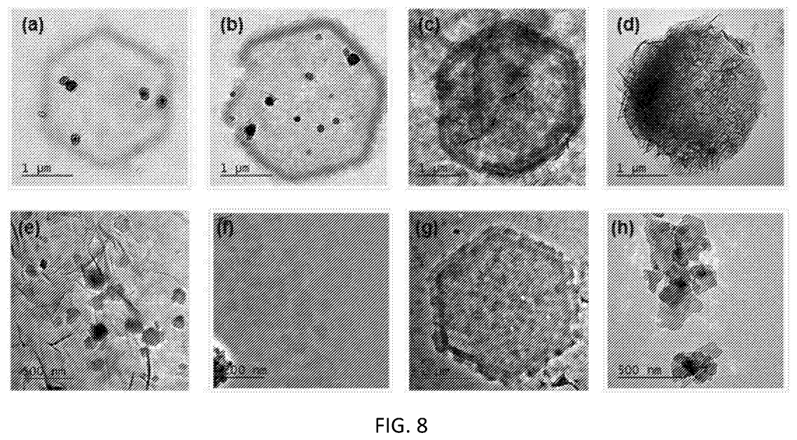

FIG. 8 shows TEM images of LDHs reconstructed with different amino acids in round bottom flask vs autoclave with hydrothermal treatment using urea-hydrothermally treated Mg₄Al—CO₃-precursor AMO LDH (UHT-AMO LDH) following procedure 1; (a), (e) β-Alanine, (b), (f) β-aminobutyric acid, (c), (g) β-Leucine, (d), (h) β-Phenylalanine reconstructed LDHs in round bottom flask and in autoclave hydrothermal treatment, respectively.

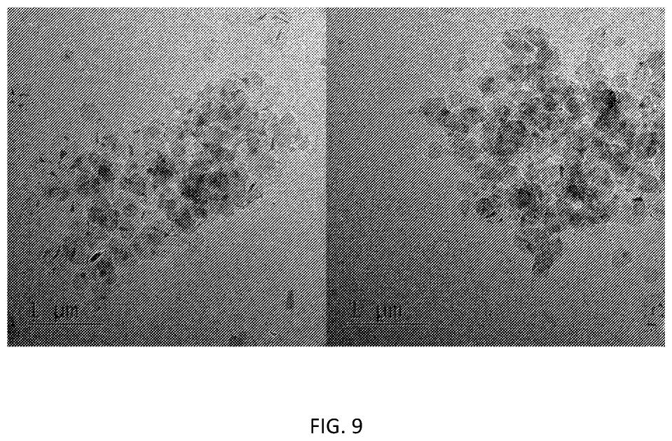

FIG. 9 shows TEM images of an LDH reconstructed with glycine following Procedure 2.

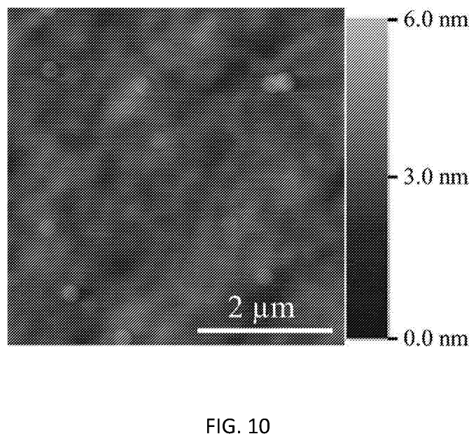

FIG. 10 shows Atomic Force Microscopy image of an LDH reconstructed with glycine following Procedure 2.

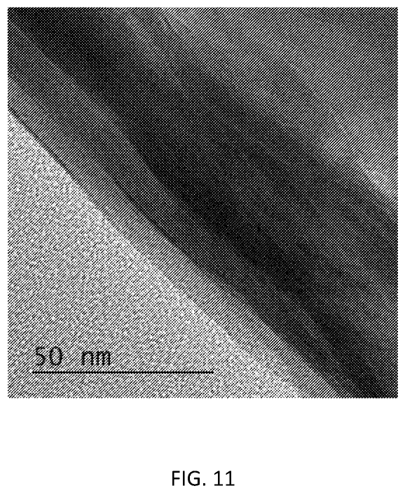

FIG. 11 shows a cross-sectional TEM image of a PET substrate coated with a coating mixture containing an LDH reconstructed with glycine following Procedure 2.

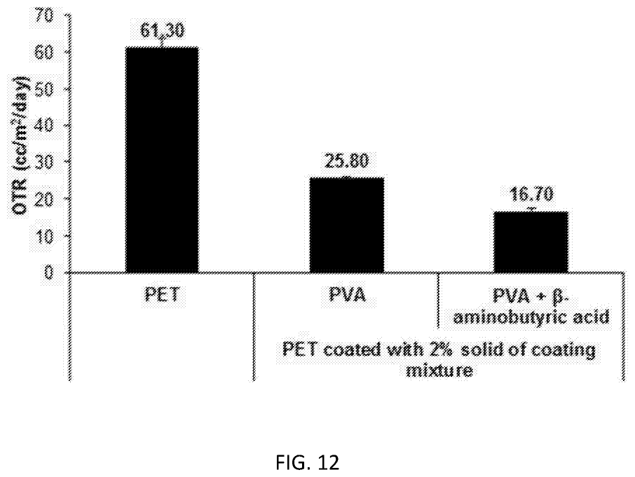

FIG. 12 shows oxygen transmission rate results for various coated and uncoated PET substrates, demonstrating the effect the presence of amino acid (without LDH) on the OTR properties. PET substrate was 23 μm thick and PVA was Mowiol 4-88 (M_{w}˜31000 g/mol).

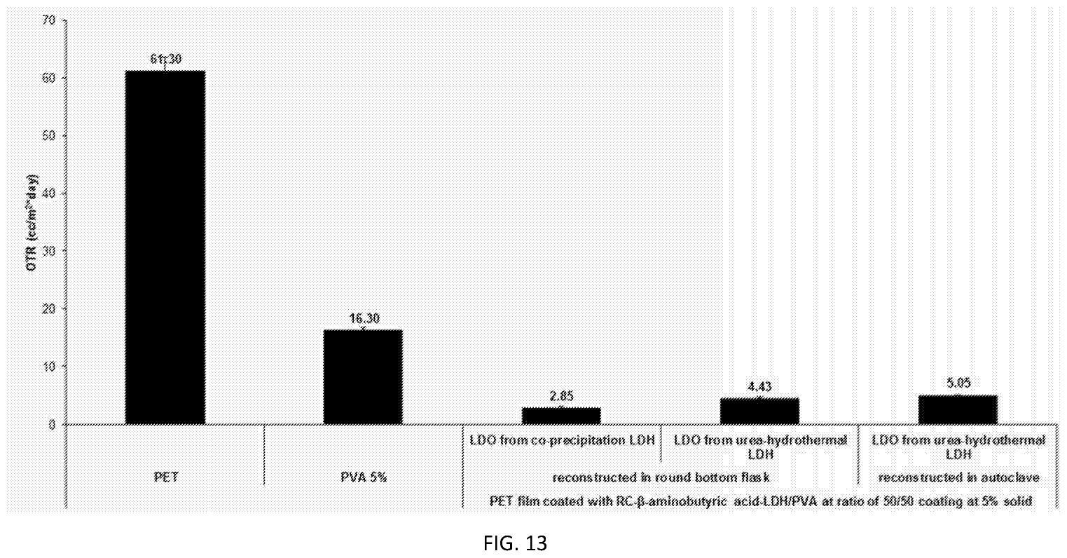

FIG. 13 shows oxygen transmission rate results for various coated and uncoated PET substrates, demonstrating the effect of the LDH synthesis method (coprecipitated vs urea hydrothermal) and reconstruction conditions (round bottom flask vs hydrothermal treating in autoclave) on the OTR properties. PET substrate was 23 μm thick and PVA was Mowiol 4-88 (M_{w}˜31000 g/mol).

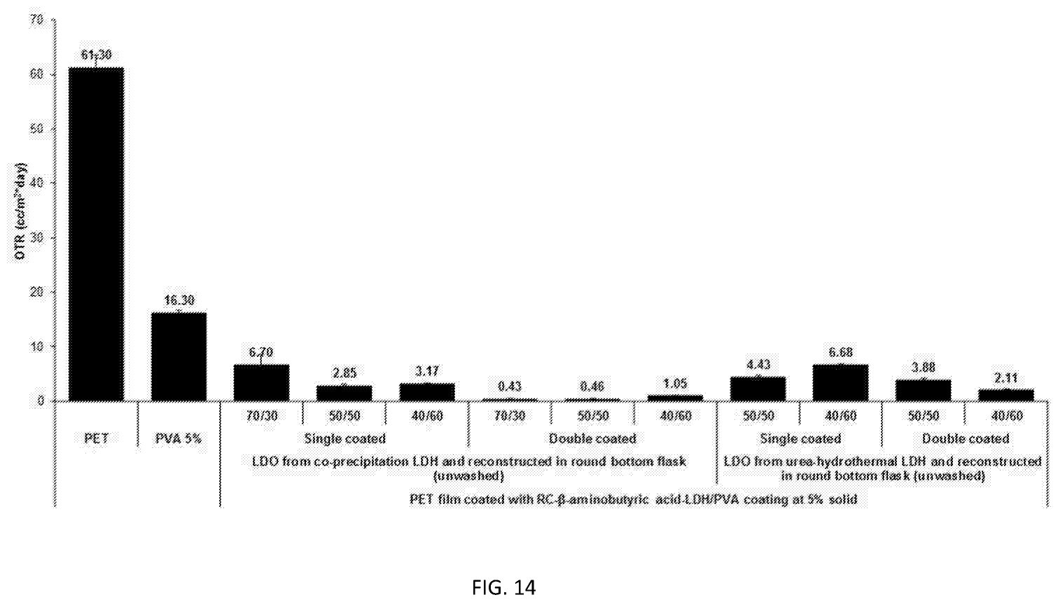

FIG. 14 shows oxygen transmission rate results for various coated and uncoated PET substrates, demonstrating the effect of single vs double layer coating on the OTR properties. PET substrate was 23 μm thick and PVA was Mowiol 4-88 (M_{w}˜31000 g/mol).

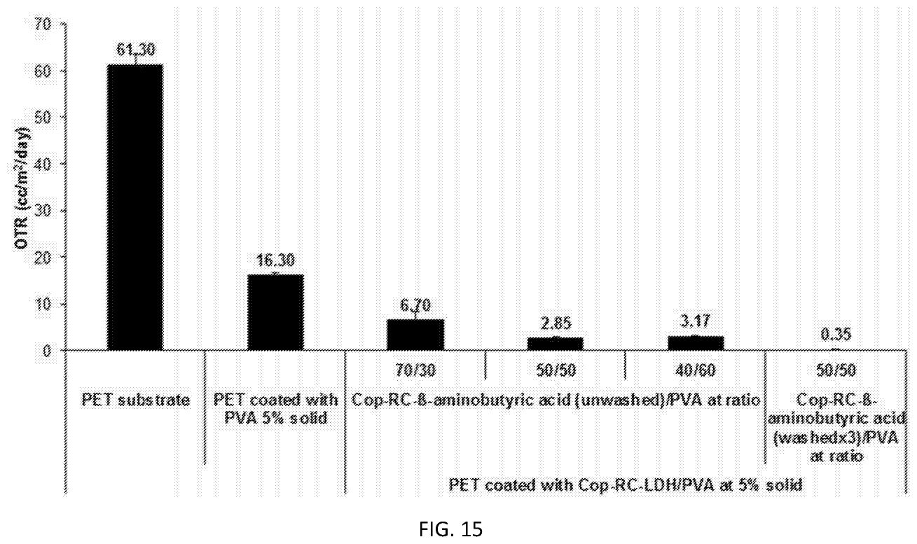

FIG. 15 shows oxygen transmission rate results for various coated and uncoated PET substrates, demonstrating the effect of washing the amino acid-modified LDH on the OTR properties. PET substrate was 23 μm thick and PVA was Mowiol 4-88 (M_{w}˜31000 g/mol).

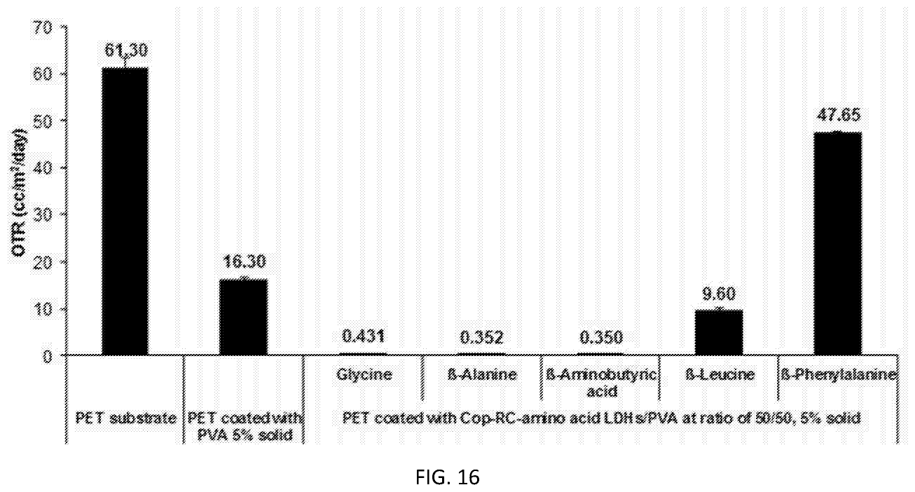

FIG. 16 shows oxygen transmission rate results for various coated and uncoated PET substrates, demonstrating the effect of different amino acid-modified LDHs on the OTR properties. PET substrate was 23 μm thick and PVA was Mowiol 4-88 (M_{w}˜31000 g/mol).

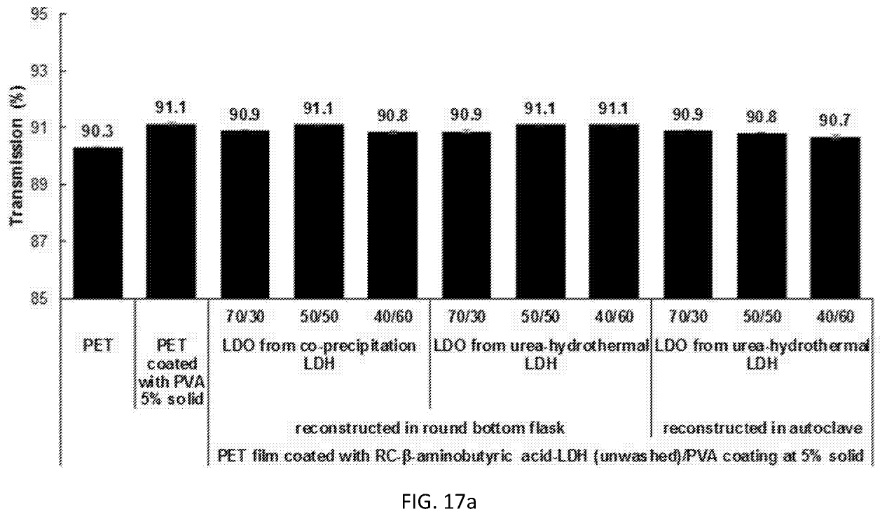

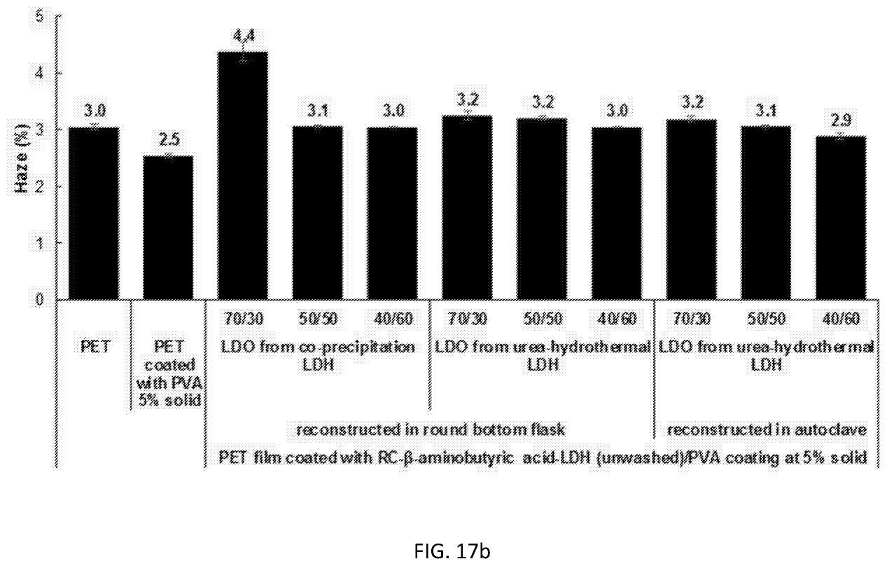

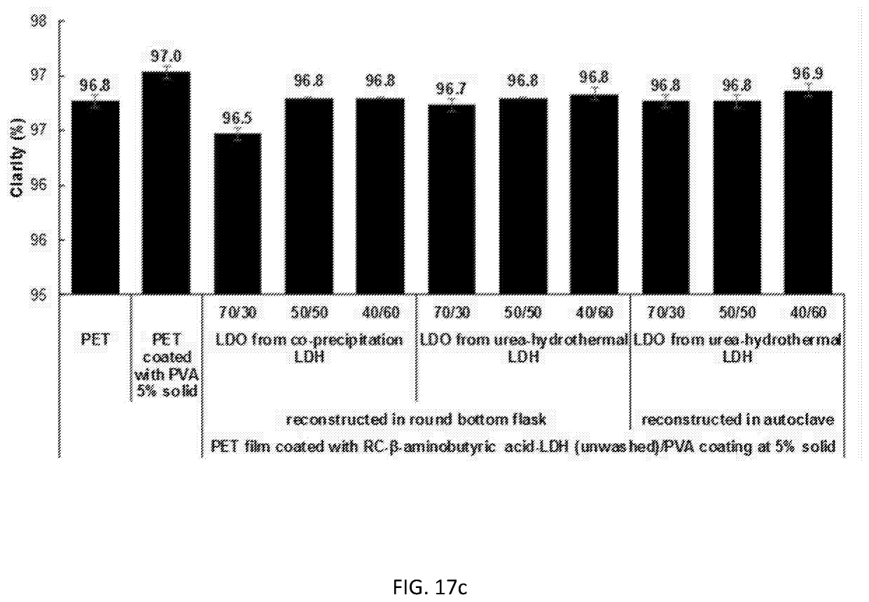

FIG. 17 shows optical properties of various coated and uncoated PET substrates; (a) transmittance, (b) haze and (c) clarity. PET substrate was 23 μm thick and PVA was Mowiol 4-88 (M_{w}˜31000 g/mol).

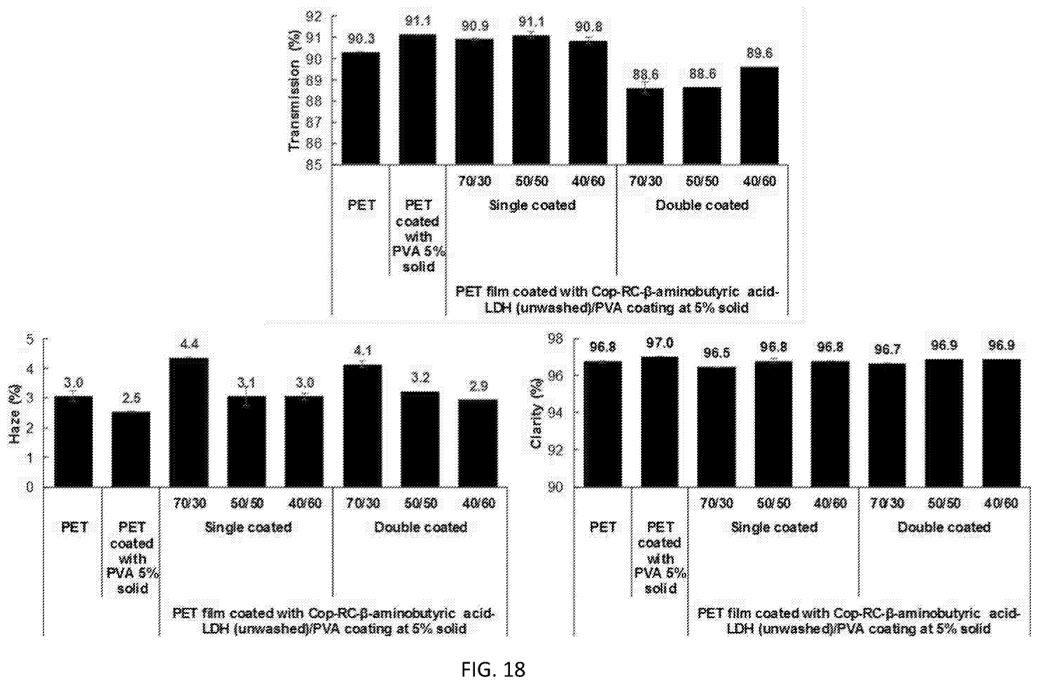

FIG. 18 shows optical properties (transmittance, haze and clarity) of various coated and uncoated PET substrates. PET substrate was 23 μm thick and PVA was Mowiol 4-88 (M_{w}˜31000 g/mol).

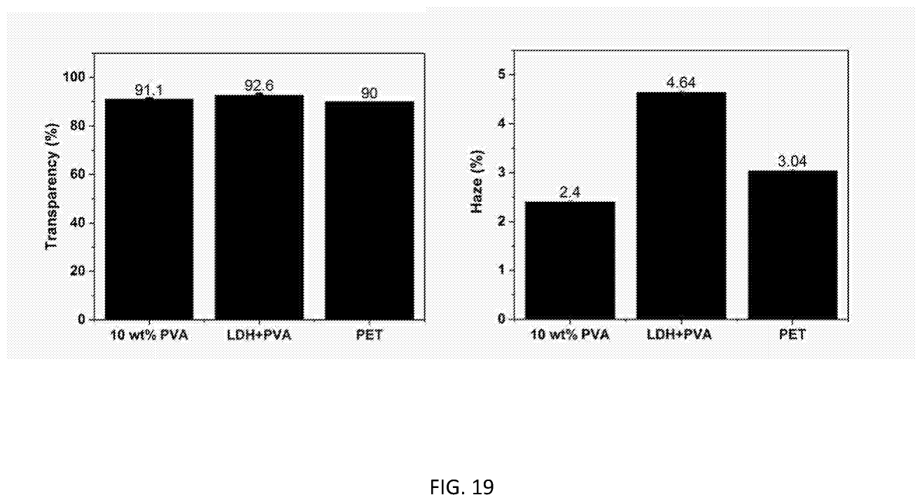

FIG. 19 shows the transparency and haze of uncoated films, and films coated with only PVA or a coating mixture containing glycine modified LDH and PVA at a 5% solid content. The PET film was 12 μm thick and LDH used was 7 um LDH (FIG. 2(c)) calcined at 550° C. and reconstructed with glycine according to Procedure 2 for 48 h at 100° C. Within the coating mixture, LDH was 3 wt % and PVA (M_{w} 67,000) was 2 wt % (total 5% solids). Left columns—10 wt % PVA (no LDH). middle columns—5 wt % LDH+PVA (3% wt LDH+2 wt % PVA). Right column—uncoated 12 μm thick PET film.

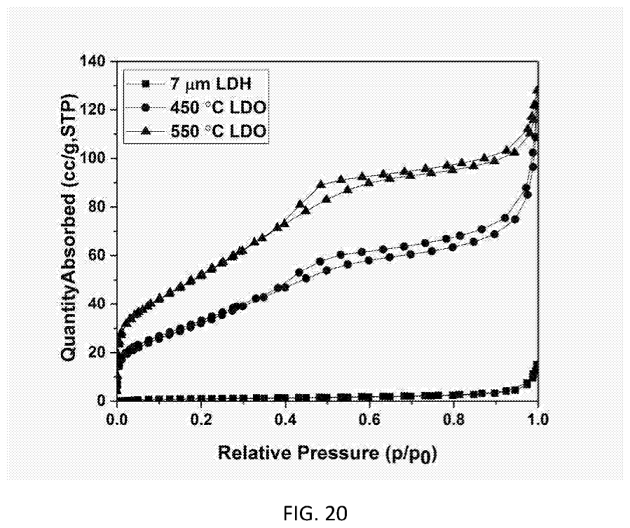

FIG. 20 shows the BET (N₂) traces for the LDH depicted in FIG. 2(c) as well as the same LDH thermally treated at 450 and 550° C., affording LDO. The 7 μm LDH has a surface area of 4 m²/g and the LDO of 130 and 202 m²/g for temperature of calcination at 450 and 550° C. respectively.

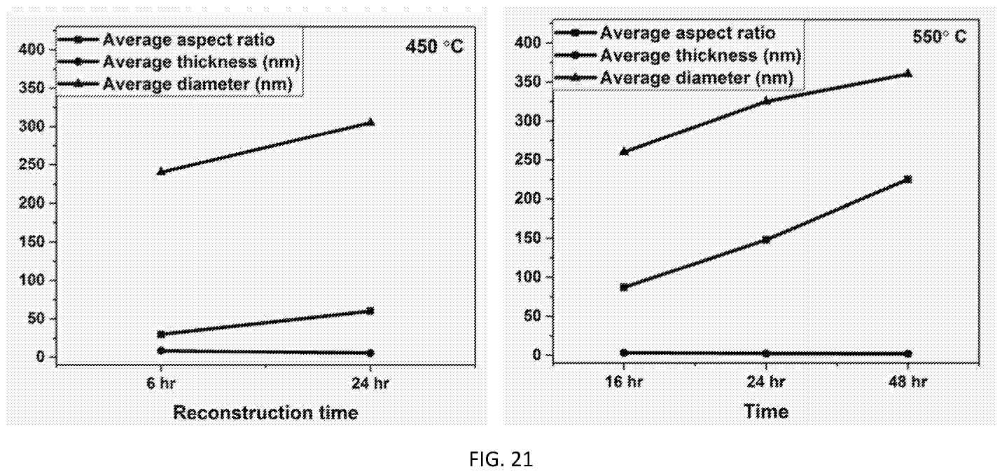

FIG. 21 shows the variation on aspect ratio, thickness and diameter over reconstruction time for two different thermal treatment temperatures using the precursor LDH depicted in FIG. 2(c) that has been modified with glycine according to Procedure 2. It shows that the aspect ratio increases with increasing time of reconstruction.

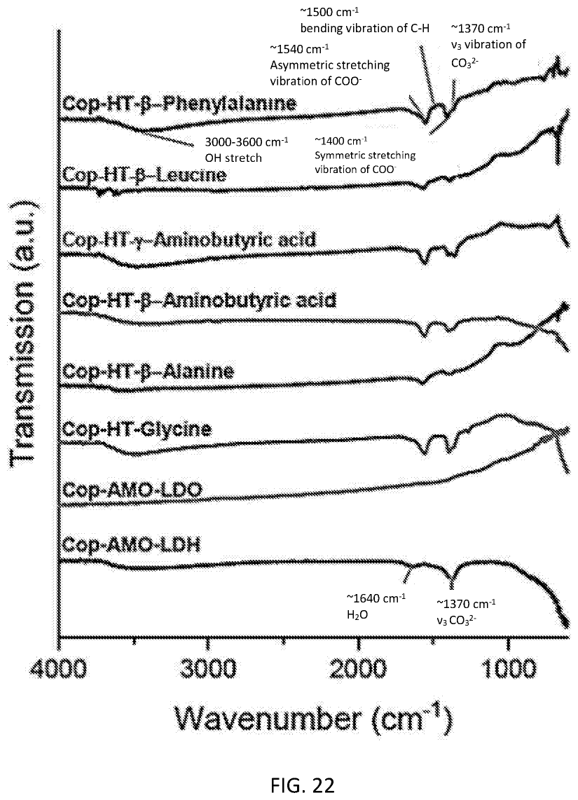

FIG. 22 shows FTIR spectrum of a coprecipitated LDH, as well as the FTIR spectra of the corresponding LDO, and various amino acid-modified LDHs (i.e. LDHs reconstructed from various amino acid solutions) prepared in under hydrothermal (“HT”) conditions in an autoclave according to Procedure 1.

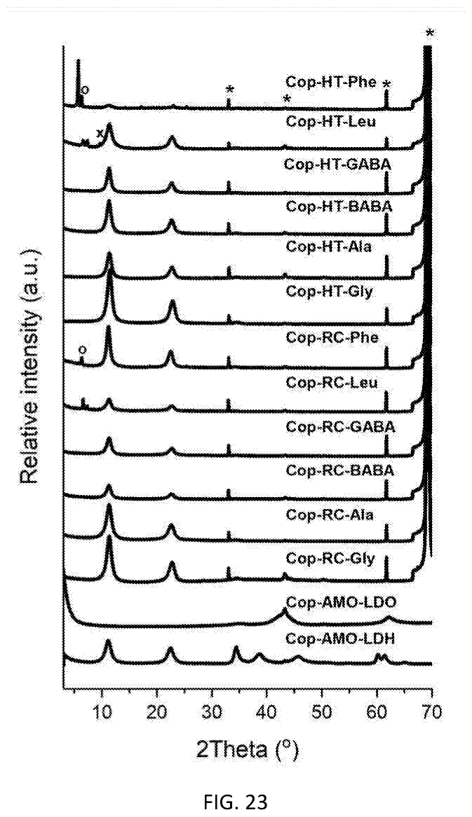

FIG. 23 shows the XRD pattern of a coprecipitated precursor LDH, as well as the XRD pattern of the corresponding LDO, and various amino acid-modified LDHs (i.e. LDHs reconstructed from various amino acids) prepared by heating in a round bottom flask (“RC”) or under hydrothermal (“HT”) conditions in an autoclave according to Procedure 1. o and x denote the Bragg reflections of impurities from phenylalanine (o) and leucine (x). (*Bragg reflections due to the sample holder were observed at 26=43-44 and 500 and reflections from the silicon wafer were located at 26=330 and 62.)

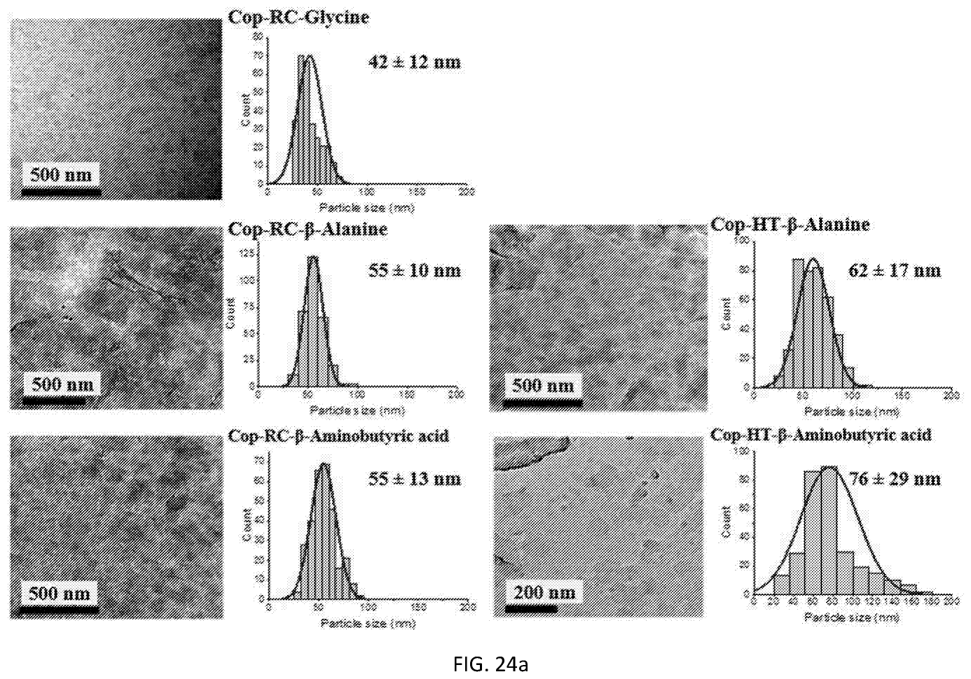

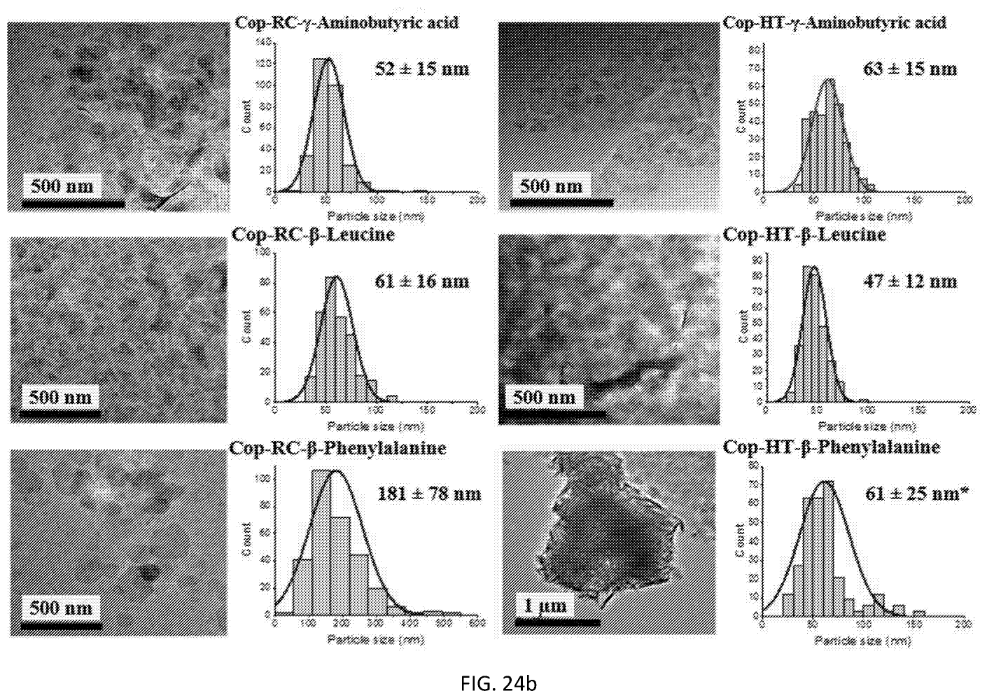

FIG. 24 shows TEM images with particle size distributions of reconstructed products from co-precipitation LDHs (Cop) with different nonpolar amino acids. “RC” and “HT” were denoted as product from round bottom flask using oil bath heating and hydrothermal reactors, respectively, according to Procedure 1. Black lines indicate the best fit of a Gaussian distribution, showing approximately a normal distribution. Mean values and standard deviation were obtained from measurement of 300 particles. ‘*’ indicates that only small size particles were used for size distribution curves.

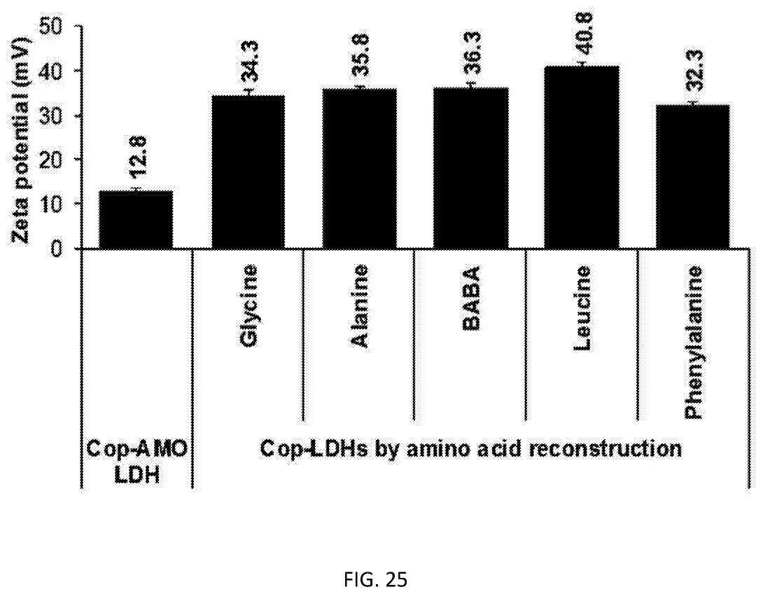

FIG. 25 shows the Zeta potential of a coprecipitated precursor LDH and various reconstructed amino acid-modified LDHs.

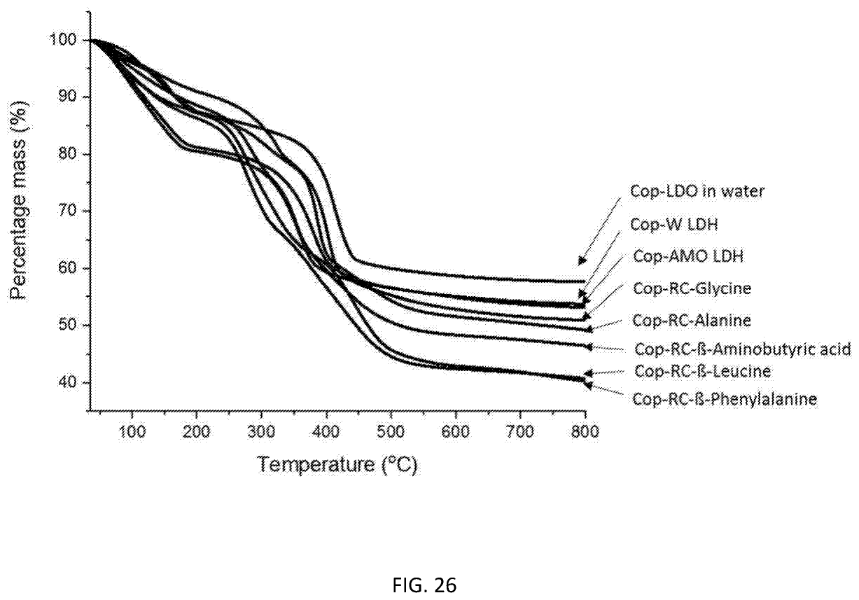

FIG. 26 shows TGA curves of coprecipitated precursor LDHs (water-washed and AMO solvent treated), a LDH reconstructed from an LDO in water, and various reconstructed amino acid-modified LDHs prepared by round bottom flask heating according to Procedure 1.

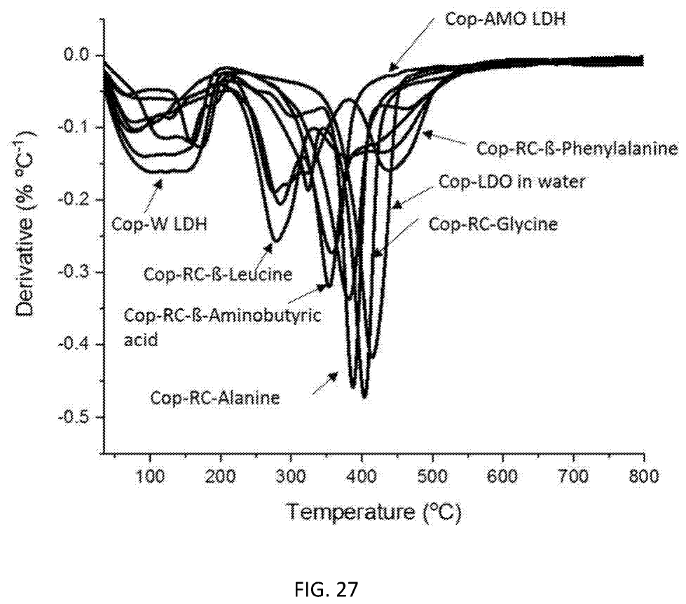

FIG. 27 shows differential thermogravimetric curves (DTG) of coprecipitated precursor LDHs (water-washed and AMO solvent treated), a LDH reconstructed from an LDO in water, and various reconstructed amino acid-modified LDHs prepared by round bottom flask heating according to Procedure 1.

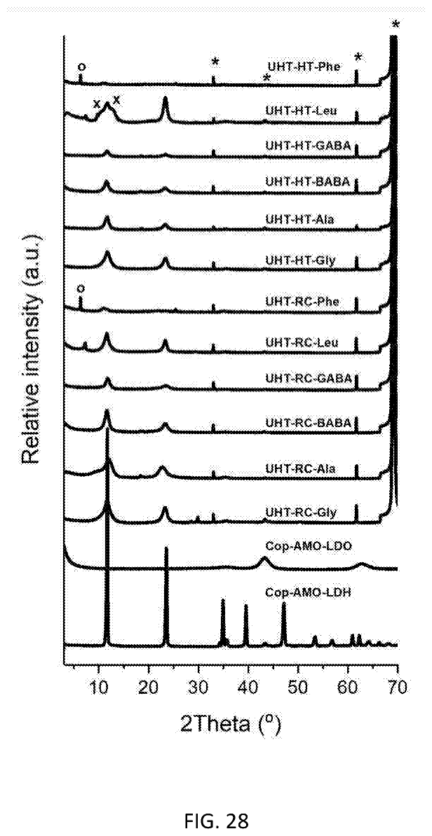

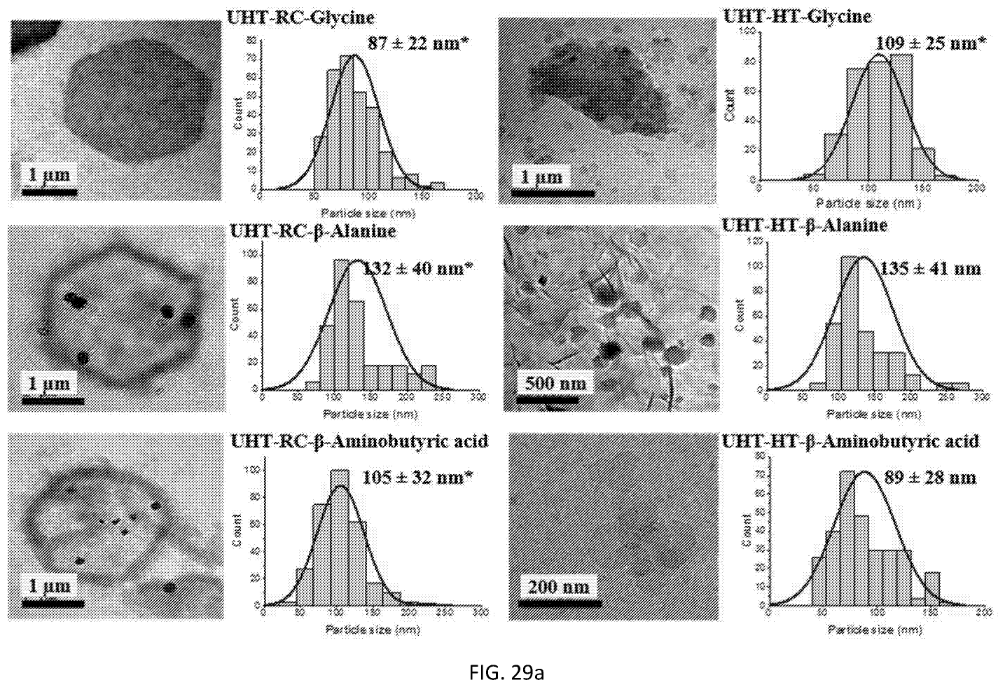

FIG. 28 shows XRD pattern of reconstructed LDHs (originated from UHT-AMO LDHs) by nonpolar amino acids by round bottom flask heating according to Procedure 1. o and x denote the Bragg reflections of impurities from phenylalanine (o) and leucine (x). (*Bragg reflections due to the sample holder were observed at 2θ=43-44° and 50° and reflections from the silicon wafer were located at 2θ=330 and 62°.)

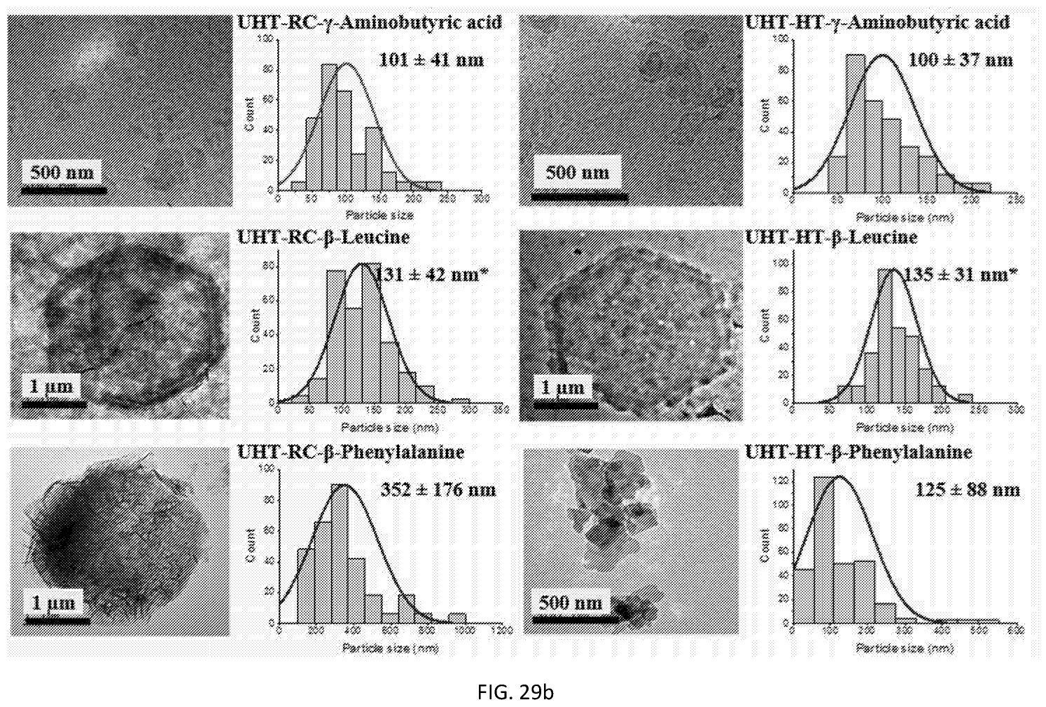

FIG. 29 shows TEM images with particle size distributions of reconstructed products from urea-hydrothermal LDHs (UHT) with different nonpolar amino acids. ‘RC’ and ‘HT’ were denoted as product from round bottom flask using oil bath heating and hydrothermal reactors, respectively, according to Procedure 1. Black lines indicate the best fit of a Gaussian distribution, showing approximately a normal distribution. Mean values and standard deviation were obtained from measurement of 300 particles. ‘*’ indicates that only small size particles were plotted the size distribution curves.

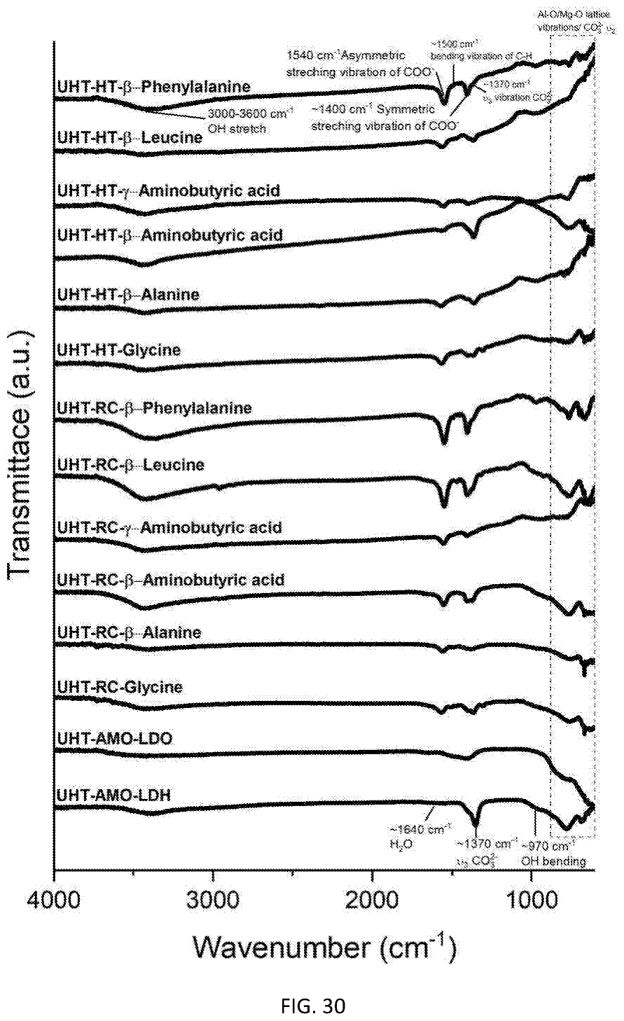

FIG. 30 shows FTIR spectra of reconstructed LDHs (originated from UHT-AMO LDHs) by nonpolar amino acids using round bottom flask using oil bath heating (“RC”) or hydrothermal conditions (“HT”) according to Procedure 1.

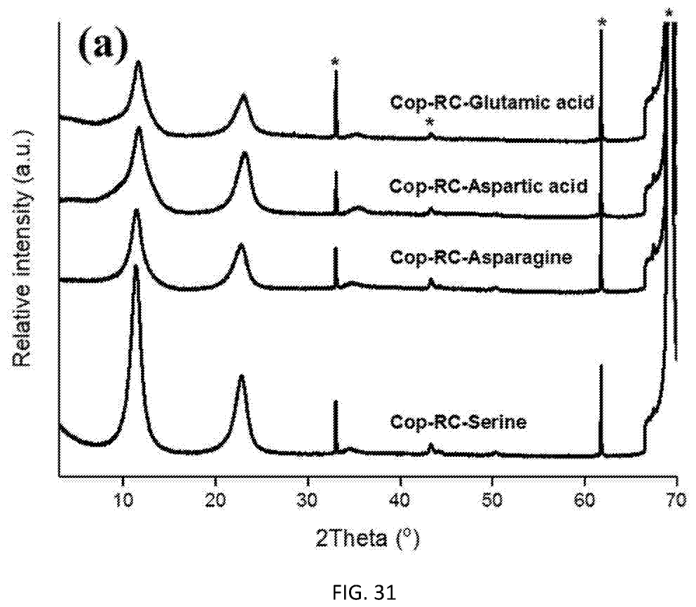

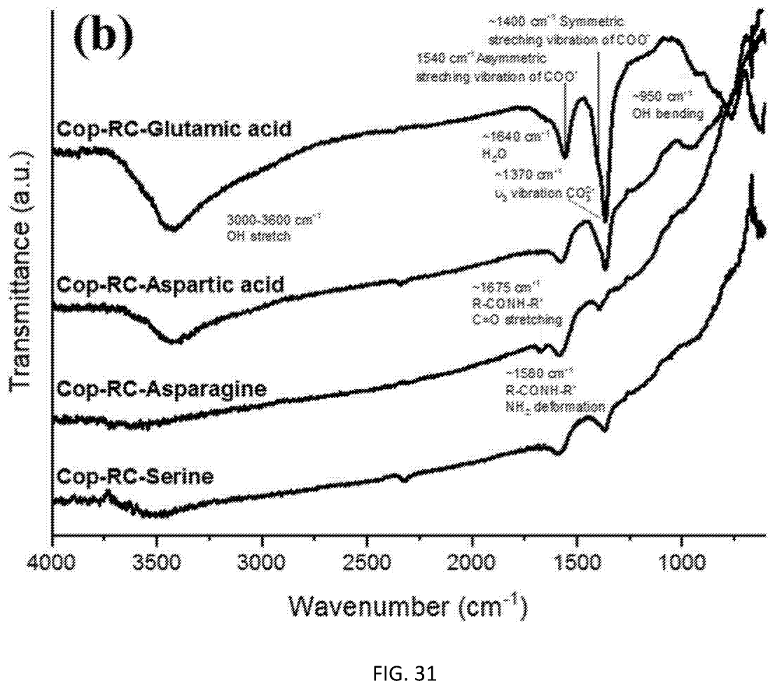

FIG. 31 shows (a) XRD patterns and (b) FTIR of reconstructed LDHs (originated from Cop-AMO LDHs) using polar side chain amino acids. (*Bragg reflections due to the sample holder were observed at 2θ=43-44° and 50° and reflections from the silicon wafer were located at 2θ=33° and 62°).

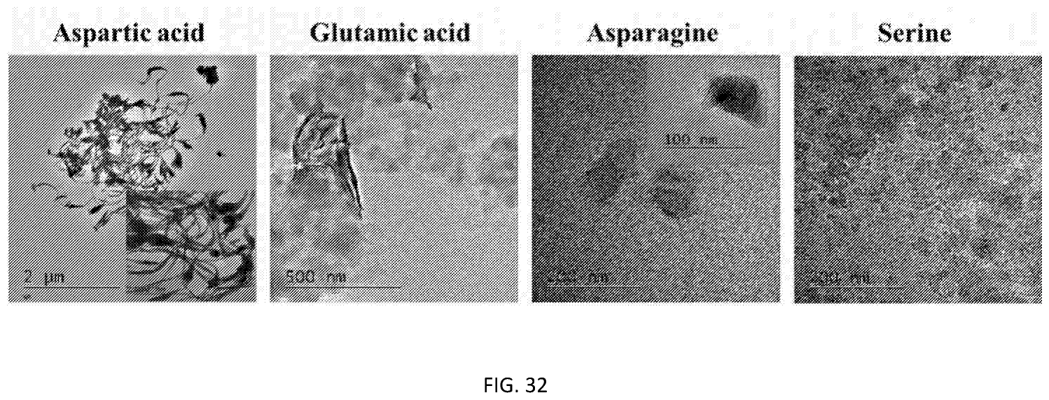

FIG. 32 shows TEM images of reconstructed LDHs using different polar amino acids.

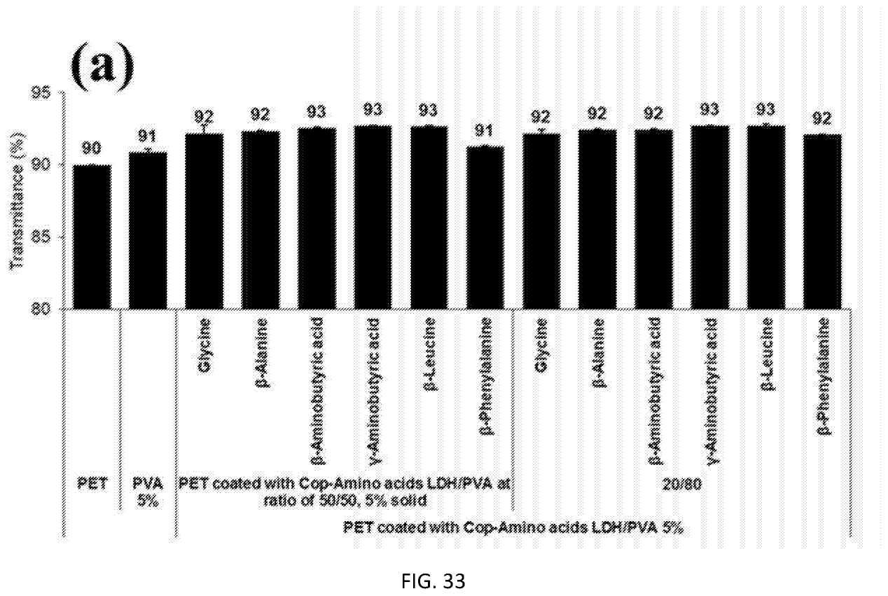

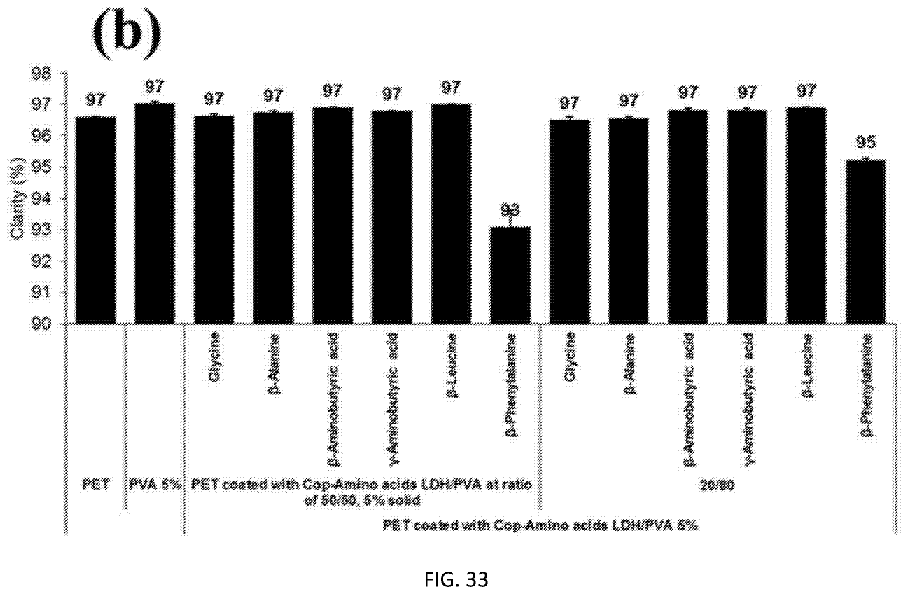

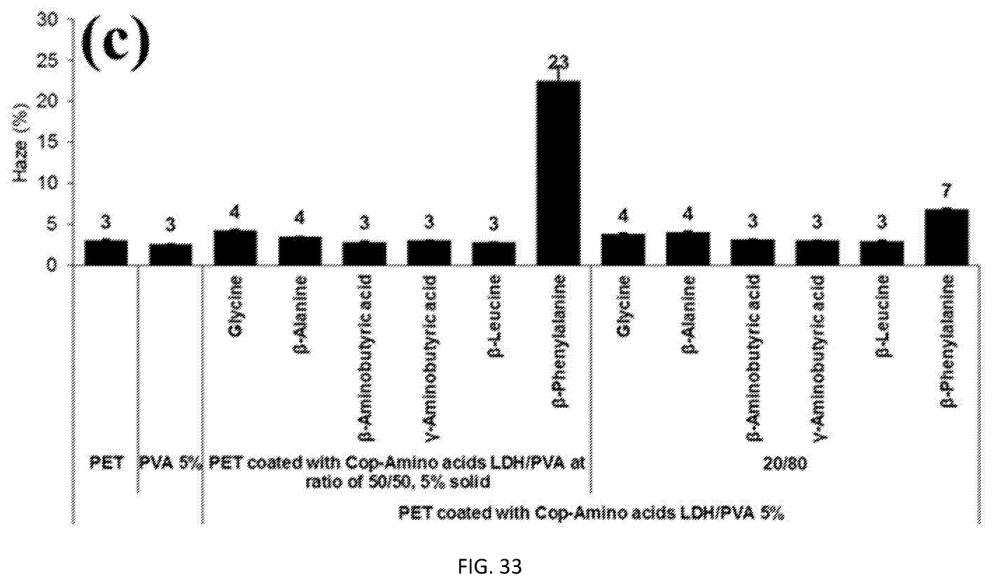

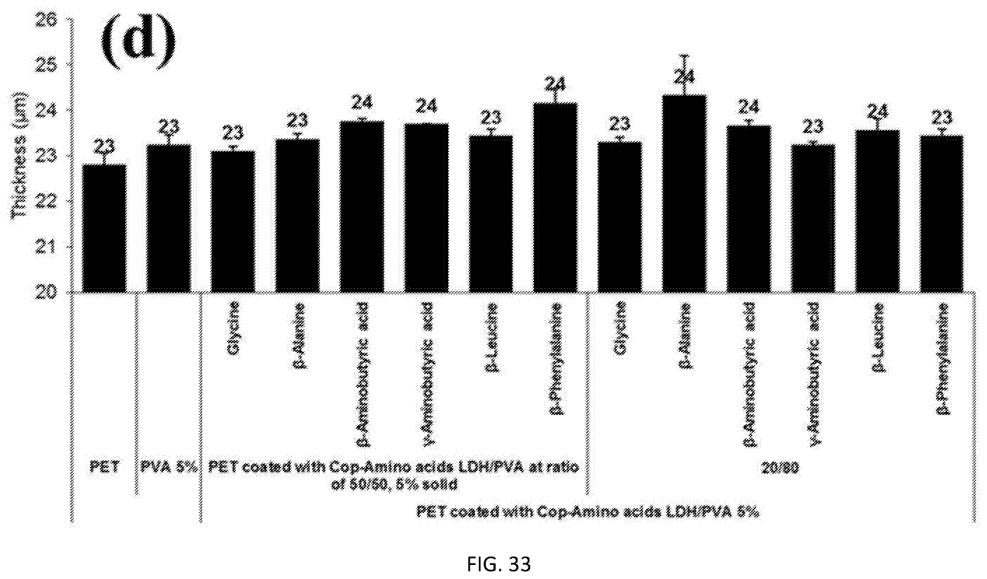

FIG. 33 shows optical properties of coated films: (a) % transmission, (b) % clarity, (c) % haze and (d) film thickness.

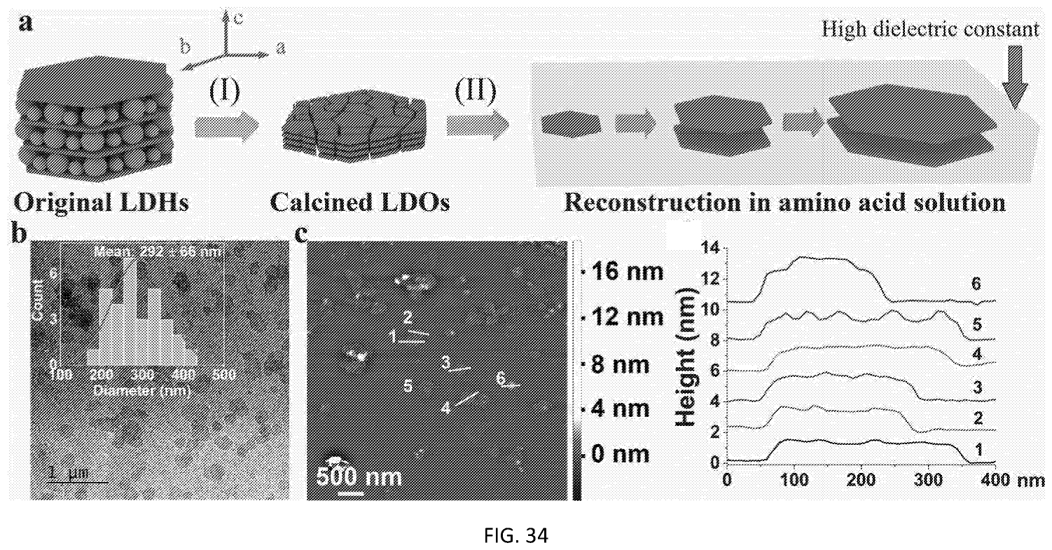

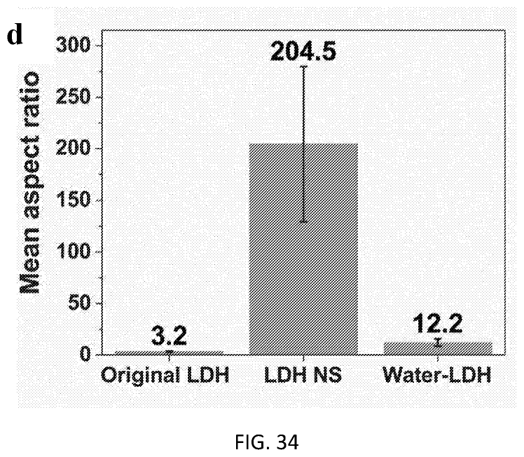

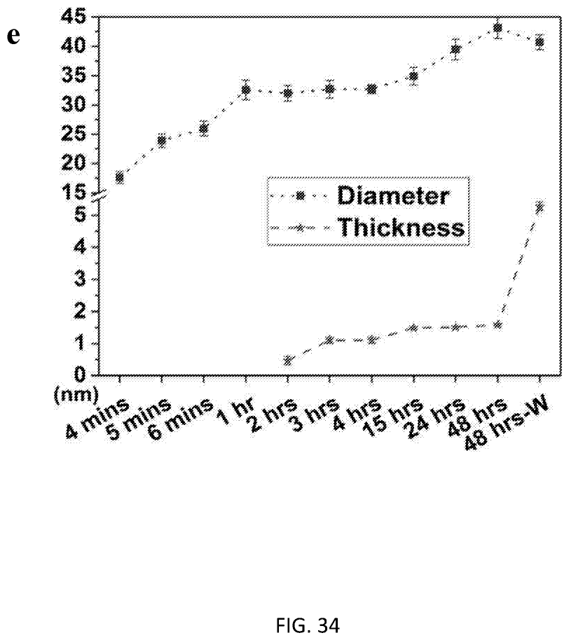

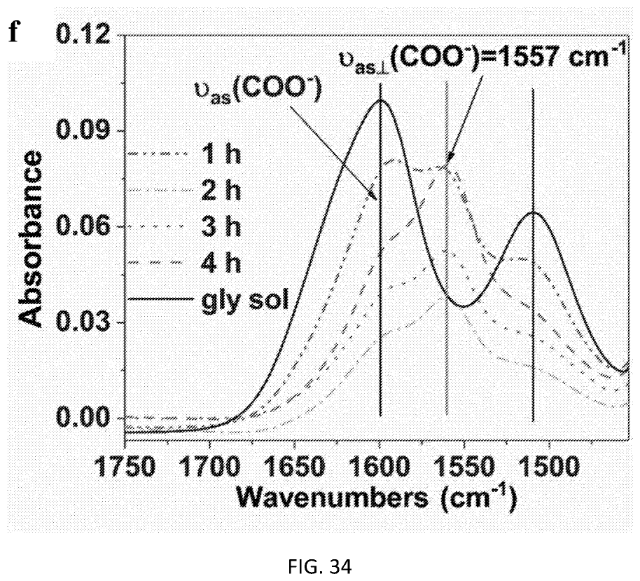

FIG. 34 shows high aspect ratio LDH NS. (a), Schematic showing (I) calcination (interlayer water and anions are removed by calcination) and (II) reconstruction process and the preferential growth inhibition in a high dielectric constant solution: thickness growth is much slower than the diameter growth, giving high aspect ratio NS. TEM (b) and AFM images (c) of the MgAl-LDH reconstructed in glycine solution (inset in TEM image represents the diameters measured by TEM). (d), Mean diameter and mean thickness measured by AFM measurements and the calculated mean aspect ratio of original LDH, LDH reconstructed in glycine and in water (Mean aspect ratio is taken the mean value of the aspect ratio of individual particles). (e), Estimation of crystallite sizes calculated from Scherrer equation confirming the growth inhibition in the c direction. (f), IR spectra: formation of hydrogen bonding evidenced by the red shift of asymmetry vibration of COO⁻ group and that part of the group is shifted to orthogonal position (vₐₛ(COO⁻)=1557 cm⁻¹) during reconstruction in glycine solution.

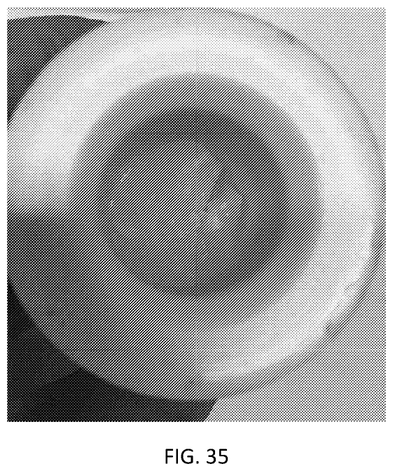

FIG. 35 shows a digital image of the reconstructed LDH gel.

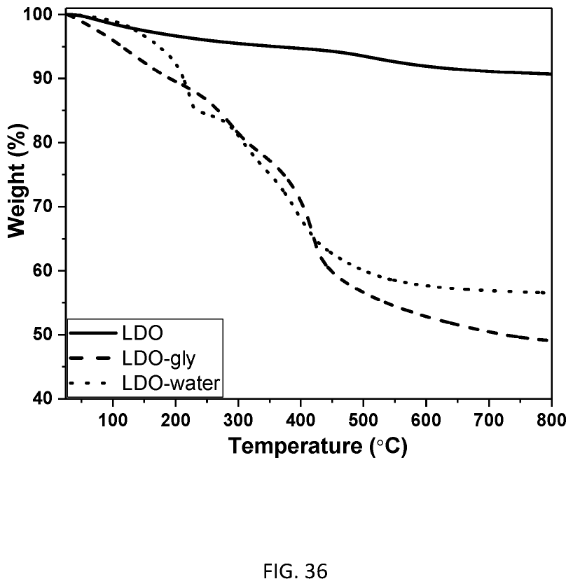

FIG. 36 shows thermal analysis of LDO, LDO reconstructed in glycine and in water.

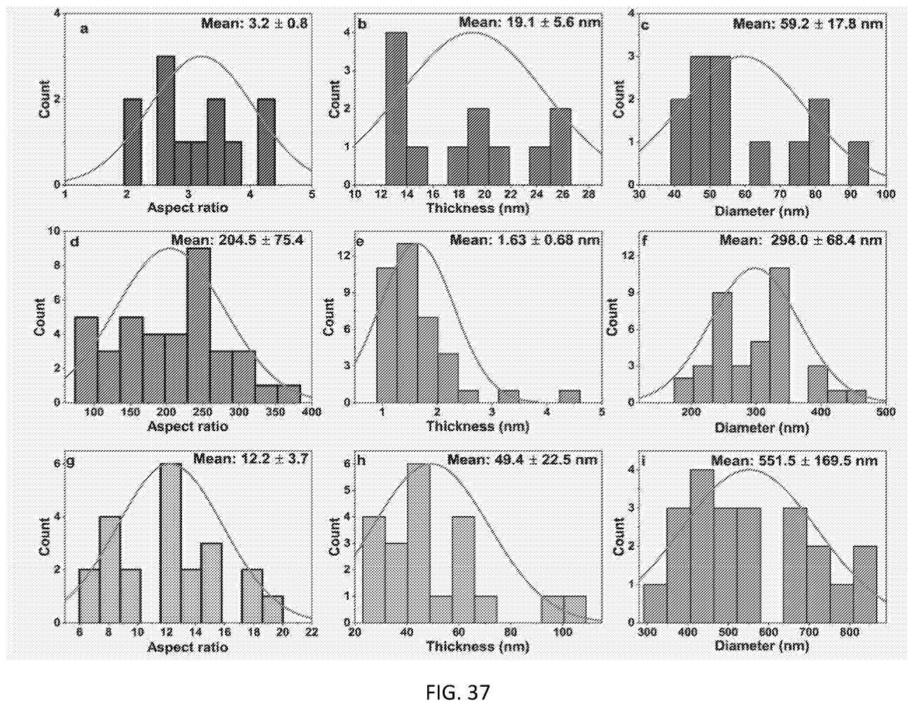

FIG. 37 shows mean aspect ratio, thickness, and diameter of LDHs. The original LDH (a, b and c), LDH reconstructed in glycine solution (d, e, and f), and LDH reconstructed in water (g, h, and i). Thickness and diameter are obtained from AFM measurements of samples at more than three different spots. Aspect ratio was calculated by diameter divided by thickness of individual particles.

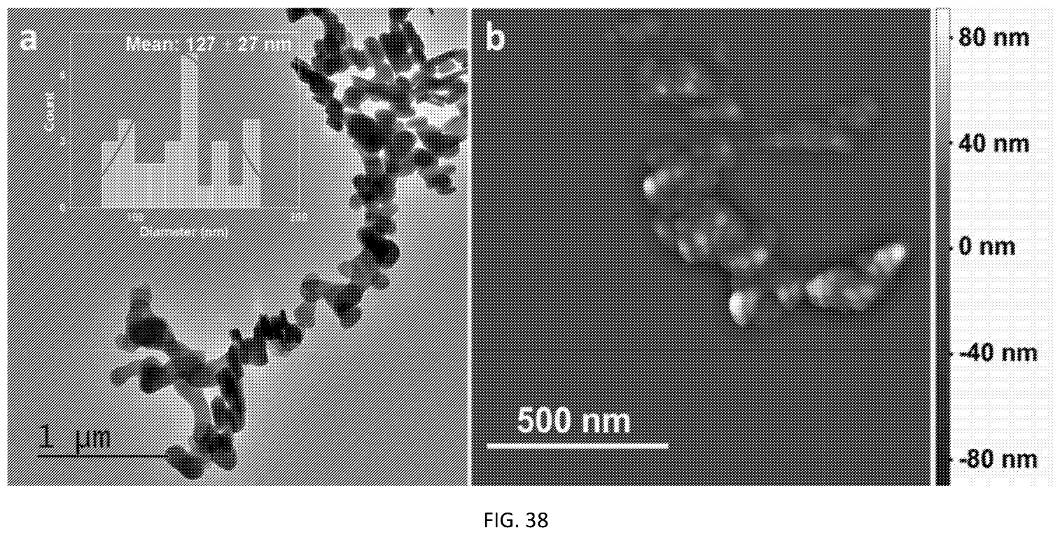

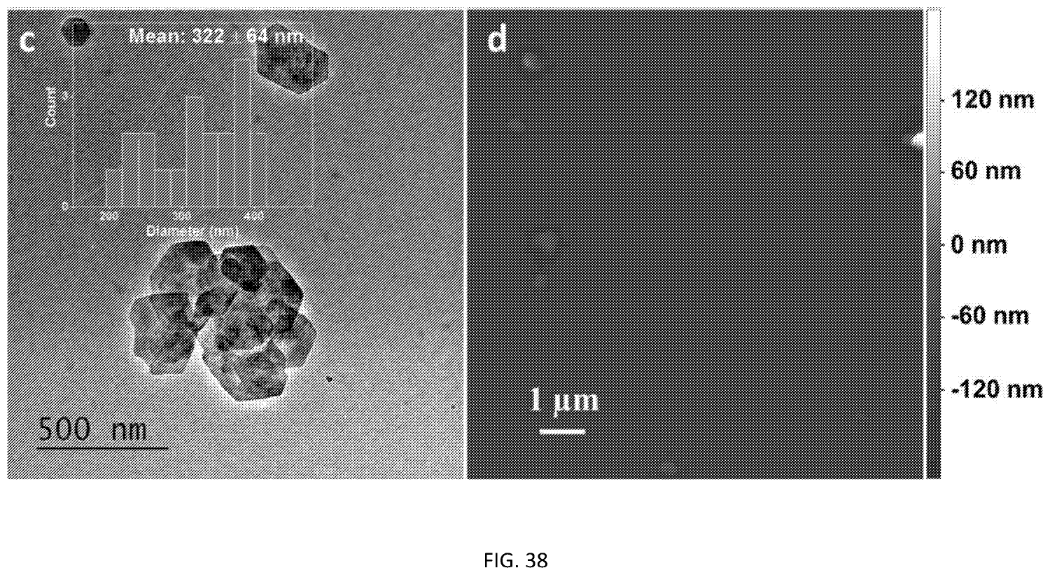

FIG. 38 shows particle size of LDHs: TEM and AFM images of the original LDH (a and b) and the control LDH reconstructed in water (c and d) (inset in TEM images represents the diameters measured by TEM).

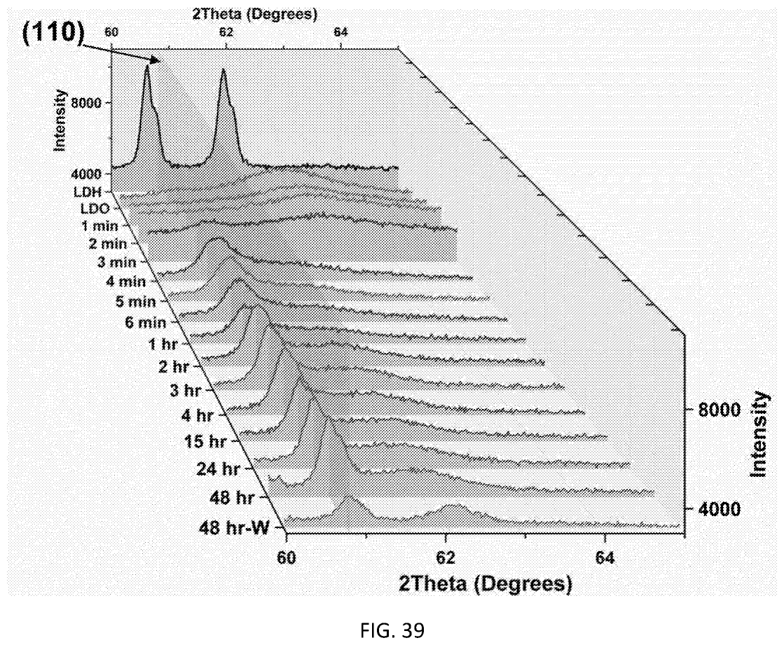

FIG. 39 shows XRD patterns of MgAl-LDH NS at reconstruction time varied from 1 minute to 48 hours: diameter growth monitored by (110) peak (f) (48 hrs-W, W represent washed sample) compared with the original LDH, calcined LDO and washed 48 hours sample.

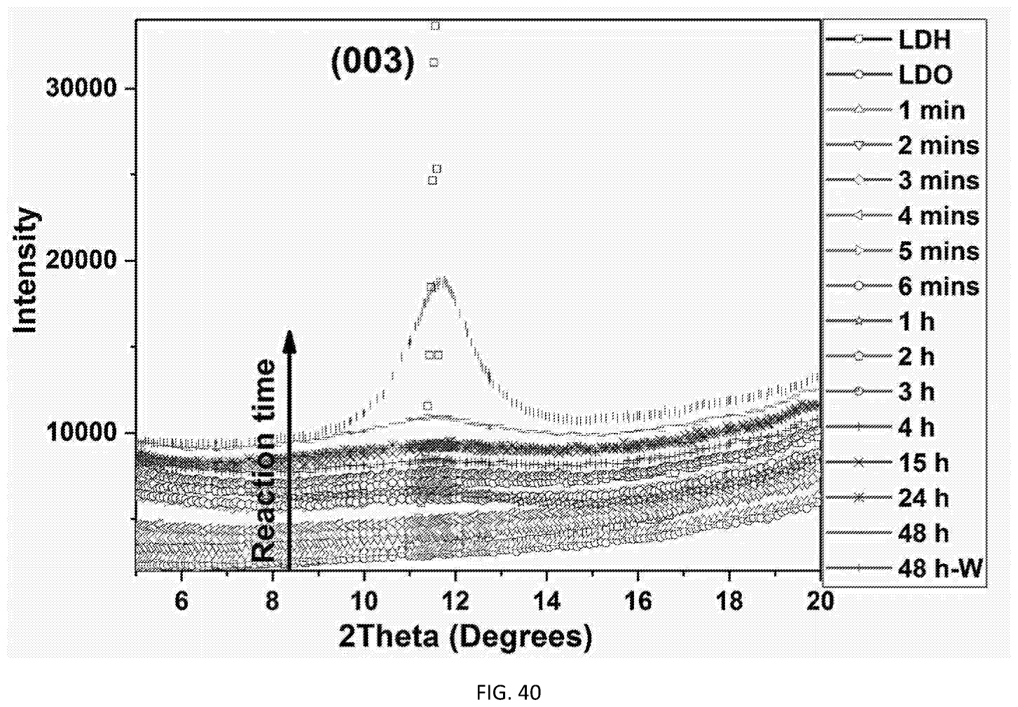

FIG. 40 shows XRD patterns of MgAl-LDH NS at reconstruction time varied from 1 minute to 48 hours: thickness growth monitored by (003) (48 hrs-W, W represent washed sample) compared with the original LDH, calcined LDO and washed 48 hours sample.

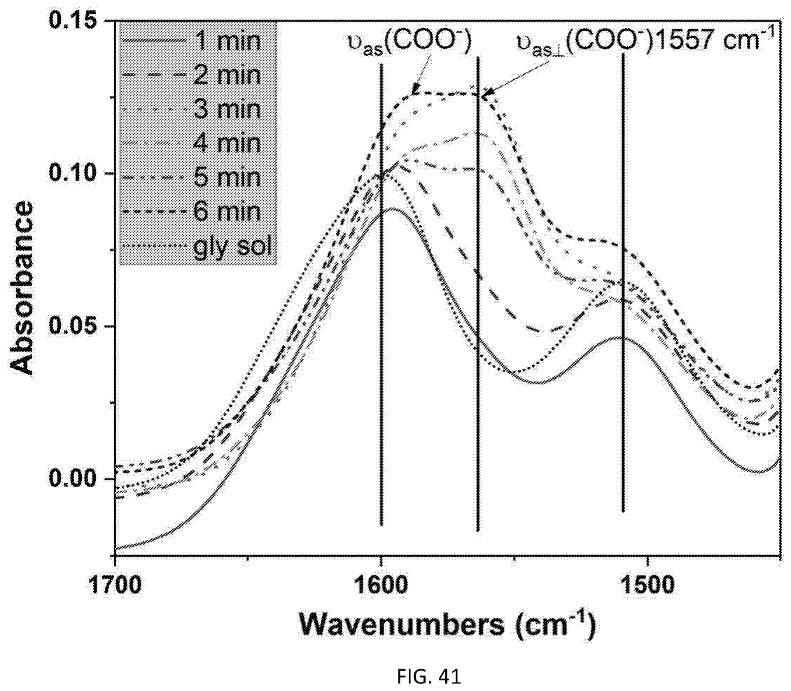

FIG. 41 shows IR spectra of LDH reconstructed in glycine solution for various periods of time.

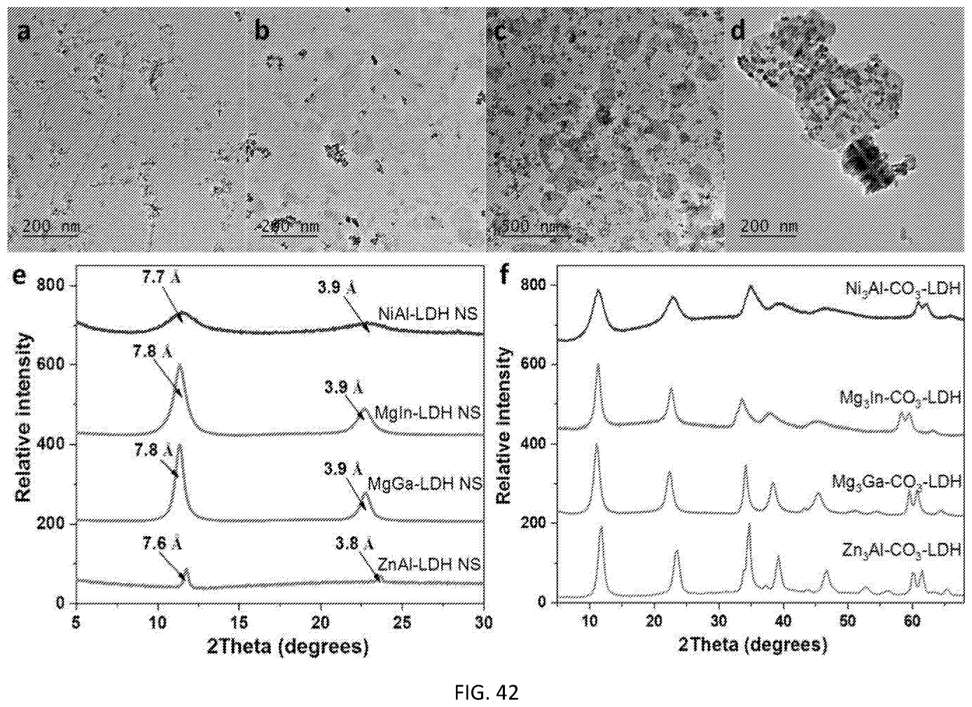

FIG. 42 shows reconstruction of other LDHs containing various metal cations. TEM images of reconstructed NiAl (a), Mgln (b), MgGa (c), and ZnAl-LDH NS (d); XRD patterns of the reconstructed LDHs NS (e) and original LDHs (f).

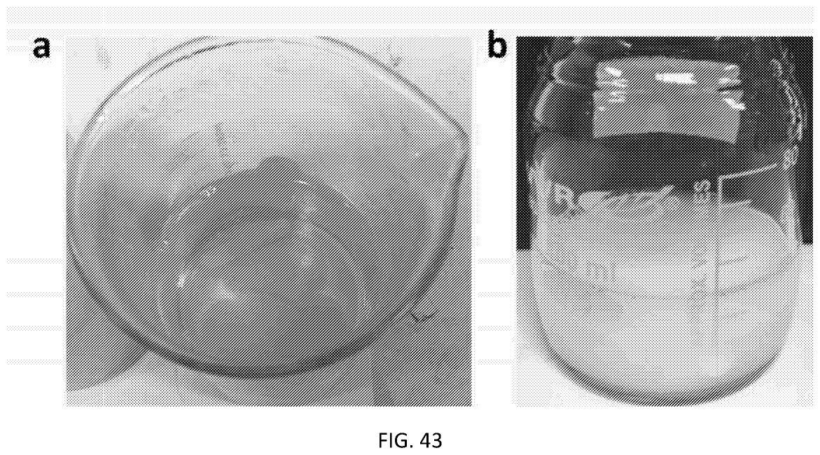

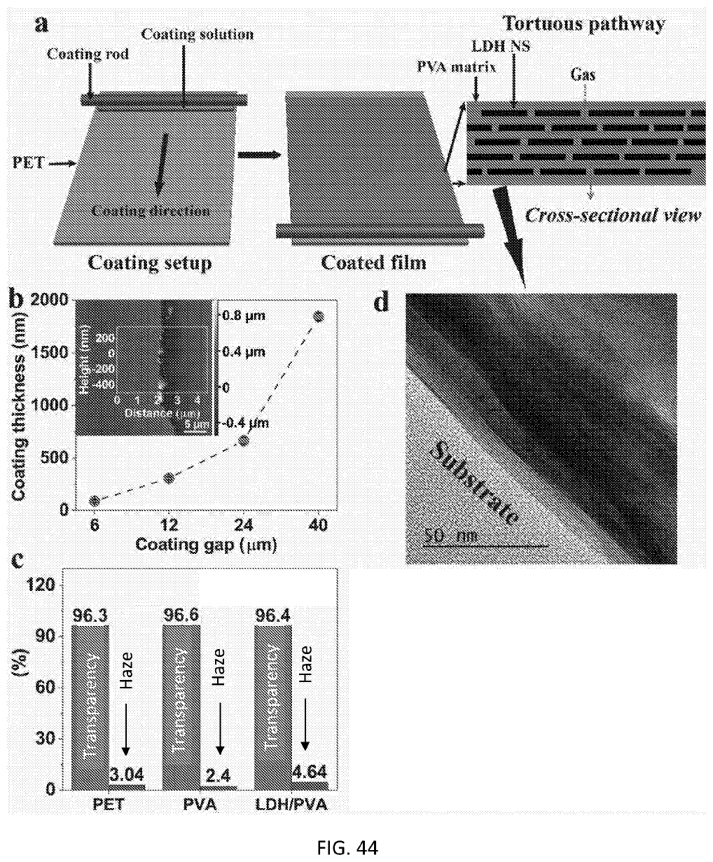

FIG. 43 shows digital images of LDH NS dispersion in water (a) and stable LDH/PVA coating solution (b).

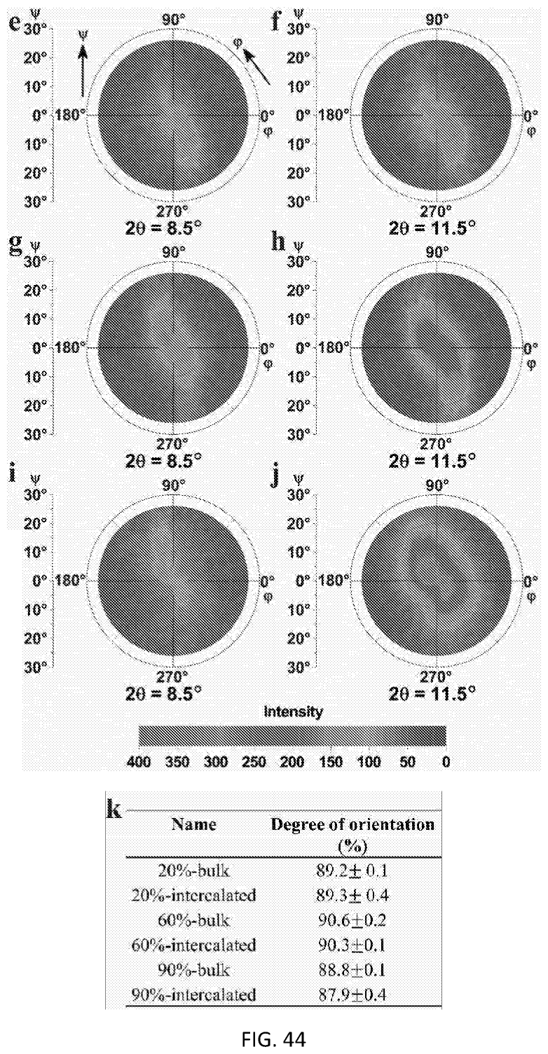

FIG. 44 shows the structure of LDHs barrier films. (a), Schematic of coating process and tortuous pathway. (b), Coating layer thickness plotted as a function of coating gap (inset shows the coating layer thickness of film coated with 24 μm coating gap measured by AFM). (c), Transparency and haze of the barrier films. (d), Cross-sectional TEM image of the barrier film containing 60% LDH showing ordered structure where LDH NS are aligned parallel to each other. Pole figure measurements of intercalation phase and bulk phase in the barrier films containing 20% (e and f), 60% (g and h) and 90% LDHs (i and j) in the coating layer. (k), Summary of degree of orientation of LDH NS calculated by equation (3). The total solid content of all the coating solutions are 5 wt % for all the coated film samples discussed in this figure.

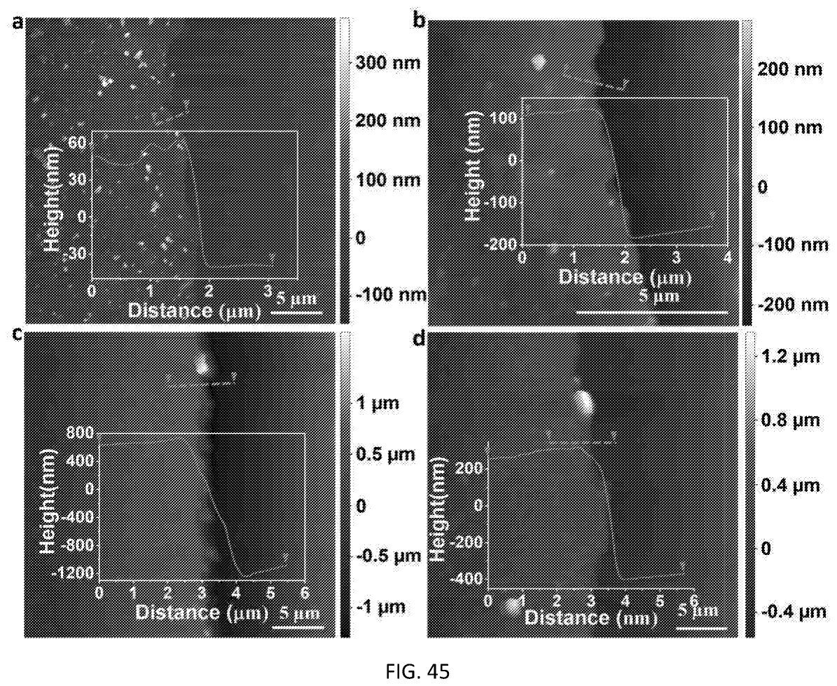

FIG. 45 shows the thickness of coating layers measured by AFM. Coating layer thickness of film coated with 6 (a), 12 (b), and 40 μm (c) coating gap and films coated twice with 12 μm (d) coating gap which is very close to the thickness of film coated with 24 μm coating gap (Coating solution is 5 wt %-60% LDH).

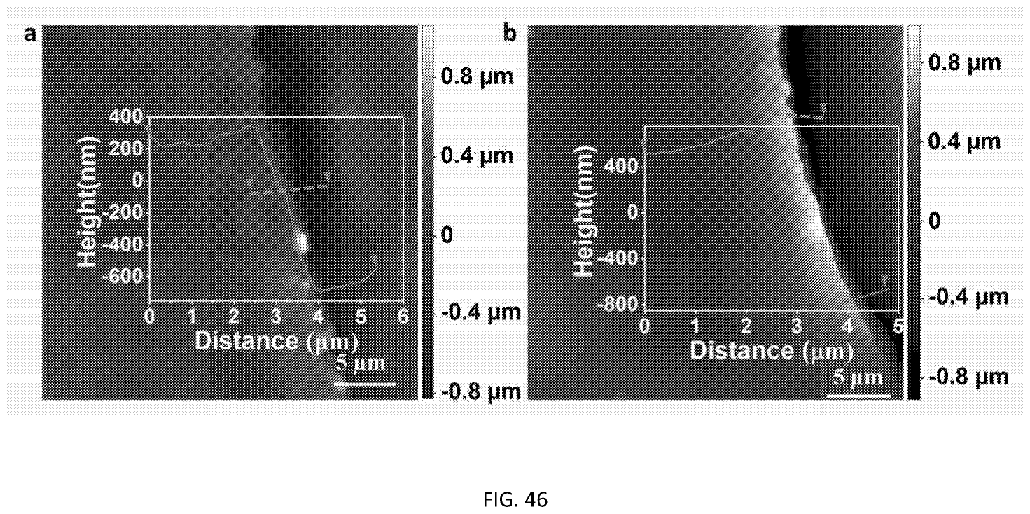

FIG. 46 shows the thickness of coating layers measured by AFM. Coating layer thickness of film coated with 80% LDH in 5 wt % total solid content solution (a) and with 60% LDH in 10 wt % total solid content solution (b). The coating gap of the rod is 24 μm.

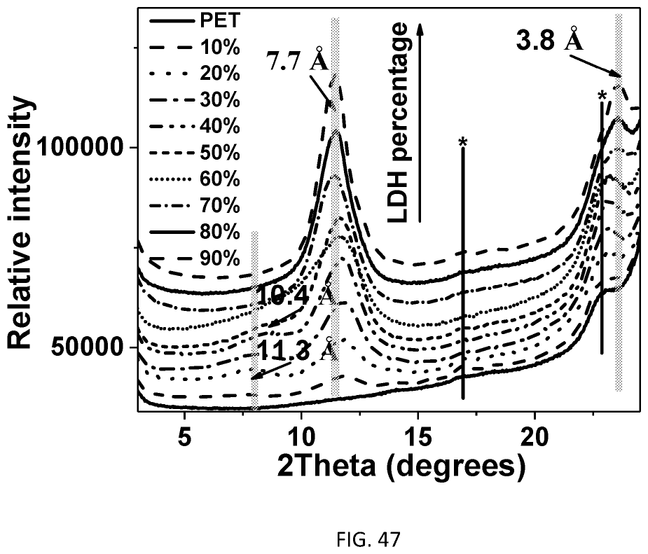

FIG. 47 shows XRD measurements of barrier films containing 10-90% LDH in the coating layer (* indicates diffractions from PET substrates).

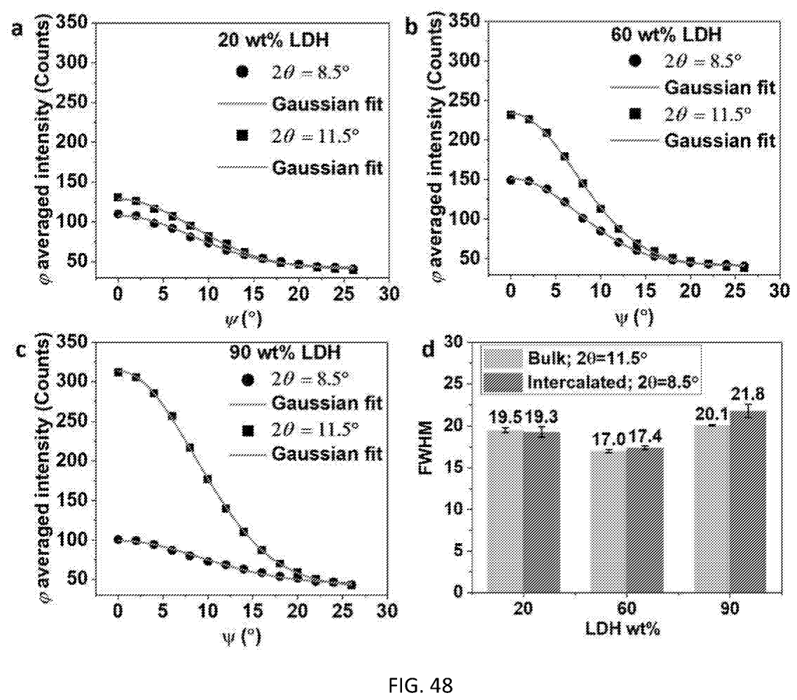

FIG. 48 shows the orientation of LDH NS in barrier films. The φ averaged intensity plotted against the ψ angle for coating film containing 20 wt % (a), 60 wt % (b) and 90 wt % LDH (c). Data measured at a 26 of 8.5° are marked by the black circles and fitted with a Gaussian coloured red and data measured at a 2θ of 11.5° are marked by black squares and fitted with a blue Gaussian. d, FWHMs in degrees plotted against LDH wt % in coating layer.

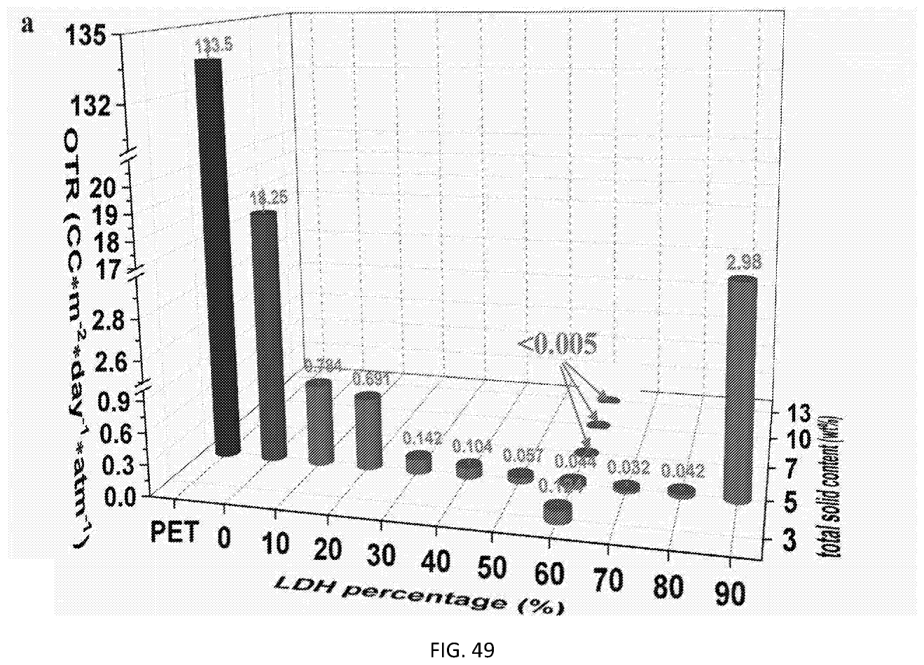

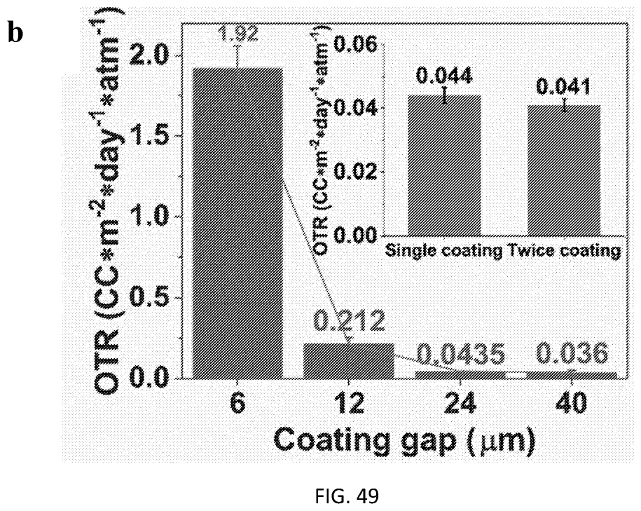

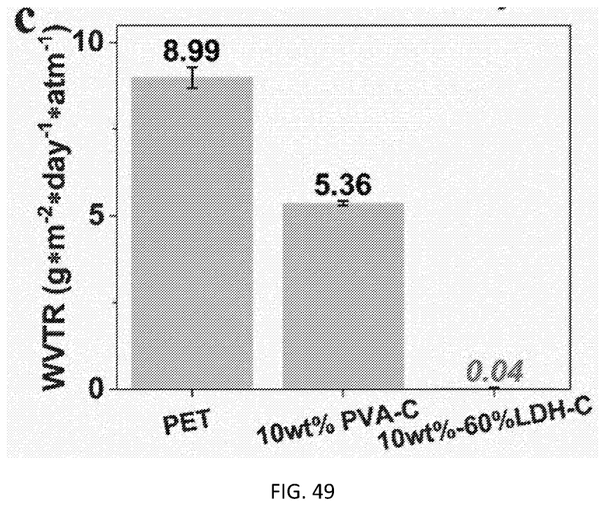

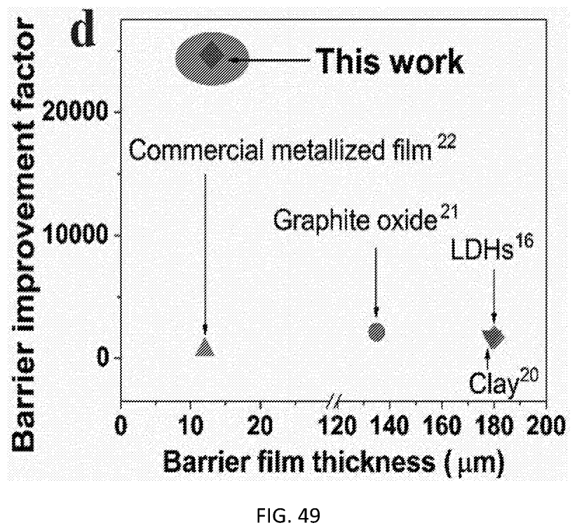

FIG. 49 shows the gas barrier properties of coated films. (a), OTR plot against LDHs % in the coating layer and total solid content of the coating solutions. (b), OTR plot against coating gap and the inset shows that the OTR values are very similar by coating a substrate with the same coating layer thickness (a single and double coating process). (c), WVTR of the crosslinked barrier film at 10 wt % total solid content (C indicates that PVA is crosslinked). (d), Barrier improvement factor plot against barrier film thickness: Comparison of this work and other works with LDH⁹, clay¹⁴, and graphite oxide¹⁶ as filler and commercial metallized film¹⁷.

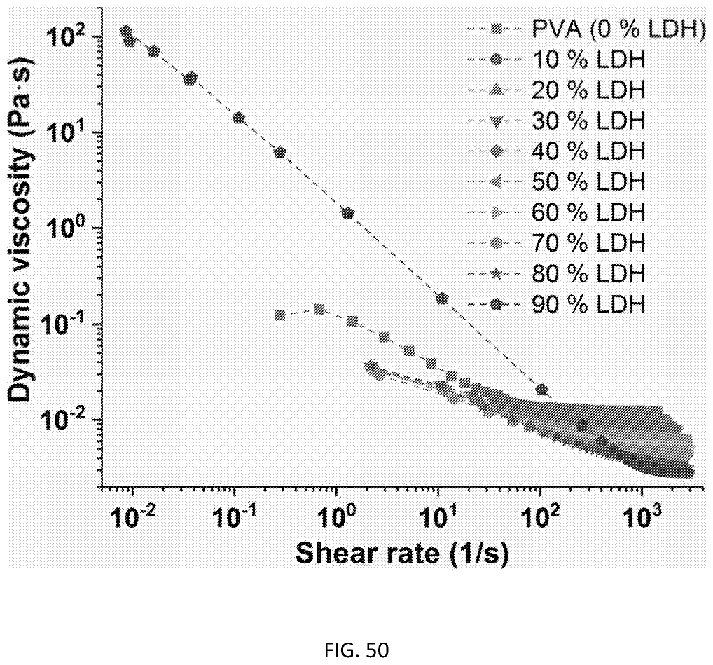

FIG. 50 shows that dynamic viscosity of the coating solution with LDH percentage varied from 10 to 90% compared with control PVA solution which, unlike the rest of the samples, the 90% LDH sample showed significant shear thinning effect (the total solid content of each sample is 5 wt %).

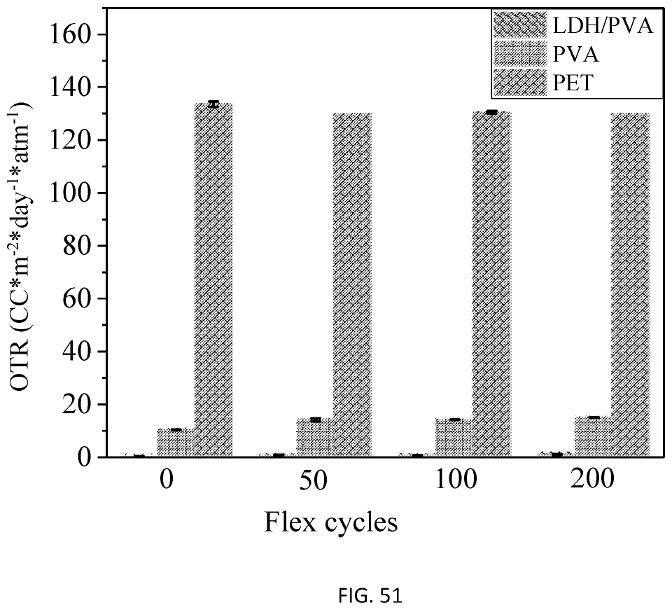

FIG. 51 shows OTR properties of films before and after 50, 100, and 200 flexes.

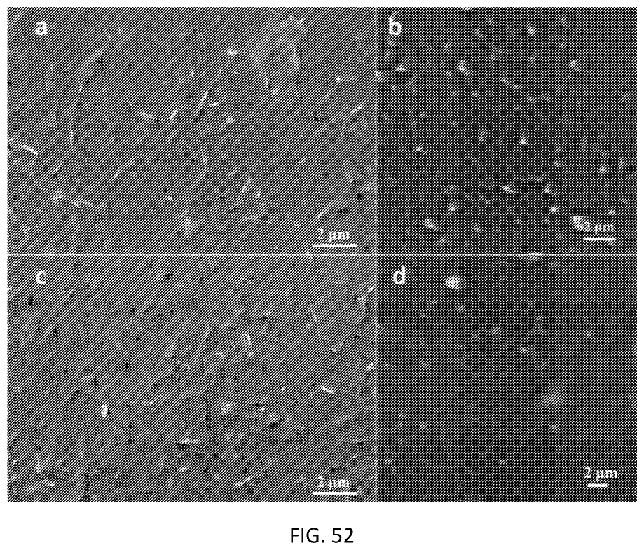

FIG. 52 shows SEM and AFM images of film surface before (a and b) and after 200 flex (c and d) showing smooth surface.

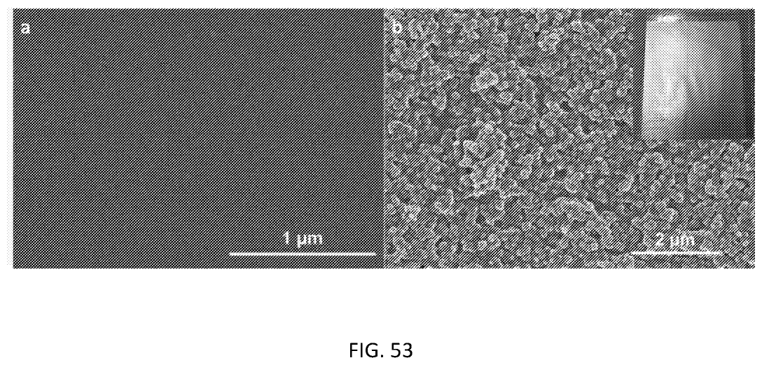

FIG. 53 shows SEM images of film surface coated with PVA (a) and original LDH/PVA (b) showing rough surface compared to the reconstructed LDH coated films (b inset shows that the film is opaque).

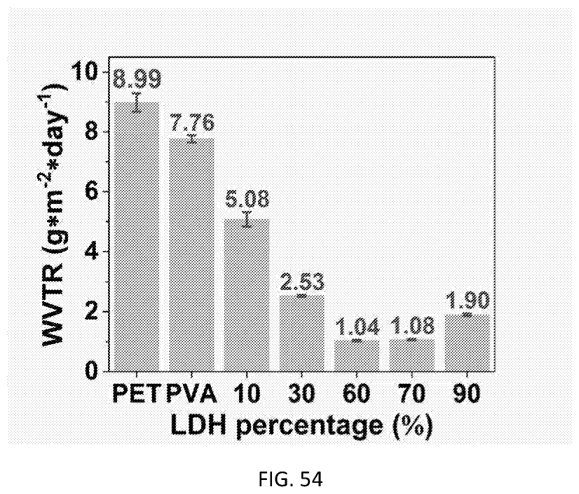

FIG. 54 shows WVTR plot against LDH weight percentage in the coating layer. All the coating solution used to prepare the coated films has a total solid content of 5 wt %, same as the films in FIG. 44.

### PART A

### Example 1—Formation of Coating Mixtures

### Procedure 1

Scheme 1 below is a flow diagram illustrating the various steps involved in the formation of the coating mixtures of the invention according to Procedure 1.

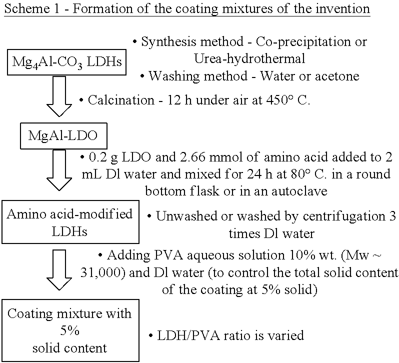

### Procedure 2

FIG. 1 is a flow diagram illustrating the various steps involved in the formation of the coating mixtures of the invention according to Procedure 2.

### Example 1a—Preparation of Precursor LDHs

The precursor Mg₃Al—CO₃ LDHs used in the preparation of coated substrates were prepared either by a co-precipitation (Cop) technique (to yield flower-like LDHs) or a urea-hydrothermal (UHT) technique (to yield platelet-like LDHs). The general synthetic approach for each technique is outlined below.

General co-precipitation technique: Aqueous solution (50 mL) of 0.80 M Mg(NO₃)₂.6H₂O and 0.20 M of Al(NO₃)₃.9H₂O was added drop-wise into the 50 mL of 0.5 M Na₂CO₃ solution with stirring and the pH was controlled at 10 using 4.0 M NaOH solution. After stirring at room temperature for 24 hours, the product was filtered and washed with DI water until the pH was close to 7.

General urea-hydrothermal technique: An aqueous solution (100 mL) of 0.40 M Mg(NO₃)₂.6H₂O, 0.10 M of Al(NO₃)₃.9H₂O, and 0.80 M urea was prepared. The mixed solution were transferred to a Teflon-lined autoclave and heated in an oven at the 100° C. for 24 hours. After the reactions were cooled to room temperature, the precipitate products were washed several times with deionised water by filtration.

Prior to drying, the as-prepared LDHs were subjected to one of two washing techniques. LDHs denoted “water” or “W” were washed with DI water and then subsequently dried. LDHs denoted “AMO” or “A” were washed with acetone (an Aqueous Miscible Organic solvent) and then subsequently dried.

FIG. 2 shows TEM images of (a) Mg₄Al—CO₃-AMO LDH from co-precipitation (Cop-AMO LDH) and (b) Mg₄Al—CO₃-AMO LDH from urea-hydrothermal method (UHT-AMO LDH). The difference in morphology (flower vs platelet) arising from the different preparation techniques is readily apparent.

FIG. 2(c) depicts a commercial 7 μm diameter Mg₄Al—CO₃ LDH obtained from SCG Chemicals, which was used as received. FIG. 20 shows the BET (N₂) traces for the LDH depicted in FIG. 2(c) as well as the same LDH thermally treated at 450 and 550° C., affording LDO. The 7 μm LDH has a surface area of 4 m²/g and the LDO of 130 and 202 m²/g for temperature of calcination at 450 and 550° C. respectively.

### Example 1b—Formation of LDOs and Amino Acid-Modified LDHs

LDHs prepared in Example 1a were then calcined in air at 450° C. (Procedure 1) or 550° C. (Procedure 2) for 12 hours to yield the corresponding LDOs. The LDOs were then used in the preparation of various amino acid-modified LDHs.

The amino acid-modified LDHs were prepared by mixing quantities of the LDO and an amino acid in DI water at 80° C. (in a round bottom flask or an autoclave, Procedure 1) or at 100° C. (in an autoclave, Procedure 2). Contacting the LDO with the amino acid and DI water resulted in reconstruction of the LDH structure. Without wishing to be bound by theory, it is believed that the presence of an amino acid during this reconstruction step resulting in LDH platelets having improved morphology (e.g. aspect ratio, uniformity, etc).

Some of the resulting amino acid-modified LDHs (i.e. reconstructed LDHs) were then subjected to washing by centrifugation in DI water.

The terms “amino acid-modified LDH” and “reconstructed LDH” are synonymously used herein. The term “RC” may be used to denote a reconstructed LDH.

FIG. 3(a) shows the XRD patterns of a commercial 7 μm diameter Mg₄Al—CO₃ LDH obtained from SCG Chemicals thermally treated at 450 and 550° C. affording LDO. FIG. 3(b) shows XRD patterns of various coprecipitated (“Cop”) precursor LDHs, as well as various LDHs that have been reconstructed (“RC”) using various different amino acids in a round bottom flask according to Procedure 1.

FIG. 4 shows XRD patterns of LDHs reconstructed with glycine for various period of time following Procedure 2.

FIG. 5 shows FTIR spectra of coprecipitated LDHs reconstructed with various different amino acids in a round bottom flask following Procedure 1. FIG. 6 is an FTIR spectrum of a coprecipitated LDH reconstructed with glycine for 24 hours following Procedure 2, which clearly shows signals at −1540 cm⁻¹ and −1400 cm⁻¹ indicating the presence of glycine within the LDH structure.

FIG. 7 shows TEM images of coprecipitated AMO-LDHs reconstructed with various different amino acids in a round bottom flask or in an autoclave at 80° C. following Procedure 1.

FIG. 8 shows TEM images of urea-hydrothermal AMO-LDHs reconstructed with various different amino acids in a round bottom flask or in an autoclave at 80° C. following Procedure 1.

FIG. 9 shows TEM images of an LDH reconstructed with glycine following Procedure 2 using the precursor LDH depicted in FIG. 2(c).

FIG. 10 is an Atomic Force Microscopy image an LDH reconstructed with glycine following Procedure 2, indicating that the thickness of the platelets ranges from 0.8 to 2.2 nm.

FIG. 21 shows the variation on aspect ratio, thickness and diameter over reconstruction time for two different thermal treatment temperatures using the precursor LDH depicted in FIG. 2(c) that has been modified with glycine according to Procedure 2. It shows that the aspect ratio increases with increasing time of reconstruction.

### Example 1c—Preparation of Coating Mixtures

As depicted in Scheme 1 and FIG. 1, the amino acid-modified LDHs prepared in Example 1b were mixed with an aqueous solution of poly(vinyl alcohol) to yield a coating mixture of 5 wt % solids. The ratio of amino acid-modified LDH to poly(vinyl alcohol) within the coating mixture was 70:30, 50:50 or 40:60.

### Example 2—Formation of Coated Substrates

The various coating mixtures prepared in Example 1c were coated onto a PET substrate using an automated coater (K101 Control Coater). The coated substrates were then dried at room temperature for 5-30 minutes.

FIG. 11 is a cross-sectional TEM image of a PET substrate coated with a coating mixture containing an LDH reconstructed with glycine following Procedure 2. FIG. 11 shows that the amino acid-modified platelets present in the coating mixture are well aligned with the substrate onto which they have been coated.

The OTR properties of the coated and uncoated substrates were assessed. As a control, the OTR properties of an uncoated PET substrate were assessed, as were a PET substrate that had been coated with i) PVA, and ii) PVA+β-aminobutyric acid. The results are shown in FIG. 12.

FIG. 13 demonstrates the OTR properties of various coated and uncoated PET substrates. The results show that PET substrates that have been coated with a coating mixture comprising β-aminobutyric acid-modified LDH (i.e. LDH reconstructed (“RC”) with β-aminobutyric acid) gave substantially lower OTR values.

FIG. 14 demonstrates the OTR properties of various coated and uncoated PET substrates. The results show that PET substrates that have been coated with a coating mixture comprising β-aminobutyric acid-modified LDH (i.e. LDH reconstructed (“RC”) with s-aminobutyric acid) gave substantially lower OTR values. Particularly good results were observed in respect of samples that had been double coated with a coating mixture comprising β-aminobutyric acid-modified LDH that was derived from coprecipitated precursor LDHs, and which had been modified with the amino acid in a round bottom flask (i.e. at 80° C.).

FIG. 15 demonstrates the OTR properties of various coated and uncoated PET substrates. The results show that washing the amino acid-modified LDH with DI water prior to formation of the coating mixture leads to a decrease in OTR.

FIG. 16 demonstrates the OTR properties of various coated and uncoated PET substrates. The results show that reduced OTR (when compared with uncoated substrates and non-LDH containing coated substrates) was observed using coating mixtures containing LDHs modified with glycine, β-alanine, β-aminobutyric acid and β-leucine.

Table 1 below compares the OTR properties of an uncoated PET substrate, with those of a PET substrate coated solely with PVA and a PET substrate coated with a PVA coating mixture containing 3 wt % of a glycine-modified LDH. The glycine-modified LDH was prepared from the precursor LDH depicted in FIG. 2(c).

TABLE 1
OTR properties of uncoated, PVA-coated and PVA/glycine-modified
LDH-coated PET substrates

| | Total | | | | |
|---|---|---|---|---|---|
| | solid | | | | |
| | content | LDH | Average | | |
| Samples | (wt %) | (wt %) | OTR^{a} | OTR^{a} | OTR^{a} |
| 12 μm PET | 0 | 0 | 133.5 | 134.5 | 132.5 |
| 10 wt % PVA | 10 | 0 | 10.5 | 10.5 | 10.4 |
| | | | 22.6 | 23.0 | 22.2 |
| 5 wt %-3 wt % LDH- | 5 | 3 | 0.36 | 0.27 | 0.45 |
| 2 wt % PVA | | | | | |

^{a}CC m⁻² day⁻¹ atm⁻¹

The results shown in Table 1 illustrate that the inclusion of glycine-modified LDH within the coating mixture gives rise to a significant decrease in OTR properties.

The optical properties of the coated and uncoated substrates were also assessed.

The transmittance of the coated and uncoated substrates was assessed by a haze meter (The haze-gard I, BYK-Gardner GmbH Inc) according to ASTM D 1003. It is the ratio of transmitted light to the incident light, which is influenced by the absorption and reflection properties of the materials. The specimen is placed at the film holder at the entrance port of the haze meter in order to measure the transmittance. Average of ten measurements is reported in units of percent.

The haze of the coated and uncoated substrates was assessed by a haze meter (The haze-gard I, BYK-Gardner GmbH Inc) according to ASTM D 1003. It is the percent of transmitted light which in passing through deviates from the incident beam greater than 2.5 degrees in the average. The specimen is placed at the film holder at the entrance port of the haze meter in order to measure the haze. Average of ten measurements is reported in units of percent.

The clarity of the coated and uncoated substrates was assessed by a haze meter (The haze-gard I, BYK-Gardner GmbH Inc). This measurement describes how well very fine details can be seen through the specimen. It needs to be determined in an angle range smaller than 2.5 degrees. The specimen is placed at the film holder at the entrance port of the haze meter in order to measure the clarity. Average of ten measurements is reported in units of percent.

FIGS. 17, 18 and 19 demonstrate the optical properties of various uncoated and coated substrates. The results show that, when compared with uncoated PET substrates and non-LDH containing coated PET substrates, the coated substrates of the invention exhibited comparable—and in some cases better—optical properties.

### PART B

### Example 3—Extended Characterisation of Amino Acid-Modified LDHs

Further characterisation of amino acid-modified LDHs prepared according to Procedure 1 (Example 1) was conducted. In Example 3:

Cop-W denotes a precursor LDH prepared by co-precipitation technique and then washed with water
Cop-AMO denotes a precursor LDH prepared by co-precipitation technique and then washed with acetone
UHT denotes a precursor LDH prepared by urea hydrothermal synthesis
HT denotes an LDH that has been reconstructed from an LDO under hydrothermal conditions in an autoclave
RC denotes an LDH that has been reconstructed from an LDO by heating in a round bottom flask.

### Example 3a—Use of Nonpolar Amino Acids and Coprecipitated LDHs (“Cop-AMO LDH”)

Fourier transform infrared (FTIR) spectra of obtained products after reconstruction of calcined Cop-AMO LDHs in different nonpolar amino acids in the closed hydrothermal reaction are shown in FIG. 22. The characteristic bands of amino acid are present in FTIR spectra which suggests the presence of amino acid molecules in the product. The carbonate band at 1370 cm⁻¹ was observed in all reconstruction LDHs indicating the co-intercalated carbonate ion in the samples.

Powder X-ray diffraction (XRD) data of the LDH products obtained from LDH reconstruction are shown in FIG. 23. All LDHs appear to be phase pure by XRD, except for the ones that are reconstructed with β-leucine and β-phenylalanine due to low water solubility of these amino acids making them difficult to remove by washing process. No expansion of the interlayer spacing was observed in most amino acids reconstructed LDHs. Those molecules may horizontally align parallel to the LDH layers, resulting in no expansion of the interlayer. On the other hand, enlargement of the interlayer spacing was observed in products reconstructed with β-leucine and β-phenylalanine. The larger interlayer expansion might be due to the bilayer arrangement of the amino acids in the interlayer region as well as the larger molecular size. The reaction under hydrothermal conditions may favour the introduction of this hydrophobic amino acid into the LDH interlayer regions which enlarges the basal spacing expanding to 15.43 Å. The thickness of smaller amino acids such as glycine and alanine is comparable to that of carbonate and nitrate. Those molecules may horizontally align parallel to the LDH layers, resulting in no expansion of the interlayer. d-spacing values of obtained products are summarised in Table 2.

TABLE 2
Summary of d-spacing of reconstructed LDHs using different
nonpolar amino acids. ‘RC’ and ‘HT’ were denoted as product
from round bottom flask heated and hydrothermal conditions in
an autoclave, respectively, according to Procedure 1.

| Sample | | d-spacing (Å) |
|---|---|---|
| Cop-AMO LDHs | | 7.93 |
| RC | Glycine | 7.78 |
| | β-Alanine | 7.8 |
| | β-Aminobutyric acid | 7.83 |
| | γ-Aminobutyric acid | 7.8 |
| | β-Leucine | 7.83, 12.05, 13.41 |
| | β-Phenylalanine | 7.9 |
| HT | Glycine | 7.71 |
| | β-Alanine | 7.76 |
| | β-Aminobutyric acid | 7.82 |
| | γ-Aminobutyric acid | 7.83 |
| | β-Leucine | 7.76, 12.02 |
| | β-Phenylalanine | 7.79, 13.91, 15.43 |

TEM was used to determine the particle sizes and size distribution. TEM images and particle size distribution curves of LDHs are shown in FIG. 24 and summarised in Table 3.

TABLE 3
Summary of average particle size of reconstructed LDHs using different
nonpolar amino acids. ‘RC’ and ‘HT’ were denoted as product from
round bottom flask heated and hydrothermal conditions in an autoclave,
respectively, according to Procedure 1. The TEM images were used to
determine the mean values and standard deviation by measurement
of 300 particles.

| Sample | | Particle size |
|---|---|---|
| Cop-AMO LDHs | | 1131 ± 504 nm* |
| RC | Glycine | 42 ± 12 nm |
| | β-Alanine | 55 ± 10 nm |
| | β-Aminobutyric acid | 55 ± 13 nm |
| | γ-Aminobutyric acid | 52 ± 15 nm |
| | β-Leucine | 61 ± 16 nm |
| | β-Pheny1alanine | 181 ± 78 nm |
| HT | β-Alanine | 62 ± 17 nm |
| | β-Aminobutyric acid | 76 ± 29 nm |
| | γ-Aminobutyric acid | 63 ± 15 nm |
| | β-Leucine | 47 ± 12 nm |
| | β-Phenylalanine | 61 ± 25 nm, 0.5-1 μm |

*measured from the secondary particles of LDHs.

The average particle sizes decreased drastically to 40-60 nm after reconstruction and formed uniform LDH platelets, indicating original structure was not retained. However, it is difficult to find a direct relationship between the chain length of the amino acids and the particle size of the final reconstructed LDHs. It is believed that hydrogen bonding should play a role in directing morphology transformation of the LDHs.

FIG. 25 shows Zeta potential of reconstructed LDHs by different amino acids by round bottom flask heating (RC) according to Procedure 1. Zeta potential is significantly increased to 32-40 mV after reconstruction with amino acids, suggesting a stable colloid dispersion in water.

Thermal properties of Cop-AMO LDH, LDOs and reconstructed LDHs by different amino acids were determined by thermogravimetric analysis (TGA) and the differential thermogravimetric curves (DTG), as shown in FIGS. 26 and 27. For amino acid reconstructed LDHs, the total mass loss increased with increasing molecular weight of the amino acid, 50 to 60 wt % for glycine and phenylalanine, respectively. Three steps of a major weight losses were observed for all amino acid reconstructed LDHs as shown in the differential thermogravimetric curves (DTG). The first step occurs below 200° C. due to the removal of adsorbed water and interlayer water. The second step, corresponding to the dehydroxylation of LDH layers and the decomposition of the intercalated amino acids, occurs between 250-400° C. The last step corresponds to the combustion of the intercalated amino acids and formation of a carbonaceous residue produced from the decomposition of the amino acid.

The amino acid content in all reconstructed products was determined by elemental analysis (EA), the results are summarised in Table 4.

TABLE 4
Elemental analysis (EA) and TGA studies.

| | | % C | % H | % Mass | % Mass |
|---|---|---|---|---|---|
| | | apart | apart | different | different |
| | % | from | from | from | from |
| | Amino | amino | amino | ‘original | ‘controlled |
| Sample | acid* | acid* | acid* | LDH’** | sample’** |
| Cop-AMO LDH | — | 3.50 | 4.35 | — | −4.50 |
| Cop-W LDH | — | 2.01 | 3.54 | 0.61 | −3.89 |
| Cop-LDO in water | — | 1.46 | 4.29 | 4.50 | — |
| Cop-RC-Glycine | 16.67 | 0.06 | 2.33 | −2.24 | −6.74 |
| Cop-RC-β-Alanine | 27.56 | 0.53 | 4.43 | −3.97 | −8.47 |
| Cop-RC-β- | 22.46 | 0.00 | 2.81 | −6.73 | −11.23 |
| Aminobutyric acid | | | | | |
| Cop-RC-β-Leucine | 32.43 | 0.01 | 2.99 | −12.54 | −17.04 |
| Cop-RC-β- | 38.82 | 3.98 | 2.28 | −13.10 | −17.60 |
| Phenylalanine | | | | | |

*calculated on the basis of Elemental analysis results and ** from TGA results.

Amino acid content in the LDH was assumed to be the sole source of nitrogen in the samples. In addition, it was also used to determine the carbon and hydrogen content which do not originate from the amino acid. These carbon and hydrogen contents indicate the amount of carbonate and hydroxide intercalated anions and structural water molecules in the reconstructed LDHs.

Table 5 and 6 present the raw data for ICP results and formula of LDHs before and after reconstruction.

TABLE 5
ICP results of LDHs before and after reconstruction.

| | % Weight from | | | | | | Total | % Mole | | |
|---|---|---|---|---|---|---|---|---|---|---|
| | ICP results | | | | % Mole | | mole | fraction | | |
| | Mg | | Al | | Mg | Al | fraction | in total | | Mg/Al |
| Sample | (avg.) | sd | (avg.) | sd | % | % | Mg + Al | Mg | Al | ratio |
| Cop-AMO | 20.95 | 0.21 | 5.73 | 0.10 | 0.86 | 0.21 | 1.07 | 0.80 | 0.20 | 4.06 |
| LDH | | | | | | | | | | |
| Cop-LDO in | 27.50 | 0.25 | 8.01 | 0.16 | 1.13 | 0.30 | 1.43 | 0.79 | 0.21 | 3.81 |
| water | | | | | | | | | | |
| Cop-RC- | 22.22 | 0.24 | 7.29 | 0.13 | 0.91 | 0.27 | 1.18 | 0.77 | 0.23 | 3.38 |
| Glycine | | | | | | | | | | |
| Cop-RC-β- | 23.16 | 0.19 | 7.13 | 0.10 | 0.95 | 0.26 | 1.22 | 0.78 | 0.22 | 3.60 |
| Alanine | | | | | | | | | | |
| Cop-RC-β- | 22.86 | 0.06 | 7.03 | 0.04 | 0.94 | 0.26 | 1.20 | 0.78 | 0.22 | 3.61 |
| Aminobutyric | | | | | | | | | | |
| acid | | | | | | | | | | |
| Cop-RC-β- | 19.81 | 0.06 | 6.39 | 0.07 | 0.82 | 0.24 | 1.05 | 0.77 | 0.23 | 3.44 |
| Leucine | | | | | | | | | | |
| Cop-RC-β- | 17.56 | 0.10 | 6.87 | 0.07 | 0.72 | 0.25 | 0.98 | 0.74 | 0.26 | 2.84 |
| Phenylalanine | | | | | | | | | | |

TABLE 6
Compositional formula of LDHs before and after reconstruction.

| Sample | Formula of LDHs |
|---|---|
| Cop-AMO LDH | [Mg_{0.80}Al_{0.20}(OH)₂(CO₃)_{0.10}]•0.245H₂O•0.215(Ethanol) |
| Cop-W LDH | [Mg_{0.80}Al_{0.20}(OH)₂(CO₃)_{0.10}]•0.634H₂O |
| Cop-LDO in water | [Mg_{0.79}Al_{0.21}(OH)₂(HCO₃)_{0.031}(CO₃)_{0.095}]•1.194H₂O |
| Cop-RC-Glycine | [Mg_{0.77}Al_{0.23}(OH)₂(HCO₃)_{0.031}(CO₃)_{0.100}]•0.053H₂O•0.111(Glycine) |
| Cop-RC-β-Alanine | [Mg_{0.78}Al_{0.22}(OH)₂(HCO₃)_{0.031}(CO₃)_{0.095}]•2.212H₂O•0.420(β-Alanine) |
| Cop-RC-β- | [Mg_{0.78}Al_{0.22}(OH)₂(HCO₃)_{0.031}(CO₃)_{0.095}]•2.465H₂O•0.206 |
| Aminobutyric acid | (β-Aminobutyric acid) |
| Cop-RC-β-Leucine | [Mg_{0.77}Al_{0.23}(OH)₂(HCO₃)_{0.031}(CO_{3)0.100}]•0.033H₂O•0.195(β-Leucine) |
| Cop-RC-β- | [Mg_{0.74}Al_{0.26}(OH)₂(HCO₃)_{0.031}(CO₃)_{0.115}]•0.281H₂O•0.308 |
| Phenylalanine | (β-Phenylalanine) |

XRD patterns of reconstruction products prepared from urea hydrothermal treatment (UHT) precursor LDHs according to Procedure 1 are presented in FIG. 28 and d-spacing values are summarised in Table 7. No layer spacing expansion was obtained using small size amino acids. An increase of the basal spacing was observed in products produced from leucine (12 Å) but it was not found in the case of phenylalanine. This is probably due to several factors such as: the large particle size of the original LDHs, the contact area and accessibility of the amino acid. In addition, the hydrophobicity of the phenylalanine may suppress the interaction with the LDH surface.

TEM images and particle size distributions are shown in FIG. 29 and Table 7 for all samples. The obtained products from the UHT-AMO LDH produce a mixture of small and large particles particularly in air, the large platelets were almost all transformed into small particles under hydrothermal conditions. Normally hydrothermal conditions favour larger particle size formation of LDHs.

TABLE 7
Summary of d-spacing and average particle size of reconstructed LDHs using different
nonpolar amino acids. ‘RC’ and ‘HT’ were denoted as product from round bottom flask heated
and hydrothermal conditions in an autoclave, respectively, according to Procedure 1. The TEM
images were used to determine the mean values and standard deviation by measurement of
300 particles. Bragg reflections of excess amino acids in samples were excluded in this table.

| Sample | | d-spacing (Å) | Particle size |
|---|---|---|---|
| UHT-AMO LDHs | | 7.62 | 3-4 μm |
| RC | Glycine | 7.58 | 87 ± 22 nm, 3 ± 1 μm |
| | β-Alanine | 7.36 | 132 ± 40 nm, 3 ± 1 μm |
| | β-Aminobutyric acid | 7.61 | 105 ± 32 nm, 3 ± 1 μm |
| | γ-Aminobutyric acid | 7.51 | 101 ± 41 nm |
| | β-Leucine | 7.65, 12.08 | 131 ± 42 nm, 3 ± 1 μm |
| | β-Phenylalanine | 8.12 | 352 ± 176 nm, 3 ± 1 μm |
| HT | Glycine | 7.52 | 109 ± 25 nm, 3 ± 1 μm |
| | β-Alanine | 7.6 | 135 ± 41nm |
| | β-Aminobutyric acid | 7.63 | 89 ± 28 nm |
| | γ-Aminobutyric acid | 7.56 | 100 ± 37 nm |
| | β-Leucine | 7.55, 11.99 | 135 ± 31 nm, 3 ± 1 μm |
| | β-Phenylalanine | 8.08 | 125 ± 88 nm |

The characteristic bands for phenylalanine (as well as the other amino acids) are present in FTIR spectra shown in FIG. 30. The spectra suggest the presence of amino acid molecules in the product. The carbonate band at 1370 cm⁻¹ was observed in all reconstruction LDHs indicating the co-intercalated carbonate ion in the samples.

### Example 3c—Use of Polar Amino Acids

FIG. 31 shows XRD data and FTIR spectra of the reconstructed LDHs using polar side-chain amino acids by round bottom flask heating according to Procedure 1. Their interlayer distances are summarised in Table 8, the intercalation occurred with no expansion of the interlayer spacing, peak shift from the original parent LDH was observed in all cases.

TABLE 8
Summary of d-spacing and average particle size of reconstructed
LDHs using polar amino acids. The TEM images were used to
determine the mean values and standard deviations by
measurement of 300 particles.

| | d-spacing | Particle size |
|---|---|---|
| Sample | (Å) | (nm) |
| Aspartic acid | 7.60 | 46 ± 13 |
| Glutamic acid | 7.60 | 59 ± 25 |
| Asparagine | 7.74 | 63 ± 27 |
| Serine | 7.74 | 25 ± 5 |

FIG. 32 displays the TEM images of the reconstruction products by round bottom flask heating according to Procedure 1, their size distribution is summarised in Table 8. Well-dispersed LDH hexagonal platelets (with lateral size <100 nm) were formed after reconstruction with asparagine (63 nm), serine (25 nm), glutamic acid (59 nm) and aspartic acid (46 nm). In the case of aspartic acid, a flower like shape was observed. The formation of this morphology is still unclear.

### Example 4—Coating Applications

A variety of PVA-based coating mixtures were prepared according to the procedure outlined in Scheme 1 and were then coated onto PET films according to the procedure described in Example 2.

FIG. 33 presents the optical properties and film thickness of coated films. All samples show similar film transparency, clarity and haze values as the PET substrate, except in the coated film containing phenylalanine reconstructed LDHs. The present of large particles from TEM images of this sample leads to increases of light scattering and a broad particle size distribution, reduces film transparency and clarity values and considerably increase haze value of the coated film. No difference in the thickness of the coated and uncoated films could be measured using a micrometer.

### PART C

### Example 5—Use of Glycine-Modified LDHs in Coating Applications

### Materials and Methods

Materials. The MgAl—CO₃²⁻-LDH (Mg:Al 2:1 ratio) is commercially available LDHs (Alcamizer 1) and was used as purchased from Kisuma Chemicals, Netherlands. Polyvinyl alcohol (PVA) 8-88 (MW: 67,000), Poval 56-98 PVA (MW: 195,000), glycine (≥98%), and sodium hydroxide pellets (≥98%) were purchased from Sigma Aldrich. Polyethylene terephthalate (PET) film (12 μm thick) was sent from SCG chemicals.

Calcination of LDHs. LDH was calcined at 450° C. for 12 hr at a heating rate of 5° C./min. The calcined LDO was taken out of furnace at ca. 80° C. and stored in a desiccator to avoid slow rehydration in air.

Reconstruction of LDOs in amino acid solution. Typically, glycine was mixed with 0.1 g calcined LDO at 1.5:1 weight ratio in 1 mL water and the mixture was placed in an autoclave and reacted at 100° C. for 48 hr to obtain a semi-transparent gel. The obtained gel was then dispersed and stirred in water (usually 100 mL) overnight. The dispersion is very stable and thus LDH NS can be difficult to collect by centrifuge. Thus, to improve the yield, LDHs suspension is intentionally precipitated by adding NaOH solutions. The LDHs was then collected by centrifuge at 35954 g force for 10 minutes and washed with D.I. water for three times. After centrifuge, the collected LDH gel was partially dried at 100° C. in oven for 2 hours to determine the solid content (the average solid content of three measurements was used in all cases).

Reconstruction of LDOs in water. The LDOs were reconstructed under the same conditions as in amino acid solution, except without adding amino acid as a control experiment.

Coating solution preparation. PVA solution was prepared by dissolving PVA resin in water at ca. 90° C. under reflux for an hour. 10 wt % PVA stock solution was used to prepare coating solution. Reconstructed LDHs gel was mixed and stirred overnight with 10 wt % PVA solution and water to make coating solution with different total solid contents and LDHs loadings. The coating solutions typically contain 95 wt % water and 5 wt % solid where LDHs is 3 wt % and PVA is 2 wt %.

Coating process. PET substrate was coated with the coating solutions by a semiautomatic coater (K control coater, RK PrintCoat instruments Ltd, UK) at a coating speed equivalent to 9.8 m/min. After coating, the PET films are dried at room temperature for about 1 hr before testing.

Crosslinking of PVA for WVTR. PVA with molecular weight of 195,000 was only used to improve water vapor barrier of the coated film. Trisodium trimetaphosphate (TSMP) was used to crosslink PVA following a previous report¹. Typically, 5 g of 10 wt % PVA solution (Or LDH/PVA mixture) was mixed with 0.08 ml of 0.16 M TSMP and 0.03 ml of 2.5 M NaOH right before coating. After coating, the coated film was dried and cured at 100 C for 5 hours in oven.

OTR testing. The OTR of the barrier films were tested on M8001 oxygen permeation analyser (Systech Instruments, UK) at zero relative humidity. The instrument testing limit is 0.005 cc/m²/day. The testing complies with ASTM D-3985.

WVTR testing. The WVTR of the barrier films were tested on M7001 water vapour permeation analyser (Systech Instruments, UK) at 23° C. and 50% relative humidity. The testing complies with ASTM standard F-1249.

XRD measurements. The samples for XRD measurements of LDOs reconstructed in glycine were prepared by quench the reaction by liquid nitrogen after certain periods of time (from 1 minute to 48 hours) to rapidly cool down the temperature. After the reaction mixture temperature rose back to room temperature, the mixture was put into an aluminium holder and covered with Mylar® film (0.25 mil, XRF Window Film, Fisher Scientific) to avoid drying of the samples. The samples were scanned at a canning speed of 0.04°/min. The barrier films were taped on to an aluminium holder to make XRD measurements with the coated side facing the incident X-ray beam. All XRD measurements were recorded on Bruker D8 diffractometer (40 kV and 30 mA) with Cu Kα radiation (λ₁=1.544 Å and λ₂=1.541 Å).

Estimation of crystallite sizes. Scherrer equation is used to estimate the size of crystallites which correlates to the peak broadening in an X-ray diffraction pattern.

$$D = \frac{k}{β} \qquad ( 1 )$$

where D is the mean size of crystallites perpendicular to the diffraction plane; k is a dimensionless shape factor (usually is 0.89 for LDHs); λ is the wavelength of the X-ray (λ=0.15406 nm); β is the peak broadening at half maximum intensity (FWHM) after subtracting the instrument line broadening in radian; θ is the Bragg angle.

FT-IR measurements. IR spectra were recorded on a Varian FTS-7000 Fourier transform infrared spectrometer fitted with a DuraSamplIR Diamond ATR. The samples were prepared as described in XRD measurements and tested as it is.

TEM measurements of LDHs and cross-sectional TEM sample preparation. All TEM images were obtained on a JEOL JEM-2100 transmission electron microscope with an accelerating voltage of 200 kV. The coated PET films were first embedded into epoxy, and slices of ca. 80-100 nm thickness were cut on a Reichert-Jung Ultracut E ultramicrotome from the embedded epoxy sample. The slices were deposited on 75-mesh copper grids for imaging.

Viscosity measurements. Dynamic viscosity is measured on HR-2 discovery hybrid rheometer (TA instruments) using 60 mm aluminium cone plate with an angle of 1.010 and a truncation gap of 30 μm at 25° C.

SEM imaging. SEM images were taken on a Zeiss Merlin-EBSD scanning electron microscope with an operating voltage of 5 kV. The films were first coated with ca. 10 nm gold before imaging.

AFM measurements. The coating layer thickness and thickness of LDHs were measured by a NanoScope MultiMode atomic force microscope using tapping mode with a silicon tip coated with aluminium with a force constant of 40 N/m. LDHs samples were diluted into ca. 0.01 mM and spin coated on freshly cleaved mica wafer for AFM imaging.

Mechanical flex of the films. The films were conditioned at 23±2° C. and 50±5% RH for 48 hours before the flex. All films were flexed by a Gelbo flex tester (IDM instruments) following ASTM F392-93 standard.

Optical measurements of the barrier films. Haze and transparency of the films were tested by a haze-gard I haze meter (BYK instruments) following ASTM D1003-00 Standard test method. The film samples were conditioned at 23±2° C. and 50±5% RH for 48 hours before testing.

Pole figure measurements. For Pole figure measurements a Panalytical X'Pert Pro MRD was used. This is equipped with a 4-bounce Ge Hybrid Monochromator giving pure Cu Kai radiation and a Pixcel detector as a point detector with an 8.5 mm active length. This provides each pole figure with a 2θ range of 1.5°, allowing us to isolate the scattering from the intercalated and bulk phase scattering. The samples containing 20%, 60%, and 90% LDH in the coating layer were mounted on a glass slide using double-sided tape and oriented so that at φ=0° the top of the sample. The pole figure measurement consists of a series of p scans (rotation of the sample about the surface normal) made at a number of different ψ angles (sample tilt angle). Each φ scan was from 0 to 360° with a 2° step size and a counting time of 0.88 s per position. A phi scan was made every 2° from 0 to 26 in ψ giving a total collection time per pole figure of 45 minutes. For each sample a measurement was made with the detector fixed at 8.5° and 11.5° in 26 to ensure the diffracted intensity was from the intercalated LDHs and bulk LDHs, respectively.

Degree of Orientation.

$$\partial = \frac{1 - F}{1} * 100 \qquad ( 3 )$$

where FWHM is the full width at half maximum obtained by pole figure measurements.

Barrier improvement factor. Barrier improvement factor (BIF) is defined as Ps/Pt, where Ps is the permeability of the substrate and Pt is the permeability of the coated substrate.

### RESULTS AND DISCUSSION

MgAl—CO₃²-LDH was first calcined and then reconstructed in an amino acid solution (FIG. 34a and Materials and methods) to obtain a translucent gel (FIG. 35). Further agitating the gel in water gave green high aspect ratio LDH NS (FIGS. 34b and c) that contained both water and amino acids (Table 9 and 10 and FIG. 36).

TABLE 9
Mg/Al ratios of original LDH, LDH reconstructed in glycine
and control LDH reconstructed in water: the metal ratios stay
very close to each other indicating that the reconstruction
process does not change the metal ratio.

| | | | Mg/Al | |
|---|---|---|---|---|
| | Mg | Al | molar | Average |
| Samples | (wt %) | (wt %) | ratio | ratio |
| Original LDH | 18.1 | 9.51 | 2.12 | 2.11 |
| | 18.2 | 9.63 | 2.10 | |
| | 18.3 | 9.64 | 2.10 | |
| LDH-gly | 18.3 | 9.54 | 2.13 | 2.13 |
| | 18.2 | 9.48 | 2.13 | |
| | 18.2 | 9.52 | 2.12 | |
| LDH-water | 18.8 | 9.94 | 2.10 | 2.10 |
| | 18.8 | 9.95 | 2.10 | |
| | 18.7 | 9.94 | 2.09 | |

TABLE 10
Glycine content in reconstructed LDH calculated from TGA.

| | | Total | Glycine content |
|---|---|---|---|
| | Weight | weight | (wt %) |
| | loss at | loss at | (weight loss |
| | 200° C. | 800° C. | difference |
| Samples | (wt %) | (wt %) | at 800° C.) |
| A1C-450° C. LDO | 3.32 | 9.33 | 7.44 |
| A1C-450° C.-Gly | 10.5 | 50.94 | |
| A1C-450° C.-water | 7.63 | 43.5 | |

The aspect ratio was calculated by dividing the diameter by thickness of individual particles. The LDH NS have a mean aspect ratio of 204.5±75.4 (FIG. 34d, FIG. 37d-f), ca. 64 times and 17 times higher than that of the pristine LDH (FIG. 37a-c; FIGS. 38a and b) and the control LDH reconstructed in water respectively (FIG. 37g-1; FIGS. 38c and d).

The majority of the LDH NS comprise 2 LDH layers (FIG. 37e) (0.48 nm for each metal hydroxides layer) and glycine (0.3 nm from ChemDraw) and water molecules with refined shape rather than fragments that are usually obtained by exfoliation of LDHs². Calcination at high temperature removes interlayer water and anions (ca.<600° C.)^{3,4} that screened the interlayer interactions, thus, molecules/ions can interact freely with newly grown LDH NS during reconstruction process in solution (FIG. 34a).

In concentrated glycine solution, LDOs dissolve rapidly at an elevated temperature in the acidic amino acid solution (pH=5.6 of 2M glycine solution) followed by almost instantaneous reconstruction of LDHs structure (FIG. 39). During the reconstruction process, whilst the LDO peak disappears at the fourth minute, the LDH crystallites evolve at the third minute and grow larger in diameter as the (110) peak grows and becomes sharper with reaction time (FIG. 39). On the other hand, the LDH growth along c axis is much slower where only a broad hump was observable centred at around 2=11.60° (corresponds to diffraction from (003) crystal plane) after 15 hours of reaction (FIG. 40). LDHs growth is inherently faster in the in-plan direction due to the formation of stronger covalent bonds in contrast to the weaker electrostatic interactions dominating interlayer growth. Thus, in an environment lack of large amounts of anions, the presence of amino acid decreased the electrostatic interactions between the positively charge LDH NS and counter anions, slowing down the interlayer growth. The thickness growth of the LDH NS is monitored by the (003) peak positioned around 26=11.6° (FIG. 40) where the thickness remained very stable with only a slight increase from 0.5 nm to 1.6 nm (FIG. 34e). This is in sharp contrast to the rapid growth of the diameter from 17.6 nm to 43.0 nm (FIG. 34e) monitored by the (110) peak positioned around 26=60.6° in 48 hours of reconstruction (FIG. 39). The values are estimations⁵, but the growth trends are representative. The preferential growth suppression in the c direction is ascribed to the high dielectric constant of the amino acid solution (125 of 2M glycine aqueous solution is comparable to that of 111 of formamide, a known exfoliation agent for LDHs)⁶ where the carbonyl group interacts with surface hydroxyl groups of the reconstructed LDH through hydrogen bonding (FIG. 34f and FIG. 41), weakening interlayer electrostatic interactions which in turn inhibits interlayer growth.

A range of LDH NS other than MgAl—CO₃²-LDH with various metal cations were successfully obtained, including NiAl, Mgln, MgGa, and ZnAl-LDH NS, through the calcination and reconstruction method (FIG. 42).

After reaction, the gel was dispersed in water by homogenizer and a semi-transparent dispersion was formed (FIG. 43a). The LDH NS were precipitated by adding NaOH solution and collected by centrifuge; the precipitate was subsequently washed with water to remove the excess glycine and NaOH. The precipitation led to the stacking of LDH NS proven by the much resolved hump at (003) peak position (FIG. 40).

2D-NS are impermeable to gas molecules due to the dense packing of ions in the crystal structure, thus, they are natural barriers to gas molecules. Theoretical predictions⁷ and experiments⁸ have shown that well-aligned high aspect ratio NS are highly effective in diminishing gas diffusion through polymer films due to the extra diffusion path (FIG. 44a) the gas molecules are forced to migrate around the barrier NS. The structure of tortuous pathway is an universal barrier to gas⁹, moisture¹⁰, heat¹⁰, chemical molecules¹¹ and electricity¹² that is widely adopted in packaging materials, insulation materials and flame retardant materials. The gas barrier properties of the tortuous pathway derive from the alignment of the NS in the polymer matrix indicating⁷ that a higher degree of alignment is more efficient in resisting gas diffusion through the film.

It was then demonstrated that the high aspect ratio green LDH NS can be mixed with polyvinyl alcohol (PVA) to make a coating solution (FIG. 43b). A substrate polymer film, polyethylene terephthalate (PET), was coated with a single coating process using industrialized bar coater with the LDH/PVA coating solution (FIG. 44a). The coating layer thickness can be easily tuned by changing coating rod with different coating gap (FIG. 44b and FIGS. 45-46) where the thickness can be tuned from ca. 100 nm to 1.8 μm. The coating layer does not decrease the transparency of the PET substrate and the haze of the coated film is very similar to that of the substrate film (FIG. 44c). The coating solution was labelled as X wt %-Y % LDH where X wt % (ranging from 3-13 wt %) refers to the total solid content (LDH and PVA) in water solution and Y % (ranging from 10-90%) refers to the weight ratio of LDH over PVA. When referring to the coated films, Y % is the weight ratio of LDH over PVA; C means that the PVA is crosslinked.

The reconstructed LDH NS are well aligned parallel to each other in PVA matrix (FIG. 44d) indicating the formation of a high barrier film. In the XRD patterns (FIG. 47) of the coated films, two phases were identified: an LDH/PVA intercalation phase and a second LDH/glycine bulk phase (d-spacing is ca. 7.7 Å). The interlayer distance of the intercalation phase decreased from 11.3 Å to 10.1 Å and finally merged with the bulk phase when the weight percentage of LDH NS increases from 10 to 90% in the coating layer. The decreased interlayer distance is ascribed to less PVA present in between LDH NS layers when the LDH percentage is increased in the coating layer.

The degree of alignment of LDH NS was statistically examined by pole figure measurements that show graphical representations of the orientation distribution of the NS in PVA matrix (FIG. 44e-j). Two sets of measurements were carried out with 26 degrees fixed at 8.5° (the intercalated phase) and 11.5° (the bulk phase) where three samples (containing 20%, 60%, and 90% LDH) were scanned at a sample tilting angle (L) and a rotation angle (p) (FIG. 44e). Visually, the pole figures show some anisotropic scattering but are all centred around 0° in ψ indicating that LDH layers are well aligned around (003) crystal plane (parallel to PET substrate, where scattering intensity at high ψ angle indicates the presence of LDH layers aligned ψ angle away from (003) crystal plane). It can also be clearly observed that the orientation distribution of the doped layers is very similar to that of the bulk layers. The orientation distribution is compared by the averaged full width at half maximum height (FWHM) of their scattering from all φ angles. To estimate the FWHM of the LDH NS orientation distribution the scattering from all φ angles was averaged. This allowed a single set of scattering intensities as a function of sample tilt ψ to be produced. These could then be fitted with a Gaussian distribution as shown below: where y₀ is the background intensity, A is the area, w is the FWHM and x_{c} is the peak centre.

$$y = {y}_{0} + \frac{{Ae}^{\frac{- 4 ln ( 2 ) {( x - {x}_{c} )}^{2}}{{w}^{2}}}}{w \sqrt{\frac{π}{4 ln ( 2 )}}} \qquad ( 2 )$$

The fitting gave FWHM (FIG. 48a-c) of the bulk phase and intercalated phase of 19.5±0.3° and 19.3°±0.6°, 17.0°±0.2° and 17.4±0.2°, 20.1°±0.1° and 21.8°±0.8° for the coating films containing 20%, 60%, and 90% LDH NS respectively (FIG. 48d), suggesting that coating film containing 60% LDH has the highest degree of orientation of 90.3%, while the 90% LDH film has the lowest degree of orientation of 87.9% (FIG. 44k) (The calculation method can be found in Materials and methods). The anisotropy effect on FWHM is also considered for 60% LDH coating film. The pole figure measured at 26=8.5° was analysed by averaging the data into 45 sectors (Table 11) where the average FWHM is 16±1.8°, consistent with the value of 17.0°±0.2° determined when averaging all p angles. Both analysis methods suggest that the 60% LDH coating film has the highest level of alignment.

TABLE 11
FWHM and peak centres of Gaussian fits for φ sector data measured on
coating film with 60 wt % LDH at 2θ = 8.5°.
φ Sector (°)

| | | 45- | 90- | 135- | 180- | 215- | 270- | 315- | Average | STD |
|---|---|---|---|---|---|---|---|---|---|---|
| | 0-45 | 90 | 135 | 180 | 215 | 270 | 315 | 360 | (°) | (°) |
| FWHM (°) | 14.9 | 17.0 | 18.7 | 13.1 | 16.4 | 17.6 | 16.7 | 13.7 | 16.0 | 1.8 |
| Uncertainty | 1.1 | 0.7 | 0.3 | 0.4 | 0.8 | 0.8 | 1.1 | 0.5 | | |
| (°) | | | | | | | | | | |
| Xc (°) | −0.5 | 0.0 | 4.0 | 1.3 | −3.6 | −2.5 | 3.0 | 2.4 | 0.5 | |
| Uncertainty | 0.7 | 0.4 | 0.1 | 0.2 | 0.7 | 0.6 | 0.4 | 0.2 | | |
| (°) | | | | | | | | | | |

The oxygen transmission rate (OTR) of the coated films can be efficiently reduced to below the testing limit of the instrument (<0.005 cc/m²/day/atm) (FIG. 49a). The OTR decreased significantly with LDH loading and the lowest value was obtained when the LDH NS loading was in between 60-80% (FIG. 49a). In sharp contrast, the OTR increased when LDH concentration reached 90%. This is probably due to the viscosity change of the coating solution. Unlike the rest of the samples, at 90% LDH, the coating solution showed significant shear thinning behaviour (FIG. 50). At such a high LDH concentration (90%), due to the high viscosity the LDH NS are difficult to rotate to be aligned as perfectly, thus giving a poor overall LDH alignment. Another reason would be that the coating layer turned so rigid after the majority of the flexible polymer is replaced by LDH that the film became fragile and susceptible to cracking. The OTR of the coated film decreases with increasing total solid content of the solution and coating gap of the coating rod. The OTR decreased from 0.124 to below 0.005 cc/m²/day/atm when the total solid content is increased from 3 to 7 wt % (OTR stayed below detection at total solid content larger than 7 wt %) (FIG. 49a). The OTR decreased from 1.92 to 0.036 cc/m²/day/atm when the coating gap is increased from 6 to 40 μm when the coating solution contains 60% LDH and 5 wt % total solid content (FIG. 49b). It was also confirmed that a single coating process is efficient enough to decrease the OTR of the coated film (FIG. 49b inset). The OTR value is very similar (FIG. 49b inset) between the two films coated once with a 24 μm rod and twice with a 12 μm rod which have almost the same coating thickness (FIG. 45d and Table 12).

TABLE 12
Barrier properties of the coated films. STP, standard temperature and pressure.

| | Coating | | O₂ permeability of coated | |
|---|---|---|---|---|
| | thickness | OTR | barrier film | |
| Samples^{a} | (nm) | [cc/(m² · day)] | [10⁻¹⁶cm³(STP) · cm/cm² · s · Pa] | BIF^{b} |
| PET(12) | — | 133.5 | 18.3 | — |
| PVA-5 wt %-24^{c} | 890 ± 32 | 18.25 | 2.6 | 7 |
| 5 wt %-60% LDHs-24^{c} | 665 ± 33 | 0.044 | 0.00629 | 2908 |
| 5 wt %-80% LDH-24^{c} | 891 ± 42 | 0.042 | 0.00618 | 2959 |
| 7 wt %-60% LDH-24^{c} | 1000 ± 47 | <0.005 | 0.000742 | 24640 |
| 10 wt %-60% LDH-24^{c} | 1103 ± 21 | <0.005 | 0.000748 | 24452 |
| 5 wt %-60% LDH-6^{d} | 92 ± 10 | 1.92 | 0.26519 | 69 |
| 5 wt %-60% LDH-12^{e} | 295 ± 14 | 0.21 | 0.029774 | 615 |
| 5 wt %-60% LDH-12-T^{f} | 690 ± 20 | 0.041 | 0.005943 | 3079 |
| 5 wt %-60% LDH-40^{g} | 1845 ± 33 | 0.036 | 0.005695 | 3213 |
| PET(180)-LDHs⁹ | 149 | <0.005 | 0.01029 | 1685 |
| PET(180)-LDHs¹⁰ | 360 | <0.005 | 0.010301 | 1683 |
| PET(179)-MMT¹¹ | 82.6 | <0.005 | 0.0102281 | 1719 |
| PET(125)-GO¹² | 1 × 10⁴ | <0.005 | 0.00771034 | 2120 |
| Commercial metallized | 42 | 0.25 | 0.0348524 | 678 |
| PET(12)²⁰ | | | | |

^{a}The value inside the parentheses is the thickness of substrate PET films in μm;
^{b}Barrier improvement factor (BIF) (which is defined as Ps/Pt, where Ps is the permeability of the substrate and Pt is the permeability of the coated substrate);
^{c}24 denotes the coating gap is 24 μm.
^{c,d,e,g}24, 6, 12, and 40 denotes the coating gap in μm.
^{f}The sample is coated twice with 12 μm coating gap rod.

The flexibility of the barrier films was then tested, where the films were flexed 50, 100, and 200 times, and the OTR value of the coated films remain almost the same compared to that of the film before flex (FIG. 51). The surface of the coated film is smooth (FIGS. 52a and b) compared to the film coated with control LDH (FIG. 53). Even after 200 cycles flex, the surface of the coated film does not show defects (FIGS. 52c and d).

The water vapour transmission rate (WVTR) of the coated film showed significant decrease as well. Similarly, the WVTR decreased when increasing LDH NS loading and the lowest WVTR decreased from 8.99 of bare PET film to 1.04 g/m²/day after coating with LDH/PVA (FIG. 54). To further improve water vapour barrier, a high molecular weight PVA was used and the PVA was crosslinked with trisodium trimetaphosphate (TSMP)¹¹³, a previously reported food grade cross-linker. After crosslinking, PVA becomes insoluble in water, maximizing the possibility of preserving the ordered structure during the test. By adding 60% LDH NS into the coating layer, the WVTR of the coated film decreased to 0.04 g/m²/day (FIG. 49c). The improvement is significant considering its thin coating thickness and hydrophilic nature of LDH which in return, supports the theory of tortuous pathway formed by the good alignment of high aspect ratio LDH NS.

The highest oxygen barrier films based on LDHs can reduce the OTR to below instrument detection limit by LBL assembling LDHs with polymer binders⁹. However, the barrier films of the invention are far more effective when taking the coating thickness into account and calculating the permeability of the barrier films (Table 12). This is also true when comparing the permeability of the barrier films containing other 2D materials, such as Montmorillonite (MMT)^{14,15}, graphene oxide (GO)¹⁶ and commercial metallized PET film¹⁷ (The permeability of the barrier films are calculated by a previously described method¹⁸) (FIG. 49d). The advantage of the barrier films of the invention is more obvious when comparing the barrier improvement factor (BIF) which is the permeability of the bare substrate divided by the permeability of the barrier film¹⁹. The BIF reached 24452 when the coating layer contains 60% LDHs and the coating solution contains 10 wt % total solid contents as shown in Table 12. It is more than 14 times higher than the existing best LDHs based barrier films and ca. 11 times higher than other 2D materials filled barrier films. More impressively, it is more than 36 times higher than the commercial metalized PET film¹⁷.

It has been demonstrated that by reconstructing LDOs in amino acid solution, high aspect ratio LDH NS can be obtained and the NS can be stably dispersed in water. A possible explanation for this is that in the amino acid solution, LDHs particle growth in the c direction is significantly inhibited compared to that of the in-plane growth due to the lack of appreciated amount of anions (other than amino acid ions) present (CO₃²⁻ and OH⁻ for example) in the solution. Amino acid can efficiently decrease the electrostatic interactions and inhibit interlayer growth of LDHs due to their high dielectric constant. The obtained LDH NS are high aspect platelets and when incorporated into PVA matrix, they can effectively decrease both the OTR and WVTR of the PET film. The barrier film is thin, transparent, and flexible, most importantly; the high aspect ratio MgAl-LDH NS used to enhance the barrier properties does not contain any toxic substances, making it an ideal candidate for food packaging.

While specific embodiments of the invention have been described herein for the purpose of reference and illustration, various modifications will be apparent to a person skilled in the art without departing from the scope of the invention as defined by the appended claims.

### REFERENCES

1 Chaouat, M. et al. A novel cross-linked poly (vinyl alcohol)(PVA) for vascular grafts. Adv. Funct. Mater. 18, 2855-2861 (2008).
2 Liu, Z. et al. Synthesis, anion exchange, and delamination of Co— Al layered double hydroxide: assembly of the exfoliated nanosheet/polyanion composite films and magneto-optical studies. J. Am. Chem. Soc. 128, 4872-4880 (2006).
3 Millange, F., Walton, R. I. & O'Hare, D. Time-resolved in situ X-ray diffraction study of the liquid-phase reconstruction of Mg—Al-carbonate hydrotalcite-like compounds. J. Mater. Chem. 10, 1713-1720 (2000).
4 Rocha, J., del Arco, M., Rives, V. & A. Ulibarri, M. Reconstruction of layered double hydroxides from calcined precursors: a powder XRD and 27Al MAS NMR study. J. Mater. Chem. 9, 2499-2503, doi:10.1039/A903231B (1999).
5 Langford, J. I. & Wilson, A. Scherrer after sixty years: a survey and some new results in the determination of crystallite size. J. Appl. Crystallogr. 11, 102-113 (1978).
6 Wyman, J. The Dielectric Constant of Solutions of Dipolar Ions. Chem. Rev. 19, 213-239 (1936).
7 Cussler, E., Hughes, S. E., Ward, W. J. & Aris, R. Barrier membranes. Journal of Membrane Science 38, 161-174 (1988).
8 Dou, Y. et al. Transparent, flexible films based on layered double hydroxide/cellulose acetate with excellent oxygen barrier property. Adv. Funct. Mater. 24, 514-521 (2014).
9 Dou, Y. et al. Transparent, Ultrahigh-Gas-Barrier Films with a Brick-Mortar-Sand Structure. Angew. Chem. Int. Ed. 54, 9673-9678 (2015).
10 Ding, F. et al. Biomimetic nanocoatings with exceptional mechanical, barrier, and flame-retardant properties from large-scale one-step coassembly. Science Advances 3, e1701212 (2017).
11 Li, P. et al. Highly effective anti-corrosion epoxy spray coatings containing self-assembled clay in smectic order. Journal of Materials Chemistry A 3, 2669-2676, doi:10.1039/C4TA06221C (2015).
12 Cao, Y., Irwin, P. C. & Younsi, K. The future of nanodielectrics in the electrical power industry. IEEE Transactions on Dielectrics and Electrical Insulation 11, 797-807 (2004).
13 Lack, S., Dulong, V., Picton, L., Le Cerf, D. & Condamine, E. High-resolution nuclear magnetic resonance spectroscopy studies of polysaccharides crosslinked by sodium trimetaphosphate: a proposal for the reaction mechanism. Carbohydr. Res. 342, 943-953 (2007).
14 Priolo, M. A., Gamboa, D., Holder, K. M. & Grunlan, J. C. Super gas barrier of transparent polymer-clay multilayer ultrathin films. Nano Lett. 10, 4970-4974 (2010).
15 Das, P. et al. Nacre-mimetics with synthetic nanoclays up to ultrahigh aspect ratios. Nature communications 6, 5967 (2015).
16 Chen, J.-T. et al. Enhancing polymer/graphene oxide gas barrier film properties by introducing new crystals. Carbon 75, 443-451 (2014).
17 Jamieson, E. & Windle, A. Structure and oxygen-barrier properties of metallized polymer film. Journal of Materials Science 18, 64-80 (1983).
18 Roberts, A. et al. Gas permeation in silicon-oxide/polymer (SiOx/PET) barrier films: role of the oxide lattice, nano-defects and macro-defects. Journal of Membrane Science 208, 75-88 (2002).
19 Priolo, M. A., Holder, K. M., Gamboa, D. & Grunlan, J. C. Influence of Clay Concentration on the Gas Barrier of Clay-Polymer Nanobrick Wall Thin Film Assemblies. Langmuir 27, 12106-12114, doi:10.1021/la201584r (2011).

1. A process for the preparation of a coated first substrate, the process comprising the steps of:
a) providing a coating mixture comprising:
i. an amino acid-modified layered double hydroxide,
ii. a polymer, and
iii. a solvent for the polymer;
b) applying a layer of the coating mixture to a first substrate to provide a coated first substrate; and
c) drying the coated first substrate.

2. The process of claim 1, wherein the total solids content of the coating mixture is 2.0-20.0% by weight relative to the total weight of the coating mixture.

3. The process of claim 1, wherein the total solids content of the coating mixture is 8.0-12.0% by weight relative to the total weight of the coating mixture.

4. The process of claim 1, wherein of the total solids present in the coating mixture, 10-90 wt % is the amino acid-modified LDH.

5. The process of claim 1, wherein of the total solids present in the coating mixture, 50-75 wt % is the amino acid-modified LDH.

6. The process of any preceding claim, wherein the polymer is a water-soluble polymer.

7. The process of any preceding claim, wherein the polymer is one or more water-soluble polymers selected from the group consisting of poly(vinyl alcohol) (PVOH), poly(vinyl acetate) (PVAc), copolymers comprising vinyl alcohol (e.g. polyethylene vinyl alcohol (EVOH)), polylactic acid (PLA), and polyacrylic acid (PAA), or one or more water-based polymers selected from the group consisting of water-based polyurethane and water-based polyacrylate.

8. The process of any preceding claim, wherein the polymer is PVOH or crosslinked PVOH and the solvent is >95 wt % water.

9. The process of any preceding claim, wherein the first substrate is selected from the group consisting of polyethylene terephthalate (PET), polyethylene (PE), biaxiaily oriented polypropylene film (BOPP), polypropylene (PP), and polyvinyl dichloride (PVDC).

10. The process of any preceding claim, wherein the first substrate is sheet-like, having a thickness of 1-30 μm.

11. The process of any preceding claim, wherein the first substrate is polyethylene terephthalate (PET).

12. The process of any preceding claim, wherein the aspect ratio of the amino acid-modified layered double hydroxide is greater than 85, wherein aspect ratio is the average diameter of the layered double hydroxide platelet divided by the average thickness of the layered double hydroxide platelet.

13. The process of any preceding claim, wherein the aspect ratio of the amino acid-modified layered double hydroxide is >150.

14. The process of any preceding claim, wherein the amino acid-modified layered double hydroxide is a layered double hydroxide comprising 1-25 wt % of an amino acid.

15. The process of any preceding claim, wherein step a) comprises the steps of:
a-i) providing a layered double oxide;
a-ii) providing a mixture of an amino acid and a solvent for the amino acid (e.g. water);
a-iii) providing a mixture of the polymer and the solvent for the polymer;
a-iv) contacting the layered double oxide with the mixture of step a-ii) to yield an amino acid-modified layered double hydroxide; and
a-v) contacting the amino acid-modified layered double hydroxide with the mixture of step a-iii) to yield the coating mixture.

16. The process of claim 15, wherein during step a-iv), the amino acid is in an excess with respect to the layered double oxide.

17. The process of claim 15, wherein the weight ratio of amino acid (e.g. glycine) to layered double hydroxide in step a-iv) is 1.1:1 to 2:1.

18. The process of claim 15, 16 or 17, wherein step a-iv) is conducted at a temperature of 50-150° C.,
and/or
step a-iv) is conducted for >1 minute, preferably >10 minutes, more preferably >1 hour.

19. The process of any one of claims 15 to 18, wherein the solvent for the amino acid is water.

20. The process of any one of claims 15 to 19, wherein the mixture of step a-ii) and/or step a-iii) further comprises either or both of
a) a source of an inorganic oxyanion (e.g. a salt), and
b) a polymer crosslinking agent (e.g. a crosslinking agent suitable for crosslinking PVOH, such as trisodium trimetaphosphate).

21. The process of any one of claims 15 to 20, wherein the layered double oxide is obtainable by thermally treating a precursor layered double hydroxide at a temperature of 260-550° C.

22. The process of any one of claims 15 to 21, wherein the layered double oxide is obtainable by thermally treating a precursor layered double hydroxide at a temperature of 325-475° C.

23. The process of any one of claims 15 to 22, wherein the layered double oxide is obtainable by thermally treating a precursor layered double hydroxide for a period of 6-18 hours.

24. The process of any one of claims 15 to 23, wherein prior to step a-v), a base (e.g. NaOH) is added to the mixture resulting from step a-iv) to precipitate the amino acid-modified LDH.

25. The process of any one of claims 21 to 24, wherein either or both of the precursor layered double hydroxide and the amino acid-modified layered double hydroxide contained within the coating mixture is a Zn/Al, Mg/Al, ZnMg/Al or Ca/Al layered double hydroxide.

26. The process of any one of claims 21 to 25, wherein either or both of the precursor layered double hydroxide and the amino acid-modified layered double hydroxide contained within the coating mixture is a Mg/Al LDH.

27. The process of any one of claims 21 to 26, wherein either or both of the precursor layered double hydroxide and the amino acid-modified layered double hydroxide contained within the coating mixture is a Mg/Al LDH in which the molar ratio of Mg:Al is (1.9-2.5):1.

28. The process of any one of claims 21 to 27, wherein either or both of the precursor layered double hydroxide and the amino acid-modified layered double hydroxide contained within the coating mixture is a carbonate-containing layered double hydroxide.

29. The process of any preceding claim, wherein the amino acid is non-aromatic.

30. The process of any preceding claim, wherein the amino acid is β-aminobutyric acid or glycine.

31. The process of any preceding claim, wherein the amino acid is glycine.

32. The process of any preceding claim, wherein the coating mixture is applied to the substrate in step b) at a thickness of 0.5 μm-100 μm.

33. The process of any one of claims 15 to 32, wherein
step a-i) comprises thermally treating a precursor layered double hydroxide at a temperature of 325-475° C.;
during step a-iv), the amino acid (e.g. glycine) is in an excess with respect to the layered double oxide; and
step a-iv) is conducted at a temperature of 50-150° C.

34. The process of any one of claims 15 to 33, wherein
step a-i) comprises thermally treating a precursor layered double hydroxide at a temperature of 325-475° C.;
the weight ratio of amino acid (e.g. glycine) to layered double hydroxide in step a-iv) is 1.1:1 to 2:1;
step a-iv) is conducted at a temperature of 70-120° C., optionally under hydrothermal conditions; and
prior to step a-v), a base (e.g. NaOH) is added to the mixture resulting from step a-iv) to precipitate the amino acid-modified LDH.

35. The process of any one of claims 15 to 34, wherein
either or both of the precursor layered double hydroxide and the amino acid-modified layered double hydroxide contained within the coating mixture is a magnesium aluminium carbonate LDH in which the molar ratio of Mg:Al is (1.9-2.5):1;
the amino acid-modified layered double hydroxide is a layered double hydroxide comprising 1-25 wt % of an amino acid; and
the aspect ratio of the amino acid-modified layered double hydroxide is >120.

36. The process of any one of claims 15 to 35, wherein
either or both of the precursor layered double hydroxide and the amino acid-modified layered double hydroxide contained within the coating mixture is a magnesium aluminium carbonate LDH in which the molar ratio of Mg:Al is (1.9-2.5):1;
the amino acid-modified layered double hydroxide is a layered double hydroxide comprising 1-25 wt % of glycine; and
the aspect ratio of the amino acid-modified layered double hydroxide is >175.

37. A coated substrate comprising:
a) a first substrate; and
b) a coating layer provided on at least one surface of the first substrate,
wherein the coating layer comprises 20-90 wt % of an amino acid-modified layered double hydroxide dispersed throughout a polymeric matrix.

38. The coated substrate of claim 37, wherein the amino acid-modified layered double hydroxide is randomly dispersed throughout the polymeric matrix.

39. The coated substrate of claim 37 or 38, wherein the coated substrate is free from urea.

40. The coated substrate of any one of claims 37, 38 and 39, wherein the coating layer comprises 35-75 wt % of amino acid-modified layered double hydroxide.

41. The coated substrate of one of claims 37 to 40, wherein the amino acid-modified layered double hydroxide, the amino acid, the polymer and the first substrate are as defined in any preceding claim.

42. The coated substrate of any one of claims 37 to 41, wherein the coating layer has a thickness of 20 nm-5.0 μm

43. The coated substrate of any one of claims 37 to 42, wherein
the coating layer comprises 30-85 wt % of amino acid-modified layered double hydroxide;
the aspect ratio of the amino acid-modified layered double hydroxide is >120;
the polymer is PVOH; and
the first substrate is PET.

44. The coated substrate of any one of claims 37 to 43, wherein
the coating layer comprises 50-75 wt % of amino acid-modified layered double hydroxide;
the aspect ratio of the amino acid-modified layered double hydroxide is >150;
the polymer is PVOH;
the coating layer has a thickness of 50 nm-2.5 μm; and
the first substrate is PET.

45. The coated substrate of any one of claims 37 to 44, wherein
the coating layer comprises 50-75 wt % of glycine-modified layered double hydroxide;
the aspect ratio of the glycine-modified layered double hydroxide is >175;
the polymer is PVOH or crosslinked PVOH;
the coating layer has a thickness of 50 nm-2.5 μm; and
the first substrate is PET having a thickness of 5-20 μm.

46. The coated substrate of any one of claims 37 to 45, wherein the coated substrate has an OTR of <7.0 cc/m²/day/atm.

47. The coated substrate of any one of claims 37 to 46, wherein the coated substrate has an OTR of <1.5 cc/m²/day/atm.

48. The coated substrate of any one of claims 37 to 47, wherein the coated substrate has a WVTR of <7.0 g/m²/day.

49. The coated substrate of any one of claims 37 to 48, wherein the coated substrate has a WVTR of <1.5 g/m²/day.

50. Use of a coated substrate as claimed in any one of claims 37 to 49 in packaging.

51. The use of claim 50, wherein the packaging is food packaging.

52. Packaging comprising a coated substrate as claimed in any one of claims 37 to 49.

53. The packaging of claim 52, wherein the packaging is food packaging.
